(19) United States
(12) Patent Application Publication
(10) Pub. No.: US 2023/0041133 A1
(43) Pub. Date: Feb. 9, 2023

(54) NUT BUTTER REPLICAS PRODUCED FROM INDIVIDUAL COMPONENTS

(71) Applicant: Voyage Foods, Inc., Oakland, CA (US)

(72) Inventors: Kelsey Tenney, San Francisco, CA (US); Samuel Ryo, Singapore (SG); Adam Maxwell, Oakland, CA (US); Jillian Angela Jastrzembski, San Francisco, CA (US); Mardonn Carl Chua, San Francisco, CA (US); Meaghan Sugrue, Oakland, CA (US)

(21) Appl. No.: 17/855,260

(22) Filed: Jun. 30, 2022

Related U.S. Application Data
(60) Provisional application No. 63/217,632, filed on Jul. 1, 2021.

(51) Int. Cl. A23L 19/00; A23L 27/20; A23L 27/28; A23L 27/30

(52) U.S. Cl. CPC A23L 19/09; A23L 19/07; A23L 27/2054; A23L 27/2052; A23L 27/204; A23L 27/28; A23L 27/2024; A23L 27/203; A23L 27/2022; A23L 27/34; A23V 2002/00

(57) ABSTRACT

Materials and methods for producing nut butter replicas from individual components are provided herein.

### CROSS-REFERENCE TO RELATED APPLICATIONS

This application claims priority to U.S. Provisional Patent Application No. 63/217,632, filed Jul. 1, 2021. The entire contents of the foregoing application are incorporated herein by reference.

### TECHNICAL FIELD

This document relates to materials and methods for producing nut butter-like products from individual components.

### BACKGROUND

Traditional methods for producing nut butters are often lengthy and costly, involving the harvesting of crops, followed by processing, drying, roasting, cooling, blanching, and grinding steps. Each component of the traditional process has an inherent variability and risk, including climate, crop disease, and contamination, which can render such methods and their resulting products inconsistent from batch to batch and year to year. Additionally, traditional nut butters contain allergens that can cause severe allergic reactions for a subset of the population.

### SUMMARY

This document is based, at least in part, on the identification of compounds that contribute to the flavor and aroma of nut butters, and on the development of methods for combining those compounds to yield nut butter replicas (e.g peanut butter, almond butter, hazelnut butter, acorn butter, cashew butter, macademia butter, pecan butter, pistachio butter, walnut butter, and other nut butter replicas) that have the taste, aroma, and other characteristics of traditionally generated nut butters. Because each ingredient is added individually, the methods disclosed herein reduce many of the risks and variability associated with traditional nut butter production, which can vary by region, farm, or year. In some cases, one or more ingredients (e.g., at least 50%, 60%, 70%, 80%, 90%, 95%, 99%, or 100% of the ingredients) can be highly defined (e.g., by lot analysis). In some cases, one or more ingredients (e.g., at least 50%, 60%, 70%, 80%, 90%, 95%, 99%, or 100% of the ingredients) can be highly pure (e.g., at least 90%, 95%, 96%, 97%, 98%, 99%, 99.5%, or 99.9% pure). The methods also provide infinite reproducibility of a recipe, which is not possible with traditional production methods. Further, the methods described herein allow for unique flexibility in optimization of the flavors, aromas, and textures of nut butter, and greatly reduce or even eliminate the possibility that the resulting nut butter will contain detrimental or undesired components. Moreover, the methods disclosed herein differ from currently existing methods in that they are rapid, reproducible, and cost-effective. For some, the nut butter replica may exclude the allergens found in the traditional product (e.g. peanut proteins in peanut butter).

In a first aspect, this document features a nut butter replica containing: one or more isolated volatile organic compounds (VOCs); and one or more isolated non-volatile compounds; wherein: a) the one or more isolated VOCs include at least one VOC that is not present in a corresponding reference nut butter, b) the one or more isolated VOCs do not include at least one VOC that is present in a corresponding reference nut butter, c) the one or more isolated VOCs are present in the nut butter replica in a total amount of at least 100 ppm, d) the one or more isolated non-volatile compounds include at least one non-volatile compound that is not present in a corresponding reference nut butter, or e) the one or more isolated non-volatile compounds do not include at least one non-volatile compound that is present in a corresponding reference nut butter. In some cases, the one or more isolated VOCs can include at least one VOC that is not present in a corresponding reference nut butter. In some cases, the one or more isolated VOCs do not include at least one VOC that is present in a corresponding reference nut butter.

The one or more isolated VOCs can be present in the nut butter replica in a total amount of at least 100 ppm, at least 200 ppm, at least 300 ppm, at least 400 ppm, at least 500 ppm, at least 600 ppm, at least 700 ppm, or at least 800 ppm.

In some cases, the one or more isolated non-volatile compounds can include at least one non-volatile compound that is not present in a corresponding reference nut butter. In some cases, the one or more isolated non-volatile compounds do not include at least one non-volatile compound that is present in a corresponding reference nut butter.

In some cases, the one or more isolated VOCs do not include at least one compound selected from the group consisting of (+/−) 2-methyl-1-butanol, 1-methyl-1h-pyrrole-2-carboxaldehyde, 1-octen-3-ol, 1-penten-3-one, 2,3,5,6-tetramethylpyrazine, 2,3,5-trimethylpyrazine, 2,3-diethyl-5-methylpyrazine, 2,3-dimethylpyrazine, 2,3-pentanedione, 2,5-dimethylpyrazine, 2-ethyl-6-methylpyrazine, 2-methyl-5-vinylpyrazine (re-gras), 2-methylbutyraldehyde, 2-methylbutyric acid, 2-methylpyrazine, 2-methyltetrahydrofuran-3-one, 2-nonanone, 2-octanone, 2-pentylfuran, 3,5-diethyl-2-methylpyrazine, 3-octen-2-one, 4-hexene-3-one, 4-hydroxy-2-butenoic acid gamma-lactone, 4-methyl-3-penten-2-one, 5-methylfurfural, acetoin, amyl alcohol, benzaldehyde, benzene, 1,3,5-trimethyl-, decanal, furfural, furfuryl alcohol, heptanal, heptyl alcohol, hexanal, hexanoic acid, hexyl alcohol, isoamyl alcohol, isobutyl isobutyrate, methyl 2-pyrrolyl ketone, methylcyclopentenolone, nonanal, nonyl alcohol, phenylacetaldehyde, pyrazine, pyridine, pyrrole, valeraldehyde, 2,3-butanediol, 2-phenyl-2-butenal, 3-ethyl-2,6-dimethylpyrazine, 5,6,7,8-tetrahydroquinoxaline, d-limonene, heptyl formate, trans-2-heptenal, 1-octanol, 2-acetyl-1-pyrroline, 2-undecenal, benzyl benzoate, cinnamaldehyde, (e)-, piperonal, vanillin, (e,e)-3,5-octadien-2-one, 2-ethyl-5-methylpyrazine, 2-ethylfuran, 2-heptanone, 2-pyrrolidone, caffeine, gamma-nonalactone, maltol, phenethyl acetate, 2-ethylpyrazine, 2-methoxy-4-vinylphenol, 3-octanone, 3-phenylpropionaldehyde, 4-hydroxybutanoic acid lactone, alpha-pinene, delta-3-carene, dihydrocoumarin, ethyl 2-methylbutyrate, ethyl benzoate, gamma-hexalactone, hexyl acetate, isobutyric acid, isovaleric acid, naphthalene, phenethyl alcohol, propylene glycol, styrene, 4-methylthiazole, alpha-phellandrene, methylsulfinylmethane, palmitic acid, pyruvaldehyde, pyruvic acid, 2,5-dimethylfuran, 2-butanone, 2-butylfuran, 2-decanone, 3-hepten-2-one, 4-carvomenthenol, 4-heptanone, 4-methyl-5-thiazoleethanol, 5-ethyl-2,3-dimethylpyrazine, butyric acid, delta-octalactone, gamma-heptalactone, heptanoic acid, methyl heptanoate, methyl hexanoate, methyl octanoate, methyl valerate, octanal, octanoic acid, o-methylanisole, p-mentha-1,4-diene, terpinolene, thiazole, trans-2-hexenal, valeric acid, 1-octen-3-one, 1-penten-3-ol, 3-hexanol, 3-penten-2-one, beta-angelicalactone, nonanoic acid, o-cymene, p-tolyl acetate, tetrahydrofurfuryl alcohol, 1-methylnaphthalene, 3-furaldehyde, 3-methyl-2-cyclohexen-1-one, 1-rhamnose, (e)-2-octen-1-ol, 1-ethyl-2-pyrrolecarboxaldehyde, 1-methylpyrrole, 2-acetyl-2-thiazoline, 2-methylpentanal, 3-n-butylphthalide, 4,5-dihydro-3(2h)thiophenone, 4-hydroxy-2,5-dimethyl-3(2h)-furanone, 4-hydroxy-5-methyl-3(2h)-furanone, 5h-5-methyl-6,7-dihydrocyclopenta(b)pyrazine, 5-isopropyl-2-methylpyrazine, 5-methylfurfuryl alcohol, acetophenone, benzoic acid, cyclopentanone, dimethyl disulfide, dimethyl trisulfide, indole, isopropenylpyrazine, n-furfurylpyrrole, oleic acid, phenethyl butyrate, propionic acid, trimethyloxazole, 2-heptanol, 2-pentanone, 1-tyrosine, methyl nicotinate, 1-nonene, 1-octene, cinnamaldehyde, hydroxyacetone, hexyl formate, phenethyl benzoate, 1-hexadecanol, 1-tetradecanol, 2-ethylhexyl benzoate, benzophenone, butyl isobutyrate, epsilon-decalactone, ethyl decanoate, ethyl laurate, ethyl myristate, ethyl octanoate, ethyl palmitate, guaiacol, lauric acid, methyl acetate, myristic acid, n-capric acid isobutyl ester, pentadecanoic acid, 3-methylbutyl ester, phenethyl decanoate, phenethyl octanoate, propyl p-hydroxybenzoate, stearic acid, 2,6-dimethylpyrazine, 2-acetyl-3-methylpyrazine, benzyl alcohol, menthol racemic, s-methyl thioacetate, 2-methoxy-3(5 and 6)-isopropylpyrazine, glycerol, 2-ethyl-1-hexanol, (tri-)acetin, 5-methyl-2-phenyl-2-hexenal, butyl acetate, undecyl alcohol, isobutyl acetate, propyl acetate, tetrahydrofurfuryl acetate, 2-isobutyl-4,5-dimethyloxazole, 2,6-dimethyl-4-heptanone, 4-methyl-5-vinylthiazole, beta-pinene, 2,3-hexanedione, 3-(methylthio)propionaldehyde, beta-caryophyllene, delta-hexadecalactone, difurfuryl ether, trans,trans-2,4-octadienal, 2-methylheptanoic acid, ethyl nonanoate, 2-heptylfuran, camphene, cyclohexanone, ethyl heptanoate, ethyl hexanoate, ethyl lactate, gamma-valerolactone, heptyl acetate, isopropenyl acetate, methyl butyrate, methyl levulinate, butylamine, methyl nonanoate, 3-methyl-2-butanol, 6-methyl-5-hepten-2-one, isoamyl acetate, 2-acetyl-3-ethylpyrazine, 2-acetylpyridine, butyl butyrate, lauryl alcohol, p-cymene, 3,4-dimethylthiophene, 4-hydroxybenzoic acid, 9-octadecenoic acid, ethyl ester, ethyl pyruvate, isopropylamine, 3-methyl-1-pentanol, 2-oxobutyric acid, 4-methyl-2-phenyl-2-pentenal, 2-acetyl-3,5(and 6)-dimethylpyrazine, trimethylamine, 2(3),5-dimethyl-6,7-dihydro-5h-cyclopentapyrazine, methyl cinnamate, amyl formate, 5-hydroxyundecanoic acid lactone, propiophenone, 2-isopropylpyrazine, 2-ethylbutyl acetate, 2-acetyl-5-methylfuran, acetaldehyde, gamma-decalactone, trans-2-decenol, 4,5-dimethylthiazole, isobutyl butyrate, tridecanoic acid, and 1-mercapto-2-propanone. In some cases, the one or more isolated VOCs do not include at least one compound selected from the group consisting of 2-ethyl furan, 5-methylfurfural, cyclopentanone, furfural, and limonene. In some cases, the one or more isolated VOCs do not include isopropenyl pyrazine and gamma-decalactone.

In some cases, the one or more isolated VOCs can include at least one compound selected from the group consisting of isopropenyl pyrazine and gamma-decalactone. In some cases, the one or more isolated VOCs can include at least one compound selected from the group consisting of 2,2,4-trimethyl-1,3-oxacyclopentane, 2-furyl methyl ketone, delta-hexalactone, octanal propyleneglycol acetal, (+/−)-trans- and cis-2-hexenal propylene glycol acetal, 2-isobutyl-4-methyl-1,3-dioxolane, cis- and trans-ethyl 2,4-dimethyl-1,3-dioxolane-2-acetate, eugenol, valeraldehyde propyleneglycol acetal, isopropenyl pyrazine, and gamma-decalactone.

In some cases, the one or more isolated VOCs can include at least one compound selected from the group consisting of 2,3,5-trimethylpyrazine, 2,3-diethylpyrazine, 2,3-diethyl-5-methylpyrazine, 2,5-dimethylpyrazine, 2,6-dimethylpyrazine, 2,3-dimethylpyrazine, 2-ethyl-3-methylpyrazine, 2-ethylpyrazine, 2-methylpyrazine, isopropenyl pyrazine, tetramethylpyrazine, (E,E)-2,4-decadienal, 1-octen-3-ol, 2-ethyl furan, 2-heptanone, 5-methylfurfural, benzaldehyde, coffee furanone, cyclopentanone, dimethyl trisulfide, furfural, gamma-decalactone, limonene, pyridine, isovaleric acid, syringol, valeraldehyde, esters, 4-ethylguaiacol, furfuryl mercaptan, 3-(methylthio)propionaldehyde, 2-methyltetrahydrofuran-3-one, acetic acid, 2-furyl methyl ketone, s-methyl 3-methylbutanethioate, acetoin, methyl sulfide, butyric acid, 4-methyl-5-thiazoleethanol, indole, hexanal, acetophenone, furfuryl alcohol, 2-methoxy-3(5 and 6)-isopropylpyrazine, 4-methyl-5-thiazoleethanol acetate, 2-ethoxy-3-methylpyrazine, pentanal, p-cresol, isobutyraldehyde, delta-octalactone, 5-methyl-2-hepten-4-one, linalool, beta damascenone, eugenol, vanillin, 2,3-pentanedione, 4-hydroxy-2,5-dimethyl-3(2h)-furanone, maltol, 1-lactic acid, 2-ethyl-6-methylpyrazine, 2-acetylpyridine, methional, 3-methylbutyraldehyde, phenylacetaldehyde, phenethyl alcohol, 3,4-Hexanedione, 1-(2-Furanyl)-ethanone, 5-Methyl-2-furancarboxaldehyde, 3-Methyl-2-butenal, 3-ethyl-3,6-dimethyl-2h-pyrazine, 3-furaldehyde, dihydrocoumarin, 5-hydroxy-2,4-decadienoic acid delta-lactone, 2,2,4-trimethyl-1,3-oxacyclopentane, delta-hexalactone, octanal propyleneglycol acetal, (+/−)-trans- and cis-2-hexenal propylene glycol acetal, 2-isobutyl-4-methyl-1,3-dioxolane, cis- and trans-ethyl 2,4-dimethyl-1,3-dioxolane-2-acetate, and valeraldehyde propyleneglycol acetal.

In some cases, the one or more isolated VOCs can include at least 1 compound, at least 2 compounds, at least 3 compounds, at least 4 compounds, at least 5 compounds, at least 6 compounds, at least 7 compounds, at least 8 compounds, at least 9 compounds, at least 10 compounds, at least 11 compounds, at least 12 compounds, at least 13 compounds, at least 14 compounds, at least 15 compounds, at least 16 compounds, at least 17 compounds, at least 18 compounds, at least 19 compounds, at least 20 compounds, at least 21 compounds, at least 22 compounds, at least 23 compounds, at least 24 compounds, at least 25 compounds, at least 26 compounds, at least 27 compounds, at least 28 compounds, at least 29 compounds, at least 30 compounds, at least 35 compounds, at least 40 compounds, at least 45 compounds, at least 50 compounds, at least 55 compounds, at least 60 compounds, at least 65 compounds, or at least 70 compounds selected from the group consisting of 2,3,5-trimethylpyrazine, 2,3-diethylpyrazine, 2,3-diethyl-5-methylpyrazine, 2,5-dimethylpyrazine, 2,6-dimethylpyrazine, 2,3-dimethylpyrazine, 2-ethyl-3-methylpyrazine, 2-ethylpyrazine, 2-methylpyrazine, isopropenyl pyrazine, tetramethylpyrazine, (E,E)-2,4-decadienal, 1-octen-3-ol, 2-ethyl furan, 2-heptanone, 5-methylfurfural, benzaldehyde, coffee furanone, cyclopentanone, dimethyl trisulfide, furfural, gamma-decalactone, limonene, pyridine, isovaleric acid, syringol, valeraldehyde, esters, 4-ethylguaiacol, furfuryl mercaptan, 3-(methylthio)propionaldehyde, 2-methyltetrahydrofuran-3-one, acetic acid, 2-furyl methyl ketone, s-methyl 3-methylbutanethioate, acetoin, methyl sulfide, butyric acid, 4-methyl-5-thiazoleethanol, indole, hexanal, acetophenone, furfuryl alcohol, 2-methoxy-3(5 and 6)-isopropylpyrazine, 4-methyl-5-thiazoleethanol acetate, 2-ethoxy-3-methylpyrazine, pentanal, p-cresol, isobutyraldehyde, delta-octalactone, 5-methyl-2-hepten-4-one, linalool, beta damascenone, eugenol, vanillin, 2,3-pentanedione, 4-hydroxy-2,5-dimethyl-3(2h)-furanone, maltol, 1-lactic acid, 2-ethyl-6-methylpyrazine, 2-acetylpyridine, methional, 3-methylbutyraldehyde, phenylacetaldehyde, phenethyl alcohol, 3,4-Hexanedione, 1-(2-Furanyl)-ethanone, 5-Methyl-2-furancarboxaldehyde, 3-Methyl-2-butenal, 3-ethyl-3,6-dimethyl-2h-pyrazine, 3-furaldehyde, dihydrocoumarin, and 5-hydroxy-2,4-decadienoic acid delta-lactone.

The 2,3,5-trimethylpyrazine can be present in an amount of no greater than about 4 ppm, no greater than about 3.5 ppm, no greater than about 3 ppm, no greater than about 2.5 ppm, no greater than about 2 ppm, or less than about 1.5 ppm. In some embodiments, 2,3,5-trimethylpyrazine can be present in an amount of about 0.1-4 ppm, about 0.1-3 ppm, about 0.1-2 ppm, about 0.1-1 ppm, about 0.5-4 ppm, about 0.5-3 ppm, about 0.5-2 ppm, about 0.5-1 ppm, about 1-4 ppm about 1-3 ppm, or about 1-2 ppm.

The 2,3-diethyl-5-methylpyrazine can be present in an amount of no greater than about 0.5 ppm, no greater than about 0.4 ppm, no greater than about 0.3 ppm, no greater than about 0.2 ppm, no greater than about 0.1 ppm, no greater than about 0.05 ppm, or less than about 0.03 ppm. In some embodiments, the 2,3-diethyl-5-methylpyrazine can be present in an amount of about 0.01-0.5 ppm, about 0.05-0.5 ppm, or about 0.1-0.5 ppm.

The 2,3-diethylpyrazine can be present in an amount of no greater than about 10 ppm, no greater than about 9 ppm, no greater than about 8 ppm, no greater than about 7 ppm, no greater than about 6 ppm, no greater than about 5 ppm, no greater than about 4 ppm, no greater than about 3 ppm, no greater than about 2 ppm, no greater than about 1 ppm, no greater than about 0.5 ppm, no greater than about 0.1 ppm, no greater than about 0.05 ppm, no greater than about 0.01 ppm, or less than about 0.004 ppm. In some embodiments, the 2,3-diethylpyrazine can be present in an amount of about 0.001-10 ppm, about 0.01-10 ppm, about 0.1-10 ppm, or about 1-10 ppm.

The 2,5-dimethylpyrazine can be present in an amount of no greater than about 10 ppm, no greater than about 9 ppm, no greater than about 8 ppm, no greater than about 7 ppm, no greater than about 6 ppm, no greater than about 5 ppm, no greater than about 4 ppm, or less than about 3.0 ppm. In some embodiments, the 2,5-dimethylpyrazine can be present in an amount of about 1-10 ppm, or about 5-10 ppm.

The 2,6-dimethylpyrazine can be present in an amount of no greater than about 10 ppm, no greater than about 9 ppm, no greater than about 8 ppm, no greater than about 7 ppm, no greater than about 6 ppm, no greater than about 5 ppm, no greater than about 4 ppm, no greater than about 3 ppm, no greater than about 2 ppm, no greater than about 1 ppm, or less than about 0.6 ppm. In some embodiments, the 2,6-dimethylpyrazine can be present in an amount of about 0.1-10 ppm, about 0.5-10 ppm, about 1-10 ppm, or about 5-10 ppm.

The 2,3-dimethylpyrazine can be present in an amount of no greater than about 10 ppm, no greater than about 9 ppm, no greater than about 8 ppm, no greater than about 7 ppm, no greater than about 6 ppm, no greater than about 5 ppm, no greater than about 4 ppm, no greater than about 3 ppm, or at least 2.0 ppm. In some embodiments, the 2,3-dimethylpyrazine can be present in an amount of about 1-10 ppm, about 2-10 ppm, or about 5-10 ppm.

The 2-ethyl-3-methylpyrazine can be present in an amount of no greater than about 5.47 ppm, no greater than about 5 ppm, no greater than about 4 ppm, no greater than about 3 ppm, no greater than about 2 ppm, no greater than about 1 ppm, or less than about 0.05 ppm. In some embodiments, the 2-ethyl-3-methylpyrazine can be present in an amount of about 0.01-10 ppm, about 0.05-10 ppm, or about 1-10 ppm.

The 2-ethylpyrazine can be present in an amount of no greater than about 10 ppm, no greater than about 9 ppm, no greater than about 8 ppm, no greater than about 7 ppm, or at least 6.0 ppm. In some embodiments, the 2-ethylpyrazine can be present in an amount of about 5-10 ppm, about 6-10 ppm, or about 8-10 ppm.

The 2-methylpyrazine can be present in an amount of no greater than about 10 ppm, no greater than about 9 ppm, no greater than about 8 ppm, no greater than about 7 ppm, or at least 6.0 ppm. In some embodiments, the 2-methylpyrazine can be present in an amount of about 5-10 ppm, about 6-10 ppm, or about 8-10 ppm.

The isopropenyl pyrazine can be present in an amount of no greater than about 10 ppm, no greater than about 9 ppm, no greater than about 8 ppm, no greater than about 7 ppm, no greater than about 6 ppm, no greater than about 5 ppm, no greater than about 4 ppm, no greater than about 3 ppm, no greater than about 2 ppm, no greater than about 1 ppm, or at least 0.05 ppm. In some embodiments, the isopropenyl pyrazine can be present in an amount of about 0.05-10 ppm, about 0.5-10 ppm, or about 5-10 ppm.

The tetramethylpyrazine can be present in an amount of no greater than about 10 ppm, no greater than about 9 ppm, no greater than about 8 ppm, no greater than about 7 ppm, no greater than about 6 ppm, no greater than about 5 ppm, no greater than about 4 ppm, no greater than about 3 ppm, no greater than about 2 ppm, no greater than about 1 ppm, no greater than about 0.01 ppm, or less than about 0.004 ppm. In some embodiments, the tetramethylpyrazine can be present in an amount of about 0.001-10 ppm, about 0.01-10 ppm, about 0.1-10 ppm, or about 1-10 ppm.

The (E,E)-2,4-decadienal can be present in an amount of no greater than about 8.92 ppm, no greater than about 8 ppm, no greater than about 7 ppm, no greater than about 6 ppm, no greater than about 5 ppm, no greater than about 4 ppm, or less than about 3.0 ppm. In some embodiments, the (E,E)-2,4-decadienal can be present in an amount of about 1-10 ppm, or about 5-10 ppm.

The 1-octen-3-ol can be present in an amount of no greater than about 6 ppm, no greater than about 5 ppm, no greater than about 4 ppm, no greater than about 3 ppm, no greater than about 2 ppm, no greater than about 1 ppm, no greater than about 0.5 ppm, no greater than about 0.1 ppm, or less than 0.03 ppm. In some embodiments, the 1-octen-3-ol can be present in an amount of about 0.01-10 ppm, about 0.1-10 ppm, or about 1-10 ppm.

The 2-ethyl furan can be present in an amount of no greater than about 22.5 ppm, no greater than about 20 ppm, no greater than about 15 ppm, no greater than about 10 ppm, no greater than about 5 ppm, no greater than about 1 ppm, no greater than about 0.1 ppm, or at least 0.08 ppm. In some embodiments, the 2-ethyl furan can be present in an amount of about 0.05-30 ppm, about 0.5-30 ppm, or about 5-30 ppm.

The 2-heptanone can be present in an amount of no greater than about 30 ppm, no greater than about 25 ppm, no greater than about 20 ppm, no greater than about 15 ppm, or at least 10 ppm. In some embodiments, the 2-heptanone can be present in an amount of about 10-30 ppm, about 20-30 ppm, or about 10-20 ppm.

The 5-methylfurfural can be present in an amount of no greater than about 2.25 ppm, no greater than about 2 ppm, no greater than about 1.5 ppm, no greater than about 1 ppm, no greater than about 0.5 ppm, or less than about 0.2 ppm. In some embodiments, the 5-methylfurfural can be present in an amount of about 0.1-5 ppm, or about 1-5 ppm.

The benzaldehyde can be present in an amount of no greater than about 171.26 ppm, no greater than about 150 ppm, no greater than about 120 ppm, no greater than about 100 ppm, no greater than about 80 ppm, no greater than about 50 ppm, no greater than about 30 ppm, or at least about 10 ppm. In some embodiments, the benzaldehyde can be present in an amount of about 10-200 ppm, about 50-200 ppm, or about 100-200 ppm.

The coffee furanone can be present in an amount of no greater than about 10 ppm, no greater than about 9 ppm, no greater than about 8 ppm, no greater than about 7 ppm, no greater than about 6 ppm, no greater than about 5 ppm, or at least about 4.0 ppm. In some embodiments, the coffee furanone can be present in an amount of about 1-10 ppm, or about 4-10 ppm.

The cyclopentanone can be present in an amount of no greater than about 2 ppm, no greater than about 1 ppm, no greater than about 0.1 ppm, no greater than about 0.01 ppm, or less than about 0.001 ppm. In some embodiments, the cyclopentanone can be present in an amount of about 0.001-5 ppm, about 0.001-2 ppm, about 0.01-2 ppm, or about 0.1-2 ppm.

The dimethyl trisulfide can be present in an amount of no greater than about 1 ppm, no greater than about 0.5 ppm, no greater than about 0.1 ppm, no greater than about 0.05 ppm, or less than about 0.02 ppm. In some embodiments, the dimethyl trisulfide can be present in an amount of about 0.01-1 ppm, about 0.1-1 ppm, or about 0.5-1 ppm.

The furfural can be present in an amount of no greater than about 52.56 ppm, no greater than about 50 ppm, no greater than about 40 ppm, no greater than about 30 ppm, no greater than about 20 ppm, no greater than about 10 ppm, no greater than about 5 ppm, no greater than about 1 ppm, or less than about 0.4 ppm. In some embodiments, the furfural can be present in an amount of about 0.1-100 ppm, about 0.5-100 ppm, about 1-50 ppm, or about 10-50 ppm.

The gamma-decalactone can be present in an amount of no greater than about 20.65 ppm, no greater than about 15 ppm, no greater than about 10 ppm, or at least about 5.0 ppm. In some embodiments, the gamma-decalactone can be present in an amount of about 5-50 ppm, about 10-50 ppm, or about 20-50 ppm.

The limonene can be present in an amount of no greater than about 511 ppm, no greater than about 500 ppm, no greater than about 400 ppm, no greater than about 300 ppm, no greater than about 200 ppm, no greater than about 100 ppm, no greater than about 50 ppm, or at least about 14 ppm. In some embodiments, the limonene can be present in an amount of about 10-600 ppm, about 50-500 ppm, or about 100-300 ppm.

The pyridine can be present in an amount of no greater than about 7.76 ppm, no greater than about 5 ppm, no greater than about 3 ppm, no greater than about 2 ppm, no greater than about 1 ppm, no greater than about 0.5 ppm, no greater than about 0.1 ppm, or less than about 0.05 ppm. In some embodiments, the pyridine can be present in an amount of about 0.01-5 ppm, about 0.05-5 ppm, about 0.1-5 ppm, or about 1-5 ppm.

The isovaleric acid can be present in an amount of no greater than about 7.76 ppm, no greater than about 6 ppm, no greater than about 5 ppm, no greater than about 4 ppm, no greater than about 3 ppm, no greater than about 2 ppm, no greater than about 1 ppm, or at least 0.7 ppm.

In some embodiments, the isovaleric acid can be present in an amount of about 0.5-10 ppm, about 1-10 ppm, or about 5-10 ppm.

The syringol can be present in an amount of no greater than about 5 ppm, no greater than about 4 ppm, no greater than about 3 ppm, no greater than about 2 ppm, no greater than about 1 ppm, no greater than about 0.5 ppm, or less than 0.1 ppm. In some embodiments, the syringol can be present in an amount of about 0.01-10 ppm, about 0.1-5 ppm, or about 1-5 ppm.

The valeraldehyde can be present in an amount of no greater than about 6.15 ppm, no greater than about 5 ppm, no greater than about 4 ppm, no greater than about 3 ppm, no greater than about 2 ppm, no greater than about 1 ppm, or at least about 0.6 ppm. In some embodiments, the valeraldehyde can be present in an amount of about 0.5-10 ppm, about 1-10 ppm, or about 5-10 ppm.

The 4-ethylguaiacol can be present in an amount of no greater than about 12 ppm, no greater than about 10 ppm, no greater than about 8 ppm, no greater than about 6 ppm, no greater than about 4 ppm, no greater than about 2 ppm, or no greater than about 1 ppm. In some embodiments, the 4-ethylguaiacol can be present in an amount of about 0.1-20 ppm, about 1-12 ppm, or about 5-12 ppm.

The furfuryl mercaptan can be present in an amount of no greater than about 3.55 ppm, no greater than about 3 ppm, no greater than about 2 ppm, no greater than about 1 ppm, no greater than about 0.1 ppm, no greater than about 0.05 ppm, no greater than about 0.01 ppm, no greater than about 0.005 ppm, or no greater than about 0.001 ppm. In some embodiments, the furfuryl mercaptan can be present in an amount of about 0.001-5 ppm, about 0.01-5 ppm, about 0.1-5 ppm, or about 1-5 ppm.

The 3-(methylthio)propionaldehyde can be present in an amount of no greater than about 4.6 ppm, no greater than about 4.3 ppm, no greater than about 4 ppm, no greater than about 3.6 ppm, no greater than about 3.2 ppm, no greater than about 3 ppm, no greater than about 2 ppm, no greater than about 1 ppm, no greater than about 0.5 ppm, or no greater than about 0.1 ppm. In some embodiments, the 3-(methylthio)propionaldehyde can be present in an amount of about 0.1-5 ppm, about 0.5-5 ppm, or about 1-5 ppm.

The 2-methyltetrahydrofuran-3-one can be present in an amount of no greater than about 10 ppm, no greater than about 8 ppm, no greater than about 5 ppm, no greater than about 3 ppm, or no greater than about 1 ppm. In some embodiments, the 2-methyltetrahydrofuran-3-one can be present in an amount of about 1-10 ppm, or about 5-10 ppm.

The acetic acid can be present in an amount of no greater than about 5900 ppm, no greater than about 5000 ppm, no greater than about 4000 ppm, no greater than about 3000 ppm, no greater than about 2000 ppm, no greater than about 1000 ppm, or no greater than about 500 ppm. In some embodiments, the acetic acid can be present in an amount of about 100-10000 ppm, about 100-6000 ppm, or about 1000-6000 ppm.

The 2-furyl methyl ketone can be present in an amount of no greater than about 20 ppm, no greater than about 15 ppm, no greater than about 10 ppm, no greater than about 5 ppm, or no greater than about 1 ppm. In some embodiments, the 2-furyl methyl ketone can be present in an amount of about 1-20 ppm, about 5-20 ppm, or about 10-20 ppm.

The s-methyl 3-methylbutanethioate can be present in an amount of no greater than about 0.1 ppm, no greater than about 0.08 ppm, no greater than about 0.05 ppm, no greater than about 0.03 ppm, or no greater than about 0.01 ppm. In some embodiments, the s-methyl 3-methylbutanethioate can be present in an amount of about 0.01-0.5 ppm, about 0.05-0.5 ppm, or about 0.1-0.5 ppm.

The acetoin can be present in an amount of no greater than about 50 ppm, no greater than about 40 ppm, no greater than about 30 ppm, no greater than about 20 ppm, no greater than about 10 ppm, no greater than about 8 ppm, no greater than about 7 ppm, no greater than about 6 ppm, no greater than about 5 ppm, no greater than about 4 ppm, no greater than about 3 ppm, no greater than about 2 ppm, or no greater than about 1 ppm. In some embodiments, the acetoin can be present in an amount of about 1-50 ppm, about 5-50 ppm, or about 10-50 ppm.

The methyl sulfide can be present in an amount of no greater than about 1.77 ppm, no greater than about 1.5 ppm, no greater than about 1.2 ppm, no greater than about 0.8 ppm, no greater than about 0.5 ppm, or no greater than about 0.3 ppm. In some embodiments, the methyl sulfide can be present in an amount of about 0.1-5 ppm, about 0.5-5 ppm, about 0.5-2 ppm, or about 0.1-1.5 ppm.

The butyric acid can be present in an amount of no greater than about 200 ppm, no greater than about 180 ppm, no greater than about 150 ppm, no greater than about 120 ppm, or no greater than about 100 ppm. In some embodiments, the butyric acid can be present in an amount of about 1-200 ppm, about 10-200 ppm, about 50-200 ppm, or about 100-200 ppm.

The 4-methyl-5-thiazoleethanol can be present in an amount of no greater than about 55 ppm, no greater than about 50 ppm, no greater than about 40 ppm, no greater than about 30 ppm, no greater than about 20 ppm, or no greater than about 10 ppm. In some embodiments, the 4-methyl-5-thiazoleethanol can be present in an amount of about 1-100 ppm, about 1-55 ppm, about 10-55 ppm, or about 20-55 ppm.

The indole can be present in an amount of no greater than about 1.34 ppm, no greater than about 1.2 ppm, no greater than about 1 ppm, no greater than about 0.8 ppm, no greater than about 0.5 ppm, no greater than about 0.3 ppm, or no greater than about 0.1 ppm. In some embodiments, the indole can be present in an amount of about 0.1-2 ppm, about 0.5-2 ppm, or about 0.1-1.5 ppm.

The hexanal can be present in an amount of no greater than about 9.51 ppm, no greater than about 9 ppm, no greater than about 8 ppm, no greater than about 7 ppm, no greater than about 6 ppm, no greater than about 5 ppm, no greater than about 4 ppm, no greater than about 3 ppm, no greater than about 2 ppm, or no greater than about 1 ppm. In some embodiments, the hexanal can be present in an amount of about 0.1-10 ppm, about 1-10 ppm, or about 5-10 ppm.

The acetophenone can be present in an amount of no greater than about 28.25 ppm, no greater than about 25 ppm, no greater than about 20 ppm, no greater than about 15 ppm, no greater than about 10 ppm, or no greater than about 5 ppm. In some embodiments, the acetophenone can be present in an amount of about 1-30 ppm, about 5-30 ppm, or about 10-30 ppm.

The furfuryl alcohol can be present in an amount of no greater than about 19.48 ppm, no greater than about 15 ppm, no greater than about 12 ppm, no greater than about 8 ppm, no greater than about 5 ppm, or no greater than about 3 ppm. In some embodiments, the furfuryl alcohol can be present in an amount of about 1-20 ppm, about 5-20 ppm, or about 10-20 ppm.

The 2-methoxy-3(5 and 6)-isopropylpyrazine can be present in an amount of no greater than about 0.2 ppm, no greater than about 0.15 ppm, no greater than about 0.1 ppm, no greater than about 0.05 ppm, or no greater than about 0.01 ppm. In some embodiments, the 2-methoxy-3(5 and 6)-isopropylpyrazine can be present in an amount of about 0.01-0.2 ppm, about 0.05-0.2 ppm, or about 0.1-0.2 ppm.

The 4-methyl-5-thiazoleethanol acetate can be present in an amount of no greater than about 55 ppm, no greater than about 50 ppm, no greater than about 40 ppm, no greater than about 30 ppm, no greater than about 20 ppm, or no greater than about 10 ppm. In some embodiments, the 4-methyl-5-thiazoleethanol acetate can be present in an amount of about 10-100 ppm, about 10-55 ppm, or about 1-55 ppm.

The 2-ethoxy-3-methylpyrazine can be present in an amount of no greater than about 5 ppm, no greater than about 4 ppm, no greater than about 3 ppm, no greater than about 2 ppm, or no greater than about 1 ppm. In some embodiments, the 2-ethoxy-3-methylpyrazine can be present in an amount of about 0.1-5 ppm, about 0.5-5 ppm, or about 1-5 ppm.

The pentanal can be present in an amount of no greater than about 6.15 ppm, no greater than about 6 ppm, no greater than about 5 ppm, no greater than about 4 ppm, no greater than about 3 ppm, no greater than about 2 ppm, or no greater than about 1 ppm. In some embodiments, the pentanal can be present in an amount of about 0.1-10 ppm, about 1-10 ppm, or about 1-6 ppm.

The p-cresol can be present in an amount of no greater than about 7.7 ppm, no greater than about 7 ppm, no greater than about 6 ppm, no greater than about 5 ppm, no greater than about 4 ppm, no greater than about 3 ppm, no greater than about 2 ppm, or no greater than about 1 ppm. In some embodiments, the p-cresol can be present in an amount of about 0.1-10 ppm, about 1-10 ppm, or about 1-8 ppm.

The isobutyraldehyde can be present in an amount of no greater than about 5.8 ppm, no greater than about 5.5 ppm, no greater than about 5 ppm, no greater than about 4.5 ppm, no greater than about 4 ppm, no greater than about 3.5 ppm, or no greater than about 3 ppm. In some embodiments, the isobutyraldehyde can be present in an amount of about 0.1-10 ppm, about 1-10 ppm, or about 1-6 ppm.

The delta-octalactone can be present in an amount of no greater than about 15.53 ppm, no greater than about 12 ppm, no greater than about 10 ppm, no greater than about 8 ppm, no greater than about 5 ppm, or no greater than about 3 ppm. In some embodiments, the delta-octalactone can be present in an amount of about 1-20 ppm, about 5-20 ppm, or about 10-20 ppm.

The 5-methyl-2-hepten-4-one can be present in an amount of no greater than about 20 ppm, no greater than about 18 ppm, no greater than about 15 ppm, no greater than about 12 ppm, no greater than about 10 ppm, or no greater than about 8 ppm. In some embodiments, the 5-methyl-2-hepten-4-one can be present in an amount of about 1-20 ppm, about 5-20 ppm, or about 10-20 ppm.

The linalool can be present in an amount of no greater than about 40 ppm, no greater than about 30 ppm, no greater than about 20 ppm, no greater than about 10 ppm, or no greater than about 5 ppm. In some embodiments, the linalool can be present in an amount of about 1-50 ppm, about 10-50 ppm, or about 20-50 ppm.

The beta-damascenone can be present in an amount of no greater than about 0.2 ppm, no greater than about 0.15 ppm, no greater than about 0.1 ppm, no greater than about 0.05 ppm, or no greater than about 0.01 ppm. In some embodiments, the beta-damascenone can be present in an amount of about 0.01-1 ppm, about 0.01-0.2 ppm, or about 0.05-0.2 ppm.

The eugenol can be present in an amount of no greater than about 100 ppm, no greater than about 80 ppm, no greater than about 60 ppm, no greater than about 40 ppm, no greater than about 20 ppm, or no greater than about 10 ppm. In some embodiments, the eugenol can be present in an amount of about 1-100 ppm, about 10-100 ppm, or about 50-100 ppm.

The vanillin can be present in an amount of no greater than about 407.99 ppm, no greater than about 400 ppm, no greater than about 350 ppm, no greater than about 300 ppm, no greater than about 250 ppm, no greater than about 200 ppm, no greater than about 150 ppm, or no greater than about 100 ppm. In some embodiments, the vanillin can be present in an amount of about 10-500 ppm, about 10-400 ppm, or about 100-400 ppm.

The 2,3-pentanedione can be present in an amount of no greater than about 10.98 ppm, no greater than about 10 ppm, no greater than about 8 ppm, no greater than about 6 ppm, no greater than about 4 ppm, no greater than about 2 ppm, or no greater than about 1 ppm. In some embodiments, the 2,3-pentanedione can be present in an amount of about 1-20 ppm, about 1-10 ppm, or about 5-10 ppm.

The 4-hydroxy-2,5-dimethyl-3(2h)-furanone can be present in an amount of no greater than about 60 ppm, no greater than about 50 ppm, no greater than about 40 ppm, no greater than about 30 ppm, no greater than about 20 ppm, or no greater than about 10 ppm. In some embodiments, the 4-hydroxy-2,5-dimethyl-3(2h)-furanone can be present in an amount of about 1-100 ppm, about 1-60 pm, or about 10-60 ppm.

The maltol can be present in an amount of no greater than about 267.2 ppm, no greater than about 250 ppm, no greater than about 200 ppm, no greater than about 150 ppm, no greater than about 100 ppm, or no greater than about 50 ppm. In some embodiments, the maltol can be present in an amount of about 10-300 ppm, about 100-300 ppm, or about 100-250 ppm.

The 1-lactic acid can be present in an amount of no greater than about 5000 ppm, no greater than about 4500 ppm, no greater than about 4000 ppm, no greater than about 3500 ppm, no greater than about 3000 ppm, no greater than about 2500 ppm, or no greater than about 2000 ppm. In some embodiments, the 1-lactic acid can be present in an amount of about 100-5000 ppm, about 1000-5000 ppm, or about 2000-5000 ppm.

The 2-ethyl-6-methylpyrazine can be present in an amount of no greater than about 5 ppm, no greater than about 4 ppm, no greater than about 3 ppm, no greater than about 2 ppm, or no greater than about 1 ppm. In some embodiments, the 2-ethyl-6-methylpyrazine can be present in an amount of about 0.1-5 ppm, about 0.5-5 ppm, or about 1-5 ppm.

The 2-acetylpyridine can be present in an amount of no greater than about 3 ppm, no greater than about 2 ppm, or no greater than about 1 ppm. In some embodiments, the 2-acetylpyridine can be present in an amount of about 1-10 ppm, about 1-5 ppm, or about 1-3 ppm.

The methional can be present in an amount of no greater than about 4.6 ppm, no greater than about 4.2 ppm, no greater than about 3.5 ppm, no greater than about 2.5 ppm, or no greater than about 1 ppm. In some embodiments, the methional can be present in an amount of about 1-10 ppm or about 1-5 ppm.

The 3-methylbutyraldehyde can be present in an amount of no greater than about 16.81 ppm, no greater than about 15 ppm, no greater than about 12 ppm, no greater than about 8 ppm, no greater than about 5 ppm, or no greater than about 3 ppm. In some embodiments, the 3-methylbutyraldehyde can be present in an amount of about 1-20 ppm, about 1-15 ppm, or about 5-15 ppm.

The phenylacetaldehyde can be present in an amount of no greater than about 4.41 ppm, no greater than about 4 ppm, no greater than about 3.5 ppm, no greater than about 3 ppm, no greater than about 2.5 ppm, or no greater than about 2 ppm. In some embodiments, the phenylacetaldehyde can be present in an amount of about 1-10 ppm or about 1-5 ppm.

The phenethyl alcohol can be present in an amount of no greater than about 30.01 ppm, no greater than about 25 ppm, no greater than about 20 ppm, no greater than about 15 ppm, or no greater than about 10 ppm. In some embodiments, the phenethyl alcohol can be present in an amount of 1-50 ppm, about 1-30 ppm, or about 10-30 ppm.

The 3,4-hexanedione can be present in an amount of no greater than about 10 ppm, no greater than about 8 ppm, no greater than about 6 ppm, no greater than about 4 ppm, no greater than about 2 ppm, or no greater than about 1 ppm. In some embodiments, the 3,4-hexanedione can be present in an amount of 1-10 ppm or about 5-10 ppm.

The 1-(2-furanyl)-ethanone can be present in an amount of no greater than about 20 ppm, no greater than about 15 ppm, no greater than about 10 ppm, or no greater than about 5 pm. In some embodiments, the 1-(2-furanyl)-ethanone can be present in an amount of about 1-20 ppm, about 5-20 ppm, or about 10-20 ppm.

The 5-methyl-2-furancarboxaldehyde can be present in an amount of no greater than about 2.25 ppm, no greater than about 2 ppm, no greater than about 1.8 ppm, no greater than about 1.5 ppm, no greater than about 1.2 ppm, or no greater than about 0.8 ppm. In some embodiments, the 5-methyl-2-furancarboxaldehyde can be present in an amount of about 1-5 ppm or about 1-2.5 ppm.

The 3-methyl-2-butenal can be present in an amount of no greater than about 7.25 ppm, no greater than about 7 ppm, no greater than about 6 ppm, no greater than about 5 ppm, no greater than about 4 ppm, no greater than about 3 ppm, no greater than about 2 ppm, or no greater than about 1 ppm. In some embodiments, the 3-methyl-2-butenal can be present in an amount of 1-10 ppm or about 1-8 ppm.

The 3-ethyl-3,6-dimethyl-2h-pyrazine can be present in an amount of no greater than about 10 ppm, no greater than about 8 ppm, no greater than about 5 ppm, no greater than about 3 ppm, or no greater than about 1 ppm. In some embodiments, the 3-ethyl-3,6-dimethyl-2h-pyrazine can be present in an amount of about 1-10 ppm or about 5-10 ppm.

The 3-furaldehyde can be present in an amount of no greater than about 500 ppm, no greater than 450 ppm, no greater than about 400 ppm, no greater than about 350 ppm, or no greater than about 300 ppm. In some embodiments, the 3-furaldehyde can be present in an amount of about 1-500 ppm, about 10-500 ppm, or about 100-500 ppm.

The dihydrocoumarin can be present in an amount of no greater than about 130.7 ppm, no greater than about 120 ppm, no greater than 110 ppm, no greater than 100 ppm, no greater than 80 ppm, no greater than 60 ppm, no greater than 40 ppm, or no greater than 20 ppm. In some embodiments, the dihydrocoumarin can be present in an amount of about 1-200 ppm, about 1-130 ppm, about 10-130 ppm, or about 50-130 ppm.

The 5-hydroxy-2,4-decadienoic acid delta-lactone can be present in an amount of no greater than about 0.5 ppm, no greater than about 0.4 ppm, no greater than about 0.3 ppm, no greater than about 0.2 ppm, or no greater than about 0.1 ppm. In some embodiments, the 5-hydroxy-2,4-decadienoic acid delta-lactone can be present in an amount of about 0.1-1 ppm, about 0.1-0.5 ppm, or about 0.2-0.5 ppm.

In any of the above embodiments, the VOCs can include one or more of: an acid, an alcohol, an alkane, an aldehyde, an amine, a benzene, an ester, a furan, a ketone, a lactone, a phenol, a pyrazine, a pyridine, a pyrrole, a sugar or sugar alcohol, a sulfur compound, a terpene, or a thiophene. In some cases, the VOCs can include one or more of: an acid, an alcohol, an alkane, an aldehyde, an ester, a furan, a ketone, a lactone, a pyrazine, a pyridine, a sulfur compound, or a terpene. In some cases, the VOCs can include one or more of: an acid, an alcohol, an aldehyde, an ester, a furan, a ketone, a lactone, a phenol, a pyrazine, a pyrrole, a sugar or sugar alcohol, or a sulfur compound. In some cases, the VOCs can include one or more of an acid, an alcohol, an aldehyde, a benzene, an ester, a furan, a ketone, a lactone, a pyridine, a pyrizine, a pyrrole, a phenol, a sulfur compound, and/or a terpene.

The VOCs can include one or more acids. The one or more acids can include at least one acid selected from the group consisting of isovaleric acid, acetic acid, L-lactic acid, butyric acid, 2-methylbutyric acid, 4-hydroxy-2-butenoic acid gamma-lactone, hexanoic acid, 4-hydroxybutanoic acid lactone, isobutyric acid, palmitic acid, pyruvic acid, heptanoic acid, octanoic acid, valeric acid, nonanoic acid, benzoic acid, oleic acid, propionic acid, lauric acid, myristic acid, n-capric acid isobutyl ester, pentadecanoic acid, 3-methylbutyl ester, stearic acid, 2-methylheptanoic acid, 4-hydroxybenzoic acid, 9-octadecenoic acid, ethyl ester, 2-oxobutyric acid, 5-hydroxyundecanoic acid lactone, and tridecanoic acid, or any combination thereof. In some cases, the one or more acids can include at least one acid selected from the group consisting of acetic acid, 3-methylbutanoic acid, butyric acid, and L-lactic acid. In some cases, the one or more acids can include at least one acid selected from the group consisting of acetic acid, 3-methylbutanoic acid, and butyric acid. In some embodiments, the one or more acids comprise at least one acid selected from the group consisting of isovaleric acid, acetic acid, L-lactic acid, and/or butyric acid.

The VOCs can include one or more alcohols. The one or more alcohols can include at least one alcohol selected from the group consisting of 1-octen-3-ol, furfuryl alcohol, p-cresol, eugenol, phenethyl alcohol, 4-methyl-5-thiazoleethanol, (+/−) 2-methyl-1-butanol, amyl alcohol, heptyl alcohol, hexyl alcohol, isoamyl alcohol, nonyl alcohol, 2,3-butanediol, 1-octanol, 2-methoxy-4-vinylphenol, propylene glycol, 4-carvomenthenol, 1-penten-3-ol, 3-hexanol, tetrahydrofurfuryl alcohol, (e)-2-octen-1-ol, 5-methylfurfuryl alcohol, 2-heptanol, 1-hexadecanol, 1-tetradecanol, guaiacol, benzyl alcohol, glycerol, 2-ethyl-1-hexanol, undecyl alcohol, 3-methyl-2-butanol, lauryl alcohol, 3-methyl-1-pentanol, and trans-2-decenol, or any combination thereof. The one or more alcohols can include at least one alcohol selected from the group consisting of 1-octen-3-ol, 4-ethylguiacol, 2-pentanol, 2,4,6-trimethylphenol (mesitol), p-cresol, and eugenol. The one or more alcohols can include at least one alcohol selected from the group consisting of amyl alcohol, 2-methoxy-4-vinylphenol, furaneol, phenyl methanol (benzyl alcohol), 3-(Z)-hexenol, 3-mercapto hexanol, hexyl alcohol (hexanol), 1-octanol, isoamyl alcohol, 2-nonanol, 1-heptanol, para cresol, 1-decanol, and carvacrol. In some embodiments, the one or more alcohols comprise at least one alcohol selected from the group consisting of 1-octen-3-ol, furfuryl alcohol, p-cresol, eugenol, phenethyl alcohol, and/or 4-methyl-5-thiazoleethanol The VOCs can include one or more aldehydes. The one or more aldehydes can include at least one aldehyde selected from the group consisting of (E,E)-2,4-decadienal, 5-methylfurfural, benzaldehyde, furfural, valeraldehyde, 3-(methylthio)propionaldehyde, hexanal, isobutyraldehyde, vanillin, methional, phenylacetaldehyde, 3-furaldehyde, pentanal, 3-methylbutyraldehyde, 3-methyl-2-butenal, 4-methyl-5-thiazoleethanol acetate, 5-methyl-2-furancarboxaldehyde, 1-methyl-1h-pyrrole-2-carboxaldehyde, 2-methylbutyraldehyde, decanal, heptanal, nonanal, 2-phenyl-2-butenal, trans-2-heptenal, 2-undecenal, piperonal, 3-phenylpropionaldehyde, pyruvaldehyde, octanal, trans-2-hexenal, 1-ethyl-2-pyrrolecarboxaldehyde, 2-methylpentanal, cinnamaldehyde, 5-methyl-2-phenyl-2-hexenal, trans,trans-2,4-octadienal, 4-methyl-2-phenyl-2-pentenal, acetaldehyde, octanal propyleneglycol acetal, (+/−)-trans- and cis-2-hexenal propylene glycol acetal, and valeraldehyde propyleneglycol acetal, or any combination thereof. The one or more aldehydes can include at least one aldehyde selected from the group consisting of (E,E)-2,4-decadienal, 5-methylfurfural, benzaldehyde, furfural, methional, 3-(methylthio)propionaldehyde, isobutyraldehyde, valeraldehyde, vanillin, octanal propyleneglycol acetal, (+/−)-trans- and cis-2-hexenal propylene glycol acetal, and valeraldehyde propyleneglycol acetal. The one or more aldehydes can include at least one aldehyde selected from the group consisting of (E,E)-2,4-decadienal, methional, 3-(methylthio)propionaldehyde, isobutyraldehyde, valeraldehyde, octanal propyleneglycol acetal, (+/−)-trans- and cis-2-hexenal propylene glycol acetal, valeraldehyde propyleneglycol acetal, and vanillin. In some embodiments, the one or more aldehydes comprise at least one aldehyde selected from the group consisting of (E,E)-2,4-decadienal, 5-methylfurfural, benzaldehyde, furfural, valeraldehyde, 3-(methylthio)propionaldehyde, hexanal, isobutyraldehyde, vanillin, methional, phenylacetaldehyde, 3-furaldehyde, pentanal, 3-methylbutyraldehyde, 3-methyl-2-butenal, 4-methyl-5-thiazoleethanol acetate, and/or 5-methyl-2-furancarboxaldehyde.

The VOCs can include one or more amines. The one or more amines can include at least one amine selected from the group consisting of 2-amino-1-naphthalenol, 2-methoxy-benzenamine, 5-amino-1-naphthol, N,N-dimethyl-ethanamine, and N,N-dimethyl-methylamine, or any combination thereof.

The VOCs can include one or more benzenes. The one or more benzenes can include at least one benzene selected from the group consisting of dihydrocoumarin, styrene and toluene, or a combination thereof.

The VOCs can include one or more esters. The one or more esters can include at least one ester selected from the group consisting of isobutyl isobutyrate, heptyl formate, benzyl benzoate, phenethyl acetate, ethyl 2-methylbutyrate, ethyl benzoate, hexyl acetate, methyl heptanoate, methyl hexanoate, methyl octanoate, methyl valerate, p-tolyl acetate, phenethyl butyrate, methyl nicotinate, hexyl formate, phenethyl benzoate, 2-ethylhexyl benzoate, butyl isobutyrate, ethyl decanoate, ethyl laurate, ethyl myristate, ethyl octanoate, ethyl palmitate, methyl acetate, phenethyl decanoate, phenethyl octanoate, propyl p-hydroxybenzoate, s-methyl thioacetate, butyl acetate, isobutyl acetate, propyl acetate, tetrahydrofurfuryl acetate, ethyl nonanoate, ethyl heptanoate, ethyl hexanoate, ethyl lactate, heptyl acetate, isopropenyl acetate, methyl butyrate, methyl levulinate, methyl nonanoate, isoamyl acetate, butyl butyrate, ethyl pyruvate, methyl cinnamate, amyl formate, 2-ethylbutyl acetate, and isobutyl butyrate, or any combination thereof.

The one or more esters can include at least one ester selected from the group consisting of methyl thio isovalerate, propyl 2-mercaptopropionate, and cis- and trans-ethyl 2,4-dimethyl-1,3-dioxolane-2-acetate. The one or more esters can include at least one ester selected from the group consisting of methyl thio isovalerate, propyl 2-mercaptopropionate, and cis- and trans-ethyl 2,4-dimethyl-1,3-dioxolane-2-acetate. In some cases, the nut butter replica can include at least about 0.005 ppm, at least about 0.01 ppm, at least about 0.05 ppm, at least about 0.1 ppm, at least about 0.5 ppm, or at least about 1 ppm of esters.

The VOCs can include one or more furans. The one or more furans can include at least one furan selected from the group consisting of 2-ethyl furan, 1-(2-furanyl)-ethanone, 2-pentylfuran, 2,5-dimethylfuran, 2-butylfuran, 2-heptylfuran, and 2-acetyl-5-methylfuran, or any combination thereof. The one or more furans can include at least one furan selected from the group consisting of 2-pentylfuran and 2-ethylfuran. The one or more furans can include 2-ethylfuran. In some embodiments, the one or more furans comprise at least one furan selected from the group consisting of 2-ethyl furan and/or 1-(2-furanyl)-ethanone.

The VOCs can include one or more ketones. The one or more ketones can include at least one ketone selected from the group consisting of 2-heptanone, coffee furanone, cyclopentanone, gamma-decalactone, 2-methyltetrahydrofuran-3-one, 2-furyl methyl ketone, acetoin, acetophenone, delta-octalactone, 5-methyl-2-hepten-4-one, beta damascenone, 2,3-pentanedione, 4-hydroxy-2,5-dimethyl-3(2h)-furanone, maltol, 3,4-hexanedione, 1-penten-3-one, 2-nonanone, 2-octanone, 3-octen-2-one, 4-hexene-3-one, 4-methyl-3-penten-2-one, methyl 2-pyrrolyl ketone, methylcyclopentenolone, (e,e)-3,5-octadien-2-one, 2-pyrrolidone, gamma-nonalactone, 3-octanone, gamma-hexalactone, 2-butanone, 2-decanone, 3-hepten-2-one, 4-heptanone, gamma-heptalactone, 1-octen-3-one, 3-penten-2-one, beta-angelicalactone, 3-methyl-2-cyclohexen-1-one, 4,5-dihydro-3(2h)thiophenone, 4-hydroxy-5-methyl-3(2h)-furanone, 2-pentanone, hydroxyacetone, benzophenone, epsilon-decalactone, 2,6-dimethyl-4-heptanone, 2,3-hexanedione, delta-hexadecalactone, cyclohexanone, gamma-valerolactone, 6-methyl-5-hepten-2-one, propiophenone, 1-mercapto-2-propanone, and delta-hexalactone, or any combination thereof. The one or more ketones can include at least one ketone selected from the group consisting of 2-heptanone, coffee furanone, cyclopentanone, gamma-decalactone, 2-furyl methylketone, acetoin, gamma-valerolactone, delta octalactone, delta decalactone, whiskey lactone, delta-octalactone, 5-methyl-2-hepten-4-one, beta-damascenone, 2,3-pentanedione, 4-hydroxy-2,5-dimethyl-3(2H)-furanone, and maltol. The one or more ketones can include at least one ketone selected from the group consisting of 2-heptanone, coffee furanone, gamma-decalactone, 2-furyl methylketone, acetoin, gamma-valerolactone, delta octalactone, delta decalactone, whiskey lactone, delta-octalactone, 5-methyl-2-hepten-4-one, beta-damascenone, 2,3-pentanedione, 4-hydroxy-2,5-dimethyl-3(2H)-furanone, and maltol. In some embodiments, the one or more ketones comprise at least one ketone selected from the group consisting of 2-heptanone, coffee furanone, cyclopentanone, gamma-decalactone, 2-methyltetrahydrofuran-3-one, 2-furyl methyl ketone, acetoin, acetophenone, delta-octalactone, 5-methyl-2-hepten-4-one, beta damascenone, 2,3-pentanedione, 4-hydroxy-2,5-dimethyl-3(2h)-furanone, maltol, and/or 3,4-hexanedione. In some cases, the nut butter replica can include at least about 0.0001 ppm, at least about 0.0005 ppm, at least about 0.001 ppm, at least about 0.005 ppm, at least about 0.01 ppm, at least about 0.05 ppm, at least about 0.1 ppm, at least about 0.5 ppm, or at least about 1 ppm of ketones.

The VOCs can include one or more lactones. The one or more lactones can include at least one lactone selected from the group consisting of 5-hydroxy-2,4-decadienoic acid delta-lactone, 4,5-dimethyl-3-hydroxy-2,5-dihydro-furan-2-one, gamma decalactone, massoia lactone, and sotolone, or any combination thereof. The one or more lactones can include at least one lactone selected from the group consisting of gamma decalactone, massoia lactone, and sotolone, or any combination thereof. In some embodiments, the one or more lactones can include 5-hydroxy-2,4-decadienoic acid delta-lactone.

The VOCs can include one or more phenols. The one or more phenols can include at least one phenol selected from the group consisting of syringol, 4-ethylguaiacol, 1-(2-hydroxy-5-methylphenyl)-ethanone, 2,5-dimethylphenol, 2-methoxy-4-methylphenol, 2-methoxy-4-vinylphenol, 2-methoxy-phenol, 2-methyl-phenol, 4-ethyl guaiacol, 4-ethyl phenol, 4-ethyl-2-methoxy-phenol, 4-vinylphenol, eugenol, guaiacol, isoeugenol, p-cresol, phenol, syringol (2,6-dimethoxyphenol), vanillin erythro and/or threo-butan-2,3-diol acetal, and vanillyl ethyl ether, or any combination thereof. The one or more phenols can include at least one phenol selected from the group consisting of 2,4,6-trimethylphenol (mesitol), 2,5-dimethylphenol, 2-methoxy-4-methylphenol, 2-methoxy-4-vinylphenol, 4-ethyl guaiacol, 4-ethyl phenol, 4-ethylguaiacol, 4-vinylphenol, eugenol, guaiacol, isoeugenol, p-cresol, syringol, vanillin erythro and/or threo-butan-2,3-diol acetal, and vanillyl ethyl ether. The one or more phenols can include at least one phenol selected from the group consisting of 2,4,6-trimethylphenol (mesitol), 2,5-dimethylphenol, 2-methoxy-4-methylphenol, 2-methoxy-4-vinylphenol, 4-ethylguaiacol, eugenol, guaiacol, isoeugenol, syringol, vanillin erythro and/or threo-butan-2,3-diol acetal, and vanillyl ethyl ether. In some embodiments, the one or more phenols comprise at least one phenol selected from the group consisting of syringol and/or 4-ethylguaiacol. In some cases, the nut butter replica can include at least about 0.05 ppm, at least about 0.1 ppm, at least about 0.2 ppm, at least about 0.5 ppm, or at least about 1 ppm of phenols.

The VOCs can include one or more pyrazines. The one or more pyrazines can include at least one pyrazine selected from the group consisting of 2,3,5-trimethylpyrazine, 2,3-diethylpyrazine, 2,3-diethyl-5-methylpyrazine, 2,5-dimethylpyrazine, 2,6-dimethylpyrazine, 2,3-dimethylpyrazine, 2-ethyl-3-methylpyrazine, 2-ethylpyrazine, 2-methylpyrazine, isopropenyl pyrazine, tetramethylpyrazine, 2-methoxy-3(5 and 6)-isopropylpyrazine, 2-ethoxy-3-methylpyrazine, 2-ethyl-6-methylpyrazine, 3-ethyl-3,6-dimethyl-2h-pyrazine, 2,3,5,6-tetramethylpyrazine, 2-methyl-5-vinylpyrazine (re-gras), 3,5-diethyl-2-methylpyrazine, pyrazine, 3-ethyl-2,6-dimethylpyrazine, 2-ethyl-5-methylpyrazine, 5-ethyl-2,3-dimethylpyrazine, 5h-5-methyl-6,7-dihydrocyclopenta(b)pyrazine, 5-isopropyl-2-methylpyrazine, isopropenylpyrazine, 2-acetyl-3-methylpyrazine, 2-acetyl-3-ethylpyrazine, 2-acetyl-3,5(and 6)-dimethylpyrazine, and 2(3),5-dimethyl-6,7-dihydro-5h-cyclopentapyrazine, and 2-isopropylpyrazine, or any combination thereof. The one or more pyrazines can include at least one pyrazine selected from the group consisting of 2,3,5-trimethylpyrazine, 2,3-diethyl-5-methylpyrazine, 2,3-diethylpyrazine, 2,5-dimethylpyrazine, 2,6-dimethylpyrazine, 2,3-dimethylpyrazine, 2-ethyl-3-methylpyrazine, and 2-ethylpyrazine, 2-methylpyrazine, isopropenyl pyrazine, and tetramethylpyrazine. The one or more pyrazines can include at least one pyrazine selected from the group consisting of 2,3,5-trimethylpyrazine, 2,3-diethyl-5-methylpyrazine, 2,3-diethylpyrazine, 2,5-dimethylpyrazine, 2,6-dimethylpyrazine, 2,3-dimethylpyrazine, 2-ethyl-3-methylpyrazine, 2-ethylpyrazine, 2-methylpyrazine, tetramethylpyrazine, and isopropenyl pyrazine. In some embodiments, the one or more pyrazines comprise at least one pyrazine selected from the group consisting of 2,3,5-trimethylpyrazine, 2,3-diethylpyrazine, 2,3-diethyl-5-methylpyrazine, 2,5-dimethylpyrazine, 2,6-dimethylpyrazine, 2,3-dimethylpyrazine, 2-ethyl-3-methylpyrazine, 2-ethylpyrazine, 2-methylpyrazine, isopropenyl pyrazine, tetramethylpyrazine, 2-methoxy-3(5 and 6)-isopropylpyrazine, 2-ethoxy-3-methylpyrazine, 2-ethyl-6-methylpyrazine, and/or 3-ethyl-3,6-dimethyl-2h-pyrazine.

The VOCs can include one or more pyridines. The one or more pyridines can include at least one pyridine selected from the group consisting of 2-acetylpyridine, pyridine, 1-methyl-1,2,3,6-tetrahydropyridine, 1-methyl-piperidine, 2-acetylpyridine, 2-methyl-pyridine, 3-ethylpyridine, 3-ethyl-pyridine, 3-methyl-pyridine, 3-propyl-pyridine, 3-pyridinol, and methyl nicotinate, or any combination thereof. The one or more pyridines can include at least one pyridine selected from the group consisting of pyridine, 2-acetylpyridine, 3-ethylpyridine, and methyl nicotinate, or any combination thereof. In some embodiments, the one or more pyridines include 2-acetylpyridine. In some embodiments, the nut butter replica comprises no greater than about 1.68 ppm, no greater than about 1.5 ppm, no greater than about 1.2 ppm, no greater than about 1 ppm, or no greater than about 0.5 ppm pyridines.

The VOCs can include one or more pyrroles. The one or more pyrroles can include at least one pyrrole selected from the group consisting of indole, 1-(1H-pyrrol-2-yl)-ethanone, 1-(2-furanylmethyl)-1H-pyrrole, 1-ethyl-1H-pyrrole, 1-methyl-1H-pyrrole, 1-methyl-1H-pyrrole-2-carboxaldehyde, 2-acetyl-1-methylpyrrole, 2-acetylpyrrole, and pyrrole, or any combination thereof. The one or more pyrroles can include pyrrole. In some embodiments, the one or more pyrroles include indole.

The VOCs can include one or more sugars or sugar alcohols. The one or more sugars or sugar alcohols can include at least one sugars or sugar alcohol selected from the group consisting of ethyl maltol and maltol, or a combination thereof.

The VOCs can include one or more sulfur compounds. The one or more sulfur compounds can include at least one sulfur compound selected from the group consisting of dimethyl trisulfide, methyl sulfide, s-methyl 3-methylbutanethioate, furfuryl mercaptan, diethyl disulfide, dimethyl disulfide, dimethyl sulfide, dimethyl sulfoxide, methanethiol, and methional, or any combination thereof. The one or more sulfur compounds can include at least one sulfur compound selected from the group consisting of diethyl disulfide, dimethyl sulfide, methyl sulfide, dimethyl sulfoxide, dimethyl trisulfide, methanethiol, and methional. The one or more sulfur compounds can include at least one sulfur compound selected from the group consisting of dimethyl sulfide, methyl sulfide, dimethyl trisulfide and methanethiol. In some embodiments, the one or more sulfur compounds comprise at least one sulfur compound selected from the group consisting of dimethyl trisulfide, methyl sulfide, s-methyl 3-methylbutanethioate, and/or furfuryl mercaptan.

The VOCs can include one or more terpenes. The one or more terpenes can include at least one terpene selected from the group consisting of limonene, linalool, pyrrole, d-alpha-pinene, delta-3-carene, naphthalene, styrene, 4-methylthiazole, alpha-phellandrene, o-methylanisole, p-mentha-1,4-diene, terpinolene, thiazole, o-cymene, 1-methylnaphthalene, 1-methylpyrrole, indole, n-furfurylpyrrole, trimethyloxazole, 1-nonene, 1-octene, 2-isobutyl-4,5-dimethyloxazole, 4-methyl-5-vinylthiazole, beta-pinene, beta-caryophyllene, camphene, p-cymene, 3,4-dimethylthiophene, and 4,5-dimethylthiazole, or any combination thereof. The one or more terpenes can include at least one terpene selected from the group consisting of limonene and linalool.

The VOCs can include one or more thiophenes. The VOCs can include 2,7-dimethyl-oxepine.

The VOCs can include at least 20, at least 30, at least 40, or at least 50 compounds selected from the group consisting of (+/−) 2-methyl-1-butanol, 1-methyl-1h-pyrrole-2-carboxaldehyde, 1-octen-3-ol, 1-penten-3-one, 2,3,5,6-tetramethylpyrazine, 2,3,5-trimethylpyrazine, 2,3-diethyl-5-methylpyrazine, 2,3-dimethylpyrazine, 2,3-pentanedione, 2,5-dimethylpyrazine, 2-ethyl-6-methylpyrazine, 2-methyl-5-vinylpyrazine (re-gras), 2-methylbutyraldehyde, 2-methylbutyric acid, 2-methylpyrazine, 2-methyltetrahydrofuran-3-one, 2-nonanone, 2-octanone, 2-pentylfuran, 3,5-diethyl-2-methylpyrazine, 3-octen-2-one, 4-hexene-3-one, 4-hydroxy-2-butenoic acid gamma-lactone, 4-methyl-3-penten-2-one, 5-methylfurfural, acetoin, amyl alcohol, benzaldehyde, benzene, 1,3,5-trimethyl-, decanal, furfural, furfuryl alcohol, heptanal, heptyl alcohol, hexanal, hexanoic acid, hexyl alcohol, isoamyl alcohol, isobutyl isobutyrate, methyl 2-pyrrolyl ketone, methylcyclopentenolone, nonanal, nonyl alcohol, phenylacetaldehyde, pyrazine, pyridine, pyrrole, valeraldehyde, 2,3-butanediol, 2-phenyl-2-butenal, 3-ethyl-2,6-dimethylpyrazine, 5,6,7,8-tetrahydroquinoxaline, d-limonene, heptyl formate, trans-2-heptenal, 1-octanol, 2-acetyl-1-pyrroline, 2-undecenal, benzyl benzoate, cinnamaldehyde, (e)-, piperonal, vanillin, (e,e)-3,5-octadien-2-one, 2-ethyl-5-methylpyrazine, 2-ethylfuran, 2-heptanone, 2-pyrrolidone, caffeine, gamma-nonalactone, maltol, phenethyl acetate, 2-ethylpyrazine, 2-methoxy-4-vinylphenol, 3-octanone, 3-phenylpropionaldehyde, 4-hydroxybutanoic acid lactone, alpha-pinene, delta-3-carene, dihydrocoumarin, ethyl 2-methylbutyrate, ethyl benzoate, gamma-hexalactone, hexyl acetate, isobutyric acid, isovaleric acid, naphthalene, phenethyl alcohol, propylene glycol, styrene, 4-methylthiazole, alpha-phellandrene, methylsulfinylmethane, palmitic acid, pyruvaldehyde, pyruvic acid, 2,5-dimethylfuran, 2-butanone, 2-butylfuran, 2-decanone, 3-hepten-2-one, 4-carvomenthenol, 4-heptanone, 4-methyl-5-thiazoleethanol, 5-ethyl-2,3-dimethylpyrazine, butyric acid, delta-octalactone, gamma-heptalactone, heptanoic acid, methyl heptanoate, methyl hexanoate, methyl octanoate, methyl valerate, octanal, octanoic acid, o-methylanisole, p-mentha-1,4-diene, terpinolene, thiazole, trans-2-hexenal, valeric acid, 1-octen-3-one, 1-penten-3-ol, 3-hexanol, 3-penten-2-one, beta-angelicalactone, nonanoic acid, o-cymene, p-tolyl acetate, tetrahydrofurfuryl alcohol, 1-methylnaphthalene, 3-furaldehyde, 3-methyl-2-cyclohexen-1-one, 1-rhamnose, (e)-2-octen-1-ol, 1-ethyl-2-pyrrolecarboxaldehyde, 1-methylpyrrole, 2-acetyl-2-thiazoline, 2-methylpentanal, 3-n-butylphthalide, 4,5-dihydro-3(2h)thiophenone, 4-hydroxy-2,5-dimethyl-3(2h)-furanone, 4-hydroxy-5-methyl-3(2h)-furanone, 5h-5-methyl-6,7-dihydrocyclopenta(b)pyrazine, 5-isopropyl-2-methylpyrazine, 5-methylfurfuryl alcohol, acetophenone, benzoic acid, cyclopentanone, dimethyl disulfide, dimethyl trisulfide, indole, isopropenylpyrazine, n-furfurylpyrrole, oleic acid, phenethyl butyrate, propionic acid, trimethyloxazole, 2-heptanol, 2-pentanone, 1-tyrosine, methyl nicotinate, 1-nonene, 1-octene, cinnamaldehyde, hydroxyacetone, hexyl formate, phenethyl benzoate, 1-hexadecanol, 1-tetradecanol, 2-ethylhexyl benzoate, benzophenone, butyl isobutyrate, epsilon-decalactone, ethyl decanoate, ethyl laurate, ethyl myristate, ethyl octanoate, ethyl palmitate, guaiacol, lauric acid, methyl acetate, myristic acid, n-capric acid isobutyl ester, pentadecanoic acid, 3-methylbutyl ester, phenethyl decanoate, phenethyl octanoate, propyl p-hydroxybenzoate, stearic acid, 2,6-dimethylpyrazine, 2-acetyl-3-methylpyrazine, benzyl alcohol, menthol racemic, s-methyl thioacetate, 2-methoxy-3(5 and 6)-isopropylpyrazine, glycerol, 2-ethyl-1-hexanol, (tri-)acetin, 5-methyl-2-phenyl-2-hexenal, butyl acetate, undecyl alcohol, isobutyl acetate, propyl acetate, tetrahydrofurfuryl acetate, 2-isobutyl-4,5-dimethyloxazole, 2,6-dimethyl-4-heptanone, 4-methyl-5-vinylthiazole, beta-pinene, 2,3-hexanedione, 3-(methylthio)propionaldehyde, beta-caryophyllene, delta-hexadecalactone, difurfuryl ether, trans,trans-2,4-octadienal, 2-methylheptanoic acid, ethyl nonanoate, 2-heptylfuran, camphene, cyclohexanone, ethyl heptanoate, ethyl hexanoate, ethyl lactate, gamma-valerolactone, heptyl acetate, isopropenyl acetate, methyl butyrate, methyl levulinate, butylamine, methyl nonanoate, 3-methyl-2-butanol, 6-methyl-5-hepten-2-one, isoamyl acetate, 2-acetyl-3-ethylpyrazine, 2-acetylpyridine, butyl butyrate, lauryl alcohol, p-cymene, 3,4-dimethylthiophene, 4-hydroxybenzoic acid, 9-octadecenoic acid, ethyl ester, ethyl pyruvate, isopropylamine, 3-methyl-1-pentanol, 2-oxobutyric acid, 4-methyl-2-phenyl-2-pentenal, 2-acetyl-3,5(and 6)-dimethylpyrazine, trimethylamine, 2(3),5-dimethyl-6,7-dihydro-5h-cyclopentapyrazine, methyl cinnamate, amyl formate, 5-hydroxyundecanoic acid lactone, propiophenone, 2-isopropylpyrazine, 2-ethylbutyl acetate, 2-acetyl-5-methylfuran, acetaldehyde, gamma-decalactone, trans-2-decenol, 4,5-dimethylthiazole, isobutyl butyrate, tridecanoic acid, and 1-mercapto-2-propanone.

The VOCs can include at least 10, at least 20, at least 30, or at least 40 compounds selected from the group consisting of 2,3,5-trimethylpyrazine, 2,3-diethyl-5-methylpyrazine, 2,3-diethylpyrazine, 2,5-dimethylpyrazine, 2,6-dimethylpyrazine, 2,3-dimethylpyrazine, 2-ethyl-3-methylpyrazine, 2-ethylpyrazine, 2-methylpyrazine, isopropenyl pyrazine, tetramethylpyrazine, (E,E)-2,4-decadienal, 1-octen-3-ol, 2-ethyl furan, 2-heptanone, 5-methylfurfural, benzaldehyde, coffee furanone, cyclopentanone, DMTS, furfural, gamma-decalactone, limonene, pyridine, 4-ethylguiacol, furfuryl mercaptan, 2-pentanol, methional, acetic acid, 2-furyl methylketone, methyl thio isovalerate, acetoin, 3-methylbutanoic acid, dimethyl sulfide, butyric acid, propyl 2-mercaptopropionate, 2,4,6-trimethylphenol (mesitol), gamma-valerolactone, delta octalactone, delta decalactone, whiskey lactone, p-cresol, 3-(methylthio)propionaldehyde, isobutyraldehyde, delta-octalactone, 5-methyl-2-hepten-4-one, linalool, valeraldehyde, beta-damascenone, eugenol, vanillin, 2,3-pentanedione, 4-hydroxy-2,5-dimethyl-3(2H)-furanone, maltol, L-lactic acid, and 2-acetylpyridine.

In some cases, the VOCs can have less than about 95% identity to the VOCs in a single reference nut butter. In some cases, the VOCs can have less than about 90% identity to the VOCs in a single reference nut butter. In some cases, the VOCs can have less than about 85% identity to the VOCs in a single reference nut butter. In some cases, the VOCs can have less than about 80% identity to the VOCs in a single reference nut butter.

In some cases, the nut butter replica can include at least 32 VOCs and wherein no more than 31 of the VOCs are found in a single reference nut butter. In some cases, the nut butter replica can include at least 41 VOCs and wherein no more than 40 of the VOCs are found in a single reference nut butter. In some cases, the nut butter replica can include at least 51 VOCs and wherein no more than 50 of the VOCs are found in a single reference nut butter. In some cases, the nut butter replica can include at least 61 VOCs and wherein no more than 60 of the VOCs are found in a single reference nut butter. In some cases, the nut butter replica can include at least 71 VOCs and wherein no more than 70 of the VOCs are found in a single reference nut butter.

In some cases, the one or more isolated non-volatile compounds do not include at least one compound selected from the group consisting of homoserine, nicotinic acid, valine, proline, arginine, B-alanine-2, asparagine, glutamic acid, phenylalanine, leucine, lysine, glycine, serine, arabitol, fructose, mannitol, catechin, epicatechin, sorbitol, sucrose, trehalose, sotolon, vanillin, 2-ethyl-2-hydroxybutyricacid, and ricinoleic acid. In some cases, the one or more isolated non-volatile compounds do not include homoserine.

In some cases, the one or more isolated non-volatile compounds can include at least one compound selected from the group consisting of 8-hydroxyquinoline, quinoline, chlorogenic acid, fraxetin, strawberry furanone acetate, luteolin-7-O-glucoside, inosine, trigonelline, trans-4-hydroxyproline, carnosine, cystine, kynurenic acid, ornithine, cysteine, pyridoxine, adenine, glucosamine, D-glucuronic acid, quinic acid, tartaric acid, fumaric acid, succinic acid, 3,4-dihydroxybenzoic acid, 2-furoic acid, camphoric acid, ribose, adipic acid, rutin, xylose, galactose, vanillic acid, syringic acid, polydatin, cytosine, 4-guanidinobutyric acid, uracil, tyramine, tryptamine, maple furanone, acetanilide, benzaldehyde, sorbic acid, B-ionone, muramic acid, trans,trans-muconic acid, gentisic acid, 6,7-dihydroxycoumarin, tropic acid, 6-hydroxy-2-naphthoic acid, propyl gallate, hesperetin, and caffeic acid. The chlorogenic acid can be present in an amount of at least about 32 ppm, at least about 35 ppm, at least about 40 ppm, at least about 50 pm, at least about 70 ppm, at least about 100 ppm, at least about 150 ppm, or at least about 200 ppm. The Propyl Gallate can be present in an amount of at least about 5.0 ppm, at least about 10 ppm, at least about 20 ppm, at least about 50 ppm, at least about 100 ppm, or at least about 200 ppm. The hesperetin can be present in an amount of at least about 0.08 ppm, at least about 0.2 ppm, at least about 0.5 ppm, at least about 1 ppm, at least about 5 ppm, or at least about 10 ppm. The Caffeic Acid can be present in an amount of at least about 0.15 ppm, at least about 0.3 ppm, at least about 0.8 ppm, at least about 1 ppm, at least about 2 ppm, at least about 5 ppm, or at least about 10 ppm.

The one or more isolated non-volatile compounds can include one or more of: an acid, an aldehyde, an alkaloid, an amine, an amino acid, a furan, a ketone, a lactone, a nucleotide, a nucleotide monophosphate, or nucleobase, a protein or peptide, a pyrazine, a pyridine, a sugar or sugar alcohol, a tannin, phenol, a fat, a salt, an emulsifier, polyphenol, or anthocyanin, or a xanthine. The one or more isolated non-volatile compounds can include one or more of: an acid, an aldehyde, an amino acid, a lactone, a pyrazine, a tannin, phenol, a fat, a salt, an emulsifier, polyphenol, or anthocyanin, or a xanthine.

The one or more isolated non-volatile compounds can include one or more acids. The one or more acids can include at least one acid selected from the group consisting of adipic acid, trans-ferulic acid, sinapinic acid, salicylic acid, pantothenic acid, caffeic acid, vanillic acid, syringic acid, coumaric acid, sorbic acid, kynurenic acid, d-glucuronic acid, quinic acid, malic acid, pyruvic acid, tartaric acid, lactic acid, citric acid, fumaric acid, succinic acid, gallic acid, 2-furoic acid, 3,4-dihydroxybenzoic acid, 2-isopropylmalic acid, D-gluconic acid, 4-methoxycinnamic acid, 2-ethyl-2-hydroxybutyric acid, ricinoleic acid, DL-hydroxystearic acid, Nicotinic acid, chlorogenic acid, cholic acid, hydroxybutyricacid, or any combination thereof.

The one or more acids can include at least one acid selected from the group consisting of nicotinic acid, chlorogenic acid, malic acid, lactic acid, citric acid, caffeic acid, 4-methoxycinnamic acid, D-gluconic acid, 2-ethyl-2-hydroxybutyricacid, and ricinoleic acid. The one or more isolated non-volatile compounds can include one or more aldehydes.

The one or more aldehydes can include vanillin. In some cases, the aldehydes can be present in an amount of at least about 0.001 ppm, at least about 0.002 ppm, at least about 0.005 ppm, at least about 0.01 ppm, at least about 0.02 ppm, at least about 0.05 ppm, or at least about 0.1 ppm.

The one or more isolated non-volatile compounds can include one or more alkaloids. The one or more alkaloids can include piperine.

The one or more isolated non-volatile compounds can include one or more amines. The one or more amines can include tryptamine.

The one or more isolated non-volatile compounds can include one or more amino acids. The one or more amino acids can include at least one amino acid selected from the group consisting of phenylalanine, leucine, glucosamine, methionine, GABA, tyrosine, lysine, histidine, glycine, serine, aspartic acid, isoleucine, tryptophan, valine, proline, carnitine, arginine, B-alanine-2, threonine, glutamine, asparagine, glutamic acid, betaine, pipecolinic acid, citrulline, carnosine, and homoserine, or any combination thereof. The one or more amino acids can include at least one amino acid selected from the group consisting of phenyl alanine and leucine.

The one or more isolated non-volatile compounds can include one or more furans. The one or more furans can include hydroxymethylfurfural.

The one or more isolated non-volatile compounds can include one or more ketones. The one or more ketones can include at least one ketone selected from the group consisting of 2(5H)-furanone, 5-ethyl-4-hydroxy-2-methyl-3(2H)-furanone, acetovanillone, and methyl-2-pyrrolyl ketone, or any combination thereof.

The one or more isolated non-volatile compounds can include one or more lactones. The one or more lactones can include sotolon.

The one or more isolated non-volatile compounds can include one or more nucleotides, nucleotide monophosphates, or nucleobases. The one or more nucleotides, nucleotide monophosphates, or nucleobases can include at least one nucleotides, nucleotide monophosphates, or nucleobase selected from the group consisting of adenine, AMP, CMP, cytidine, cytosine, guanine, and uracil, or any combination thereof.

The one or more isolated non-volatile compounds can include one or more proteins or peptides. The one or more proteins or peptides can include carnosine.

The one or more isolated non-volatile compounds can include one or more pyrazines. The one or more pyrazines can include at least one pyrazine selected from the group consisting of 2,3,5,6-tetramethylpyrazine, 2,3,5-trimethylpyrazine, and 2,3-dimethylpyrazine, or any combination thereof. The one or more pyrazines can include at least one pyrazine selected from the group consisting of 2,3,5-trimethylpyrazine and 2,3-dimethylpyrazine.

The one or more isolated non-volatile compounds can include one or more pyridines. The one or more pyridines can include at least one pyridine selected from the group consisting of pyridine and pyroxidine, or a combination thereof.

The one or more isolated non-volatile compounds can include one or more sugars or sugar alcohols. The one or more sugars or sugar alcohols can include at least one sugar or sugar alcohol selected from the group consisting of arabitol, fructose, rhamnose, mannitol, glucose, lactose, xylose, sorbitol, fucose, galactose, mannose, sucrose, myo-inositol, trehalose, allulose, monkfruit, stevia, maltitol, isomalt, tagatose, and stachyose, or any combination thereof.

The one or more isolated non-volatile compounds can include one or more tannins, phenols, polyphenols, or anthocyanins. The one or more tannins, phenols, polyphenols, or anthocyanins can include at least one tannin, phenol, polyphenol, or anthocyanin selected from the group consisting of catechin, ellagic acid, epicatechin, epicatechin gallate, gallic acid, hesperetin, methyl gallate, polydatin, propyl gallate, quercetin, resveratrol, rutin, salicylic acid, sinapinic acid, syringaldehyde, syringic acid, trans-ferulic acid, tyramine, and vanillic acid, or any combination thereof. The one or more tannins, phenols, polyphenols, or anthocyanins can include at least one tannin, phenol, polyphenol, or anthocyanin selected from the group consisting of catechin, epicatechin, propyl gallate, and hesperetin.

The one or more isolated non-volatile compounds can include one or more xanthines. The one or more xanthines can include theobromine.

The one or more isolated non-volatile compounds can include stabilizer fats. The one or more stabilizer fats can include hydrogenated oil, palm oil, kernel oil, shea oil, cottonseed oil, and/or other fats and plant oils.

The one or more isolated non-volatile compounds can include cocoa products. The one or more cocoa products can include cocoa powder, cocoa butter, and/or chocolate.

The one or more isolated non-volatile compounds can include an emulsifier. The one or more emulsifiers can include lecithin.

The one or more isolated non-volatile compounds can include a substrate. The substrate can include grape seeds, sunflower seeds, sunflower kernels, sunflower meal or flour, sunflower oil, other processed or unprocessed grains or grain products, legumes or legume seeds, oil plants or seeds, fruits or fruit products, roots, tubers, or root or tuber products, sugar processing by-products, and/or other plant by-products.

The one or more isolated non-volatile compounds can include a liquid medium. The liquid medium can include water, milk, plant-based milk, and/or other alternative dairy products.

The one or more nonvolatile compounds can include at least 1 compound, at least 2 compounds, at least 3 compounds, at least 4 compounds, at least 5 compounds, at least 6 compounds, at least 7 compounds, at least 8 compounds, at least 9 compounds, at least 10 compounds, at least 11 compounds, at least 12 compounds, at least 13 compounds, at least 14 compounds, at least 15 compounds, at least 16 compounds, at least 17 compounds, at least 18 compounds, at least 19 compounds, at least 20 compounds, at least 21 compounds, at least 22 compounds, at least 23 compounds, at least 24 compounds, at least 25 compounds, at least 26 compounds, at least 27 compounds, at least 28 compounds, at least 29 compounds, at least 30 compounds, at least 35 compounds, at least 40 compounds, at least 45 compounds, at least 50 compounds, at least 55 compounds, at least 60 compounds, at least 65 compounds, or at least 70 compounds, at least 75 compounds, at least 80 compounds, at least 85 compounds, at least 90 compounds, at least 95 compounds, or at least 100 compounds selected from the group consisting of 2(5H)-furanone, 2,3,5,6-tetramethylpyrazine, 2,3,5-trimethylpyrazine, 2,3-dimethylpyrazine, 2-ethyl-2-hydroxybutyric acid, 2-furoic acid, 2-isopropylmalic acid, 3,4-dihydroxybenzoic acid, 4-guanidinobutyric acid, 4-methoxycinnamic acid, 5-ethyl-4-hydroxy-2-methyl-3(2H)-furanone, acetovanillone, adenine, adipic acid, AMP, arabitol, arginine, asparagine, aspartic acid, beta-alanine, betaine, caffeic acid, caffeine, carnitine, carnosine, catechin, choline, cinnamic acid, citric acid, citrulline, CMP, coumaric acid, cysteine, cystine, cytidine, cytosine, D-gluconic acid, D-glucuronic acid, DL-hydroxystearic acid, ellagic acid, epicatechin, epicatechin gallate, fructose, fumaric acid, GABA, galactose, gallic acid, glucosamine, glucose, glutamic acid, glutamine, glycine, guanine, hesperetin, histidine, homoserine, hydroxymethylfurfural, isoleucine, kynurenic acid, lactic acid, leucine, lysine, malic acid, mannitol, mannose, methionine, methyl gallate, methyl-2-pyrrolyl ketone, inositol, ornithine, pantothenic acid, phenylalanine, pipecolinic acid, piperine, polydatin, proline, propyl gallate, pyridine, pyridoxine, pyruvic acid, quercetin, quinic acid, resveratrol, rhamnose, ribose, rutin, salicylic acid, serine, sinapinic acid, sorbic acid, sorbitol, sotolon, succinic acid, syringaldehyde, syringic acid, tartaric acid, threonine, trans-4-hydroxyproline, trans-ferulic acid, tryptamine, tryptophan, tyramine, tyrosine, uracil, valine, vanillic acid, vanillin, and xylose.

The one or more isolated non-volatile compounds can include at least 5 compounds selected from the group consisting of 2,3,5-trimethylpyrazine, 2,3-dimethylpyrazine, aspartic acid, caffeine, choline, citric acid, lactic acid, sotolon, succinic acid, trans-ferulic acid, vanillic acid, and vanillin.

The one or more isolated non-volatile compounds can include at least 10 compounds selected from the group consisting of 2,3,5-trimethylpyrazine, 2,3-dimethylpyrazine, aspartic acid, caffeine, choline, citric acid, lactic acid, sotolon, succinic acid, trans-ferulic acid, vanillic acid, and vanillin.

The one or more isolated non-volatile compounds can include 2,3,5-trimethylpyrazine, 2,3-dimethylpyrazine, aspartic acid, caffeine, choline, citric acid, lactic acid, sotolon, succinic acid, trans-ferulic acid, vanillic acid, and vanillin.

In some cases, the one or more isolated non-volatile compounds can have less than about 95% identity to the isolated non-volatile compounds in a single reference nut butter. In some cases, the one or more isolated non-volatile compounds can have less than about 90% identity to the isolated non-volatile compounds in a single reference nut butter. In some cases, the one or more isolated non-volatile compounds can have less than about 85% identity to the isolated non-volatile compounds in a single reference nut butter. In some cases, the one or more isolated non-volatile compounds can have less than about 80% identity to the isolated non-volatile compounds in a single reference nut butter.

In some cases, the nut butter replica can include at least 11 isolated non-volatile compounds and wherein no more than 10 of the isolated non-volatile compounds are found in a single reference nut butter.

In some cases, the nut butter replica does not include one or more of E. coli, Salmonella sp., Brettanomyces sp., Lactobacillales, Saccharomyces sp., Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, Verticillium psalliotae, mold, mildew, rot, insects, insect eggs, insect filth, rodent filth, mammalian excreta, hydrogen sulfide, hydrogen disulfide, 2,4,6-trichloranisole, 2,4,6-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, dichloromethane, plant protein allergens (e.g., tree nut protein allergens or peanut protein allergens), and heavy metals.

In some cases, the nut butter replica can be a solution, suspension, or emulsion. The solution, suspension, or emulsion can be a nut butter spread. The solution, suspension, or emulsion can be a nut butter coating. The nut butter replica can be soluble in water.

In another aspect, the document features a method of preparing a nut butter replica. The method can include forming a mixture comprising water (liquid), one or more isolated VOCs that are water-soluble, and isolated non-volatile compounds that are water-soluble; forming a substrate emulsion comprising an oil, one or more isolated VOCs that are fat-soluble, and isolated non-volatile compounds that are fat-soluble; and mixing the aqueous solution and the emulsion to form a nut butter replica. In some cases, forming an emulsion can include homogenizing. The oil can include corn oil, sunflower oil, palm oil, soybean oil, cocoa butter, shea oil, kernel oil or coconut oil. In some embodiments, any of the VOCs described herein can be water-soluble, e.g., 2,3,5-trimethylpyrazine, 2,3-diethylpyrazine, 2,3-diethyl-5-methylpyrazine, 2,5-dimethylpyrazine, 2,6-dimethylpyrazine, 2,3-dimethylpyrazine, 2-ethyl-3-methylpyrazine, 2-ethylpyrazine, 2-methylpyrazine, isopropenyl pyrazine, tetramethylpyrazine, (E,E)-2,4-decadienal, 1-octen-3-ol, 2-ethyl furan, 2-heptanone, 5-methylfurfural, benzaldehyde, coffee furanone, cyclopentanone, dimethyl trisulfide, furfural, gamma-decalactone, limonene, pyridine, isovaleric acid, syringol, valeraldehyde, esters, 4-ethylguaiacol, furfuryl mercaptan, 3-(methylthio)propionaldehyde, 2-methyltetrahydrofuran-3-one, acetic acid, 2-furyl methyl ketone, s-methyl 3-methylbutanethioate, acetoin, methyl sulfide, butyric acid, 4-methyl-5-thiazoleethanol, indole, hexanal, acetophenone, furfuryl alcohol, 2-methoxy-3(5 and 6)-isopropylpyrazine, 4-methyl-5-thiazoleethanol acetate, 2-ethoxy-3-methylpyrazine, pentanal, p-cresol, isobutyraldehyde, delta-octalactone, 5-methyl-2-hepten-4-one, linalool, beta damascenone, eugenol, vanillin, 2,3-pentanedione, 4-hydroxy-2,5-dimethyl-3(2h)-furanone, maltol, 1-lactic acid, 2-ethyl-6-methylpyrazine, 2-acetylpyridine, methional, 3-methylbutyraldehyde, phenylacetaldehyde, phenethyl alcohol, 3,4-Hexanedione, 1-(2-Furanyl)-ethanone, 5-methyl-2-furancarboxaldehyde, 3-methyl-2-butenal, 3-ethyl-3,6-dimethyl-2h-pyrazine, 3-furaldehyde, dihydrocoumarin, 5-hydroxy-2,4-decadienoic acid delta-lactone. In some embodiments, any of the VOCs described herein can be fat-soluble, e.g., 2,3,5-trimethylpyrazine, 2,3-diethylpyrazine, 2,3-diethyl-5-methylpyrazine, 2,5-dimethylpyrazine, 2,6-dimethylpyrazine, 2,3-dimethylpyrazine, 2-ethyl-3-methylpyrazine, 2-ethylpyrazine, 2-methylpyrazine, isopropenyl pyrazine, tetramethylpyrazine, (E,E)-2,4-decadienal, 1-octen-3-ol, 2-ethyl furan, 2-heptanone, 5-methylfurfural, benzaldehyde, coffee furanone, cyclopentanone, dimethyl trisulfide, furfural, gamma-decalactone, limonene, pyridine, isovaleric acid, syringol, valeraldehyde, esters, 4-ethylguaiacol, furfuryl mercaptan, 3-(methylthio)propionaldehyde, 2-methyltetrahydrofuran-3-one, acetic acid, 2-furyl methyl ketone, s-methyl 3-methylbutanethioate, acetoin, methyl sulfide, butyric acid, 4-methyl-5-thiazoleethanol, indole, hexanal, acetophenone, furfuryl alcohol, 2-methoxy-3(5 and 6)-isopropylpyrazine, 4-methyl-5-thiazoleethanol acetate, 2-ethoxy-3-methylpyrazine, pentanal, p-cresol, isobutyraldehyde, delta-octalactone, 5-methyl-2-hepten-4-one, linalool, beta damascenone, eugenol, vanillin, 2,3-pentanedione, 4-hydroxy-2,5-dimethyl-3(2h)-furanone, maltol, 1-lactic acid, 2-ethyl-6-methylpyrazine, 2-acetylpyridine, methional, 3-methylbutyraldehyde, phenylacetaldehyde, phenethyl alcohol, 3,4-Hexanedione, 1-(2-Furanyl)-ethanone, 5-methyl-2-furancarboxaldehyde, 3-methyl-2-butenal, 3-ethyl-3,6-dimethyl-2h-pyrazine, 3-furaldehyde, dihydrocoumarin, 5-hydroxy-2,4-decadienoic acid delta-lactone.

In some embodiments, any of the non-volatile compounds described herein can be water-soluble, e.g., 2(5H)-furanone, 2,3,5,6-tetramethylpyrazine, 2,3,5-trimethylpyrazine, 2,3-dimethylpyrazine, 2-ethyl-2-hydroxybutyric acid, 2-furoic acid, 2-isopropylmalic acid, 3,4-dihydroxybenzoic acid, 4-guanidinobutyric acid, 4-methoxycinnamic acid, 5-ethyl-4-hydroxy-2-methyl-3(2H)-furanone, acetovanillone, adenine, adipic acid, AMP, arabitol, arginine, asparagine, aspartic acid, beta-alanine, betaine, caffeic acid, caffeine, carnitine, carnosine, catechin, choline, cinnamic acid, citric acid, citrulline, CMP, coumaric acid, cysteine, cystine, cytidine, cytosine, D-gluconic acid, D-glucuronic acid, DL-hydroxystearic acid, ellagic acid, epicatechin, epicatechin gallate, fructose, fumaric acid, GABA, galactose, gallic acid, glucosamine, glucose, glutamic acid, glutamine, glycine, guanine, hesperetin, histidine, homoserine, hydroxymethylfurfural, isoleucine, kynurenic acid, lactic acid, leucine, lysine, malic acid, mannitol, mannose, methionine, methyl gallate, methyl-2-pyrrolyl ketone, inositol, ornithine, pantothenic acid, phenylalanine, pipecolinic acid, piperine, polydatin, proline, propyl gallate, pyridine, pyridoxine, pyruvic acid, quercetin, quinic acid, resveratrol, rhamnose, ribose, rutin, salicylic acid, serine, sinapinic acid, sorbic acid, sorbitol, sotolon, succinic acid, syringaldehyde, syringic acid, tartaric acid, threonine, trans-4-hydroxyproline, trans-ferulic acid, tryptamine, tryptophan, tyramine, tyrosine, uracil, valine, vanillic acid, vanillin, and xylose. In some embodiments, any of the non-volatile compounds described herein can be fat-soluble, e.g., 2(5H)-furanone, 2,3,5,6-tetramethylpyrazine, 2,3,5-trimethylpyrazine, 2,3-dimethylpyrazine, 2-ethyl-2-hydroxybutyric acid, 2-furoic acid, 2-isopropylmalic acid, 3,4-dihydroxybenzoic acid, 4-guanidinobutyric acid, 4-methoxycinnamic acid, 5-ethyl-4-hydroxy-2-methyl-3(2H)-furanone, acetovanillone, adenine, adipic acid, AMP, arabitol, arginine, asparagine, aspartic acid, beta-alanine, betaine, caffeic acid, caffeine, carnitine, carnosine, catechin, choline, cinnamic acid, citric acid, citrulline, CMP, coumaric acid, cysteine, cystine, cytidine, cytosine, D-gluconic acid, D-glucuronic acid, DL-hydroxystearic acid, ellagic acid, epicatechin, epicatechin gallate, fructose, fumaric acid, GABA, galactose, gallic acid, glucosamine, glucose, glutamic acid, glutamine, glycine, guanine, hesperetin, histidine, homoserine, hydroxymethylfurfural, isoleucine, kynurenic acid, lactic acid, leucine, lysine, malic acid, mannitol, mannose, methionine, methyl gallate, methyl-2-pyrrolyl ketone, inositol, ornithine, pantothenic acid, phenylalanine, pipecolinic acid, piperine, polydatin, proline, propyl gallate, pyridine, pyridoxine, pyruvic acid, quercetin, quinic acid, resveratrol, rhamnose, ribose, rutin, salicylic acid, serine, sinapinic acid, sorbic acid, sorbitol, sotolon, succinic acid, syringaldehyde, syringic acid, tartaric acid, threonine, trans-4-hydroxyproline, trans-ferulic acid, tryptamine, tryptophan, tyramine, tyrosine, uracil, valine, vanillic acid, vanillin, and xylose.

The method can further include agglomerating the flavor mixture. The agglomerating the flavor mixture can include pneumatic mixing, steam-jet, fluid-bed, pan, or spray drying, drum, mixer, roller, or extrusion agglomeration. The nut butter replica can include a solid substrate. The method can further include applying the flavor mixture to the solid substrate. The applying the flavor mixture can include spray applying the flavor mixture. The solid substrate can include processed or unprocessed grains or grain products, legumes or legume seeds, oil plants or seeds, fruits or fruit products, roots, tubers, or root or tuber products, sugar processing by-products, or other plant by-products. The solid substrate can include grape seeds or other fruit seeds (e.g., seeds from raspberry, cranberry, blackberry, and/or strawberry).

In any of the methods described herein, at least one of the following is true: a) the one or more isolated VOCs include at least one VOC that is not present in a corresponding reference nut butter; b) the one or more isolated VOCs do not include at least one VOC that is present in a corresponding reference nut butter; c) the one or more isolated VOCs are present in the nut butter replica in a total amount of at least 100 ppm; d) the one or more isolated non-volatile compounds include at least one non-volatile compound that is not present in a corresponding reference nut butter; or e) the one or more isolated non-volatile compounds do not include at least one non-volatile compound that is present in a corresponding reference nut butter.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the description below. Other features, objects, and advantages of the invention will be apparent from the description and from the claims.

### DETAILED DESCRIPTION

This document provides nut butter-like products (e.g., solids, liquids, and pastes) as well as methods for making nut butter-like products by combining individual, isolated volatile organic compounds (VOCs) and non-volatile organic compounds, with or without other components. Compounds designated as “VOCs” herein can be measured using GCMS. Compounds designated as “non-volatile compounds” herein can be measured using LCMS. Although some compounds may be able to be measured using either GCMS or LCMS, for the purposes of this disclosure, a compound is either a VOC or a non-volatile compound. For a compound not specifically described herein, the compound can be considered either a VOC or a non-volatile compound, based on factors such as similarity to compounds described herein and the method (GCMS or LCMS) that the ordinary artisan would select for its analysis.

Generally, these products can be called “nut butter-like products” or “nut butter replicas.” Examples of nut butters include peanut butter, almond butter, hazelnut butter, acorn butter, cashew butter, macademia butter, pecan butter, pistachio butter, walnut butter, other nut butters, coatings, and spreads. Accordingly, this document provides replicas of these, which can be termed “nut butter-like spreads” or “nut butter replicas”, “nut butter-like coatings”, or “nut butter coating replicas”, or “spread replicas”, respectively. The nut butter-like products described herein can have characteristics—including taste, aroma, mouthfeel, and appearance—of traditionally generated nut butters, and are meant to be consumed and enjoyed in the same manner as traditional nut butters.

As used herein, the term “isolated VOC,” or “isolated non-volatile compound” refers to a VOC or a non-volatile compound that has been isolated (e.g., purified, extracted and/or enriched) from a natural or synthetic source. In some embodiments, isolated VOCs and isolated non-volatile compounds described herein can be individually added to generate a nut butter replica. In some embodiments, one or more isolated VOCs and isolated non-volatile compounds described herein can be added as a blend that includes one or more isolated VOCs or isolated non-volatile compounds, to generate a nut butter replica. In some embodiments, the isolated VOCs or isolated non-volatile compounds have a purity is at least 50%, at least 55%, at least 60%, at least 65%, at least 70%, at least 75%, at least 80%, at least 85%, at least 90%, at least 95%, at least 95.5%, at least 96%, at least 96.5%, at least 97%, at least 97.5%, at least 98%, at least 98.5%, at least 99%, at least 99.1%, at least 99.2%, at least 99.3%, at least 99.4%, at least 99.5%, at least 99.6%, at least 99.7%, at least 99.8%, at least 99.9%, at least 99.99%, or at least 99.999%. In some embodiments, the purity is labeled on the container of the product.

As used herein, the terms “traditional” and “reference” nut butter refer to nut butter products produced through standard nut butter making processes, which include the farming, processing, drying, roasting, cooling, blanching, and grinding of tree nuts. “Traditionally-produced nut butter” is nut butter that was generated using standard nut butter making process.

Traditional nut butters are complex mixtures on a chemical level. In some aspects, this document provides nut butter replicas that are less complex than a traditional nut butter. It is surprising that the replicas disclosed herein, do not need to have the complexity of a traditional nut butter in order to be perceived as such. It is also surprising that some compounds, which by themselves have an unpleasant taste and/or smell, can enhance the taste and/or smell of the nut butter replicas disclosed herein. It is further surprising that the exclusion of some compounds found in all tested traditional nut butters was not detrimental to the nut butter replicas described herein. Similarly, it is surprising that some compounds that were not found in any tested traditional nut butter could be beneficial to the nut butter replicas described herein. It is also surprising that nut butter replicas described herein containing some compounds in amounts greater than the highest measured amount in any tested traditional nut butter or lower than the lowest measured amount in any tested traditional nut butter are superior to replicas that contained the same compounds in amounts within the measured range of traditional nut butter. Therefore, in another aspect, this document provides nut butter replicas that are not mere replicas of existing products, but instead provide a similar sensory experience with a different chemical composition.

In some embodiments, a nut butter replica can consist of the ingredients included in a particular list, or can have a VOC content (or non-volatile compound content) that consists of the VOCs or non-volatile compounds included in a particular list. Further, a nut butter replica can consist essentially of the ingredients included in a particular list, or can have a VOC content (or non-volatile compound content) that consists essentially of the VOCs or non-volatile compounds that are included in a particular list. By “consisting essentially of” is meant that a nut butter replica contains specified ingredients/VOCs/non-volatile compounds, and can contain additional ingredients/VOCs/non-volatile compounds that do not materially affect the basic and novel characteristics of the nut butter.

In general, the nut butter replicas include the following components, or classes of components:

a) one or more VOCs; and

b) one or more non-volatile compounds (including sweetening agents, a plant substrate, a stabilizing fat, and salt).

Nut butter-like spreads and spread replicas can include the following components, or classes of components:

a) one or more VOCs; and

b) one or more non-volatile compounds (including sweetening agents, a plant substrate, emulsifying agents, cocoa, a stabilizing fat, vanilla flavors, and dairy or dairy alternatives).

The VOCs can provide both aroma and flavor, including fruity, floral, green, earthy, herbaceous, roasted/burnt, sour/fermented, creamy, spice, and/or mineral aromas and flavors. The non-volatile components can provide acidity and much of the flavor, sweetness, aftertaste, physical structure, and mouthfeel perception of the nut butter replicas.

In some embodiments, a nut butter replica can include (a) one or more VOCs, where at least one of the one or more VOCs are not present in a corresponding reference nut butter; (b) one or more VOCs, where the one or more VOCs do not include at least one VOC that is present in a corresponding reference nut butter; (c) one or more non-volatile compounds, where the at least one of the one or more non-volatile compounds are not present in a corresponding reference nut butter; (d) one or more non-volatile compounds, where the one or more non-volatile compounds do not include at least one non-volatile compound that is present in a corresponding reference nut butter; or (e) any combination of (a), (b), (c), and (d) [(a) and (b); (a) and (c); (a) and (d); (b) and (c); (b) and (d); (c) and (d); (a), (b), and (c); (a), (b), and (d); (a), (c), and (d); (b), (c), and (d); or (a), (b), (c), and (d)]. In some embodiments, a nut butter replica can be characterized by (f) one or more VOCs, where the one or more VOCs are present in the nut butter replica in a total amount of at least 100 ppm. Characteristic (f) can be combined with any combination of (a)-(d) as described above.

In some embodiments, provided herein is a nut butter replica including: one or more VOCs; and one or more non-volatile compounds. In some embodiments, the one or more VOCs include at least one VOC that is not present in a corresponding reference nut butter. In some embodiments, the one or more VOCs do not include at least one VOC that is present in a corresponding reference nut butter. In some embodiments, the one or more VOCs are present in the nut butter replica in a total amount of at least 100 ppm. In some embodiments, the one or more non-volatile compounds include at least one non-volatile compound that is not present in a corresponding reference nut butter. In some embodiments, the one or more non-volatile compounds do not include at least one non-volatile compound that is present in a corresponding reference nut butter.

In some embodiments, provided herein is a method of preparing a nut butter replica, and the method includes: forming a mixture including: water, one or more VOCs that are water-soluble, and one or more purie non-volatile compounds that are water-soluble; forming a substrate emulsion including: an oil, one or more VOCs that are fat-soluble, and one or more non-volatile compounds that are fat-soluble; and mixing the aqueous solution and the emulsion to form a flavor mixturenut butter replica.

In some embodiments, the one or more VOCs described herein are isolated VOCs. In some embodiments, the one or more non-volatile compounds described herein are isolated non-volatile compounds.

It will be appreciated that any and all stereoisomers can be used when no stereochemistry is specified.

### Volatile Organic Compounds (VOCs)

The nut butter replicas described herein can, in some cases, include at least one VOC that is not present in a corresponding reference nut butter. Non-limiting examples of VOCs that are not present in a corresponding reference nut butter include 2,2,4-trimethyl-1,3-oxacyclopentane, 2-furyl methyl ketone, delta-hexalactone, octanal propyleneglycol acetal, (+/−)-trans- and cis-2-hexenal propylene glycol acetal, 2-isobutyl-4-methyl-1,3-dioxolane, cis- and trans-ethyl 2,4-dimethyl-1,3-dioxolane-2-acetate, eugenol, valeraldehyde propyleneglycol acetal, isopropenyl pyrazine, and gamma-decalactone.

Therefore, in some embodiments, a nut butter replica can include one or more (e.g., at least 2, 3, 4, 5, 10, 15, 20, 25, or 29) compounds selected from the group consisting of 2,2,4-trimethyl-1,3-oxacyclopentane, 2-furyl methyl ketone, delta-hexalactone, octanal propyleneglycol acetal, (+/−)-trans- and cis-2-hexenal propylene glycol acetal, 2-isobutyl-4-methyl-1,3-dioxolane, cis- and trans-ethyl 2,4-dimethyl-1,3-dioxolane-2-acetate, eugenol, valeraldehyde propyleneglycol acetal, isopropenyl pyrazine, and gamma-decalactone.

The nut butter replicas described herein can, in some cases, exclude at least one VOC that is present in a corresponding reference nut butter. Non-limiting examples of VOCs that are present in reference nut butters include (+/−) 2-methyl-1-butanol, 1-methyl-1h-pyrrole-2-carboxaldehyde, 1-octen-3-ol, 1-penten-3-one, 2,3,5,6-tetramethylpyrazine, 2,3,5-trimethylpyrazine, 2,3-diethyl-5-methylpyrazine, 2,3-dimethylpyrazine, 2,3-pentanedione, 2,5-dimethylpyrazine, 2-ethyl-6-methylpyrazine, 2-methyl-5-vinylpyrazine (re-gras), 2-methylbutyraldehyde, 2-methylbutyric acid, 2-methylpyrazine, 2-methyltetrahydrofuran-3-one, 2-nonanone, 2-octanone, 2-pentylfuran, 3,5-diethyl-2-methylpyrazine, 3-octen-2-one, 4-hexene-3-one, 4-hydroxy-2-butenoic acid gamma-lactone, 4-methyl-3-penten-2-one, 5-methylfurfural, acetoin, amyl alcohol, benzaldehyde, benzene, 1,3,5-trimethyl-, decanal, furfural, furfuryl alcohol, heptanal, heptyl alcohol, hexanal, hexanoic acid, hexyl alcohol, isoamyl alcohol, isobutyl isobutyrate, methyl 2-pyrrolyl ketone, methylcyclopentenolone, nonanal, nonyl alcohol, phenylacetaldehyde, pyrazine, pyridine, pyrrole, valeraldehyde, 2,3-butanediol, 2-phenyl-2-butenal, 3-ethyl-2,6-dimethylpyrazine, 5,6,7,8-tetrahydroquinoxaline, d-limonene, heptyl formate, trans-2-heptenal, 1-octanol, 2-acetyl-1-pyrroline, 2-undecenal, benzyl benzoate, cinnamaldehyde, (e)-piperonal, vanillin, (e,e)-3,5-octadien-2-one, 2-ethyl-5-methylpyrazine, 2-ethylfuran, 2-heptanone, 2-pyrrolidone, caffeine, gamma-nonalactone, maltol, phenethyl acetate, 2-ethylpyrazine, 2-methoxy-4-vinylphenol, 3-octanone, 3-phenylpropionaldehyde, 4-hydroxybutanoic acid lactone, alpha-pinene, delta-3-carene, dihydrocoumarin, ethyl 2-methylbutyrate, ethyl benzoate, gamma-hexalactone, hexyl acetate, isobutyric acid, isovaleric acid, naphthalene, phenethyl alcohol, propylene glycol, styrene, 4-methylthiazole, alpha-phellandrene, methylsulfinylmethane, palmitic acid, pyruvaldehyde, pyruvic acid, 2,5-dimethylfuran, 2-butanone, 2-butylfuran, 2-decanone, 3-hepten-2-one, 4-carvomenthenol, 4-heptanone, 4-methyl-5-thiazoleethanol, 5-ethyl-2,3-dimethylpyrazine, butyric acid, delta-octalactone, gamma-heptalactone, heptanoic acid, methyl heptanoate, methyl hexanoate, methyl octanoate, methyl valerate, octanal, octanoic acid, o-methylanisole, p-mentha-1,4-diene, terpinolene, thiazole, trans-2-hexenal, valeric acid, 1-octen-3-one, 1-penten-3-ol, 3-hexanol, 3-penten-2-one, beta-angelicalactone, nonanoic acid, o-cymene, p-tolyl acetate, tetrahydrofurfuryl alcohol, 1-methylnaphthalene, 3-furaldehyde, 3-methyl-2-cyclohexen-1-one, 1-rhamnose, (e)-2-octen-1-ol, 1-ethyl-2-pyrrolecarboxaldehyde, 1-methylpyrrole, 2-acetyl-2-thiazoline, 2-methylpentanal, 3-n-butylphthalide, 4,5-dihydro-3(2h)thiophenone, 4-hydroxy-2,5-dimethyl-3(2h)-furanone, 4-hydroxy-5-methyl-3(2h)-furanone, 5h-5-methyl-6,7-dihydrocyclopenta(b)pyrazine, 5-isopropyl-2-methylpyrazine, 5-methylfurfuryl alcohol, acetophenone, benzoic acid, cyclopentanone, dimethyl disulfide, dimethyl trisulfide, indole, isopropenylpyrazine, n-furfurylpyrrole, oleic acid, phenethyl butyrate, propionic acid, trimethyloxazole, 2-heptanol, 2-pentanone, 1-tyrosine, methyl nicotinate, 1-nonene, 1-octene, cinnamaldehyde, hydroxyacetone, hexyl formate, phenethyl benzoate, 1-hexadecanol, 1-tetradecanol, 2-ethylhexyl benzoate, benzophenone, butyl isobutyrate, epsilon-decalactone, ethyl decanoate, ethyl laurate, ethyl myristate, ethyl octanoate, ethyl palmitate, guaiacol, lauric acid, methyl acetate, myristic acid, n-capric acid isobutyl ester, pentadecanoic acid, 3-methylbutyl ester, phenethyl decanoate, phenethyl octanoate, propyl p-hydroxybenzoate, stearic acid, 2,6-dimethylpyrazine, 2-acetyl-3-methylpyrazine, benzyl alcohol, menthol racemic, s-methyl thioacetate, 2-methoxy-3(5 and 6)-isopropylpyrazine, glycerol, 2-ethyl-1-hexanol, (tri-)acetin, 5-methyl-2-phenyl-2-hexenal, butyl acetate, undecyl alcohol, isobutyl acetate, propyl acetate, tetrahydrofurfuryl acetate, 2-isobutyl-4,5-dimethyloxazole, 2,6-dimethyl-4-heptanone, 4-methyl-5-vinylthiazole, beta-pinene, 2,3-hexanedione, 3-(methylthio)propionaldehyde, beta-caryophyllene, delta-hexadecalactone, difurfuryl ether, trans,trans-2,4-octadienal, 2-methylheptanoic acid, ethyl nonanoate, 2-heptylfuran, camphene, cyclohexanone, ethyl heptanoate, ethyl hexanoate, ethyl lactate, gamma-valerolactone, heptyl acetate, isopropenyl acetate, methyl butyrate, methyl levulinate, butylamine, methyl nonanoate, 3-methyl-2-butanol, 6-methyl-5-hepten-2-one, isoamyl acetate, 2-acetyl-3-ethylpyrazine, 2-acetylpyridine, butyl butyrate, lauryl alcohol, p-cymene, 3,4-dimethylthiophene, 4-hydroxybenzoic acid, 9-octadecenoic acid, ethyl ester, ethyl pyruvate, isopropylamine, 3-methyl-1-pentanol, 2-oxobutyric acid, 4-methyl-2-phenyl-2-pentenal, 2-acetyl-3,5(and 6)-dimethylpyrazine, trimethylamine, 2(3),5-dimethyl-6,7-dihydro-5h-cyclopentapyrazine, methyl cinnamate, amyl formate, 5-hydroxyundecanoic acid lactone, propiophenone, 2-isopropylpyrazine, 2-ethylbutyl acetate, 2-acetyl-5-methylfuran, acetaldehyde, gamma-decalactone, trans-2-decenol, 4,5-dimethylthiazole, isobutyl butyrate, tridecanoic acid, 1-mercapto-2-propanone. Therefore, in some embodiments, a nut butter replica can lack one or more (e.g., at least 2, 3, 4, 5, 10, 15, 20, 30, 40, 50, 75, 100, 125, 150, 175, 200, 225, 250, or 261) compounds selected from the group consisting of (+/−) 2-methyl-1-butanol, 1-methyl-1h-pyrrole-2-carboxaldehyde, 1-octen-3-ol, 1-penten-3-one, 2,3,5,6-tetramethylpyrazine, 2,3,5-trimethylpyrazine, 2,3-diethyl-5-methylpyrazine, 2,3-dimethylpyrazine, 2,3-pentanedione, 2,5-dimethylpyrazine, 2-ethyl-6-methylpyrazine, 2-methyl-5-vinylpyrazine (re-gras), 2-methylbutyraldehyde, 2-methylbutyric acid, 2-methylpyrazine, 2-methyltetrahydrofuran-3-one, 2-nonanone, 2-octanone, 2-pentylfuran, 3,5-diethyl-2-methylpyrazine, 3-octen-2-one, 4-hexene-3-one, 4-hydroxy-2-butenoic acid gamma-lactone, 4-methyl-3-penten-2-one, 5-methylfurfural, acetoin, amyl alcohol, benzaldehyde, benzene, 1,3,5-trimethyl-, decanal, furfural, furfuryl alcohol, heptanal, heptyl alcohol, hexanal, hexanoic acid, hexyl alcohol, isoamyl alcohol, isobutyl isobutyrate, methyl 2-pyrrolyl ketone, methylcyclopentenolone, nonanal, nonyl alcohol, phenylacetaldehyde, pyrazine, pyridine, pyrrole, valeraldehyde, 2,3-butanediol, 2-phenyl-2-butenal, 3-ethyl-2,6-dimethylpyrazine, 5,6,7,8-tetrahydroquinoxaline, d-limonene, heptyl formate, trans-2-heptenal, 1-octanol, 2-acetyl-1-pyrroline, 2-undecenal, benzyl benzoate, cinnamaldehyde, (e)-, piperonal, vanillin, (e,e)-3,5-octadien-2-one, 2-ethyl-5-methylpyrazine, 2-ethylfuran, 2-heptanone, 2-pyrrolidone, caffeine, gamma-nonalactone, maltol, phenethyl acetate, 2-ethylpyrazine, 2-methoxy-4-vinylphenol, 3-octanone, 3-phenylpropionaldehyde, 4-hydroxybutanoic acid lactone, alpha-pinene, delta-3-carene, dihydrocoumarin, ethyl 2-methylbutyrate, ethyl benzoate, gamma-hexalactone, hexyl acetate, isobutyric acid, isovaleric acid, naphthalene, phenethyl alcohol, propylene glycol, styrene, 4-methylthiazole, alpha-phellandrene, methylsulfinylmethane, palmitic acid, pyruvaldehyde, pyruvic acid, 2,5-dimethylfuran, 2-butanone, 2-butylfuran, 2-decanone, 3-hepten-2-one, 4-carvomenthenol, 4-heptanone, 4-methyl-5-thiazoleethanol, 5-ethyl-2,3-dimethylpyrazine, butyric acid, delta-octalactone, gamma-heptalactone, heptanoic acid, methyl heptanoate, methyl hexanoate, methyl octanoate, methyl valerate, octanal, octanoic acid, o-methylanisole, p-mentha-1,4-diene, terpinolene, thiazole, trans-2-hexenal, valeric acid, 1-octen-3-one, 1-penten-3-ol, 3-hexanol, 3-penten-2-one, beta-angelicalactone, nonanoic acid, o-cymene, p-tolyl acetate, tetrahydrofurfuryl alcohol, 1-methylnaphthalene, 3-furaldehyde, 3-methyl-2-cyclohexen-1-one, 1-rhamnose, (e)-2-octen-1-ol, 1-ethyl-2-pyrrolecarboxaldehyde, 1-methylpyrrole, 2-acetyl-2-thiazoline, 2-methylpentanal, 3-n-butylphthalide, 4,5-dihydro-3(2h)thiophenone, 4-hydroxy-2,5-dimethyl-3(2h)-furanone, 4-hydroxy-5-methyl-3(2h)-furanone, 5h-5-methyl-6,7-dihydrocyclopenta(b)pyrazine, 5-isopropyl-2-methylpyrazine, 5-methylfurfuryl alcohol, acetophenone, benzoic acid, cyclopentanone, dimethyl disulfide, dimethyl trisulfide, indole, isopropenylpyrazine, n-furfurylpyrrole, oleic acid, phenethyl butyrate, propionic acid, trimethyloxazole, 2-heptanol, 2-pentanone, l-tyrosine, methyl nicotinate, 1-nonene, 1-octene, cinnamaldehyde, hydroxyacetone, hexyl formate, phenethyl benzoate, 1-hexadecanol, 1-tetradecanol, 2-ethylhexyl benzoate, benzophenone, butyl isobutyrate, epsilon-decalactone, ethyl decanoate, ethyl laurate, ethyl myristate, ethyl octanoate, ethyl palmitate, guaiacol, lauric acid, methyl acetate, myristic acid, n-capric acid isobutyl ester, pentadecanoic acid, 3-methylbutyl ester, phenethyl decanoate, phenethyl octanoate, propyl p-hydroxybenzoate, stearic acid, 2,6-dimethylpyrazine, 2-acetyl-3-methylpyrazine, benzyl alcohol, menthol racemic, s-methyl thioacetate, 2-methoxy-3(5 and 6)-isopropylpyrazine, glycerol, 2-ethyl-1-hexanol, (tri-)acetin, 5-methyl-2-phenyl-2-hexenal, butyl acetate, undecyl alcohol, isobutyl acetate, propyl acetate, tetrahydrofurfuryl acetate, 2-isobutyl-4,5-dimethyloxazole, 2,6-dimethyl-4-heptanone, 4-methyl-5-vinylthiazole, beta-pinene, 2,3-hexanedione, 3-(methylthio)propionaldehyde, beta-caryophyllene, delta-hexadecalactone, difurfuryl ether, trans,trans-2,4-octadienal, 2-methylheptanoic acid, ethyl nonanoate, 2-heptylfuran, camphene, cyclohexanone, ethyl heptanoate, ethyl hexanoate, ethyl lactate, gamma-valerolactone, heptyl acetate, isopropenyl acetate, methyl butyrate, methyl levulinate, butylamine, methyl nonanoate, 3-methyl-2-butanol, 6-methyl-5-hepten-2-one, isoamyl acetate, 2-acetyl-3-ethylpyrazine, 2-acetylpyridine, butyl butyrate, lauryl alcohol, p-cymene, 3,4-dimethylthiophene, 4-hydroxybenzoic acid, 9-octadecenoic acid, ethyl ester, ethyl pyruvate, isopropylamine, 3-methyl-1-pentanol, 2-oxobutyric acid, 4-methyl-2-phenyl-2-pentenal, 2-acetyl-3,5(and 6)-dimethylpyrazine, trimethylamine, 2(3),5-dimethyl-6,7-dihydro-5h-cyclopentapyrazine, methyl cinnamate, amyl formate, 5-hydroxyundecanoic acid lactone, propiophenone, 2-isopropylpyrazine, 2-ethylbutyl acetate, 2-acetyl-5-methylfuran, acetaldehyde, gamma-decalactone, trans-2-decenol, 4,5-dimethylthiazole, isobutyl butyrate, tridecanoic acid, and 1-mercapto-2-propanone. In some embodiments, a nut butter replica can lack on or more compounds (e.g., at least 2, 3, 4, 5, 10, 15, 20, 30, or 40) compounds selected from the group consisting of 2-ethyl furan, 5-methylfurfural, cyclopentanone, furfural, and limonene.

The VOCs present in a nut butter replica can include compounds as classified by a first set of categories, including hydrocarbons (e.g., alkanes, alkenes, terpenes, isoprenoids, or aromatic hydrocarbons), alcohols, aldehydes, ketones, acids, esters, lactones, phenols, furans, thiophenes, pyrroles, oxazoles, thiazoles, pyridines, pyrazines, amines, sulfur compounds (e.g., alkyl sulfides), and other VOCs (e.g., VOCs that do not belong to any of the above categories). In some embodiments, a nut butter replica can include a hydrocarbon, an alcohol, an aldehyde, a ketone, an acid, an ester, a phenol, a furan, a thiophene, a pyrrole, a pyridine, a pyrazine, an amine, and a sulfur compound. In some embodiments, a nut butter replica can further include a VOC that does not belong to any of the preceding categories. In some embodiments, a nut butter replica can include at least one VOC that belongs to each of at least 3 (e.g., at least 4, at least 5, at least 5, at least 7, at least 8, at least 9, at least 10, 3 to 14, 3 to 10, 3 to 5, 5 to 14, 5 to 10, or 10 to 14) of the following categories: hydrocarbon, an alcohol, an aldehyde, a ketone, an acid, an ester, a phenol, a furan, a thiophene, a pyrrole, a pyridine, a pyrazine, an amine, and a sulfur compound.

The VOCs present in a nut butter replica can include compounds as classified by a second set of categories, including acids, alcohols, aldehydes, amines, benzenes, esters, furans, ketones, lactones, phenols, pyrazines, pyridines, pyrroles, sugars or sugar alcohols, sulfur compounds, terpenes, or thiophenes. In some embodiments, a nut butter replica can include one or more of: an acid, an alcohol, an aldehyde, an ester, a furan, a ketone, a lactone, a phenol, a pyrazine, a pyridine, a pyrrole, a sugar or sugar alcohol, a sulfur compound, a terpene, or a combination thereof. In some embodiments, a nut butter replica can include an acid, an alcohol, an aldehyde, an ester, a furan, a ketone, a lactone, a phenol, a pyrazine, a pyrrole, a sugar or sugar alcohol, a sulfur compound, or a combination thereof. In some embodiments, a nut butter replica can include at least one VOC that belongs to each of at least 3 (e.g., at least 4, at least 5, at least 5, at least 7, at least 8, at least 9, at least 10, at least 15, 3 to 15, 3 to 10, 3 to 5, 5 to 14, 5 to 10, 10 to 15, or 10 to 17) of the following categories: acids, alcohols, aldehydes, amines, benzenes, esters, furans, ketones, lactones, phenols, pyrazines, pyridines, pyrroles, sugars or sugar alcohols, sulfur compounds, terpenes, or thiophenes. In some embodiments, a nut butter replica can include an acid, an alcohol, an aldehyde, an ester, a furan, a ketone, a lactone (e.g., 5-hydroxy-2,4-decadienoic acid delta-lactone), a phenol (e.g., syringol or 4-ethylguaiacol), a pyrazine, a pyrrole, a sugar or sugar alcohol, a sulfur compound.

Hydrocarbons can provide flavors and/or aromas that are important to the general character of nut butter (e.g., alkanes, alkenes, terpenes, isoprenoids, or aromatic hydrocarbons). For example, terpenes and isoprenoids can contribute floral and green characteristics to nut butter. Non-limiting examples of hydrocarbons that may be used in nut butter replicas provided herein include beta-myrcene, styrene, and mixtures thereof. The hydrocarbon(s) can be present in any suitable amount. The hydrocarbon(s) can make up any suitable proportion of the overall VOC content. Any suitable number of hydrocarbons can be used, for example, 1 to 3, 1 to 2, at least 1, or at least 2 hydrocarbons can be used.

Terpenes can contribute floral and green characteristics to nut butter. Non-limiting examples of terpenes that may be used in nut butter replicas provided herein include linalool, pyrrole, d-limonene, alpha-pinene, delta-3-carene, naphthalene, styrene, 4-methylthiazole, alpha-phellandrene, o-methylanisole, p-mentha-1,4-diene, terpinolene, thiazole, o-cymene, 1-methylnaphthalene, 1-methylpyrrole, indole, n-furfurylpyrrole, trimethyloxazole, 1-nonene, 1-octene, 2-isobutyl-4,5-dimethyloxazole, 4-methyl-5-vinylthiazole, beta-pinene, beta-caryophyllene, camphene, p-cymene, 3,4-dimethylthiophene, 4,5-dimethylthiazole and mixtures thereof. In some embodiments, a nut butter replica can include one or more (e.g., at least 1 or 2) terpenes selected from the group consisting of limonene and linalool. The terpene(s) can be present in any suitable amount. In some embodiments, the terpene(s) can be present in an amount of about 0.01 to about 20 ppm (e.g., about 0.01 to about 1.0 ppm, about 1.0 to about 2.0 ppm, about 2.0 to about 3.0 ppm, or about 3.0 to about 20 ppm). The terpene(s) can make up any suitable proportion of the overall VOC content. Any suitable number of terpenes can be used, for example, 1 to 3, 1 to 2, at least 1, or at least 2 terpenes can be used. In some embodiments, a nut butter replica can include no terpenes. In some embodiments, a nut butter replica as provided herein can include limonene and/or linalool.

Benzenes can provide flavors and/or aromas that are important to the general character of nut butters. Non-limiting examples of benzenes that may be used in nut butter replicas provided herein include dihydrocoumarin, styrene, myrcene, and mixtures thereof. The benzene(s) can be present in any suitable amount. The benzene(s) can make up any suitable proportion of the overall VOC content. Any suitable number of benzenes can be used, for example, 1 to 3, 1 to 2, at least 1, or at least 2 benzenes can be used. In some embodiments, a nut butter replica can include no benzenes. In some embodiments, a nut butter replica as provided herein can include dihydrocoumarin.

Alcohols can provide various flavor and/or aroma components to nut butter, including banana, spice, grassiness, and oxidized characteristics. Alcohols also can be important for adding roundness to the general aroma of nut butter, as well as some weight on the palate. Non-limiting examples of alcohols that can be present in the nut butter replicas provided herein include (+/−) 2-methyl-1-butanol, 1-octen-3-ol, amyl alcohol, furfuryl alcohol, heptyl alcohol, hexyl alcohol, isoamyl alcohol, nonyl alcohol, 2,3-butanediol, 1-octanol, 2-methoxy-4-vinylphenol, phenethyl alcohol, propylene glycol, 4-carvomenthenol, 4-methyl-5-thiazoleethanol, 1-penten-3-ol, 3-hexanol, tetrahydrofurfuryl alcohol, (e)-2-octen-1-ol, 5-methylfurfuryl alcohol, 2-heptanol, 1-hexadecanol, 1-tetradecanol, guaiacol, benzyl alcohol, glycerol, 2-ethyl-1-hexanol, undecyl alcohol, 3-methyl-2-butanol, lauryl alcohol, 3-methyl-1-pentanol, trans-2-decenol, eugenol, and mixtures thereof. In some embodiments, a nut butter replica as provided herein can include one or more (e.g., at least 2, 3, 4, 5, or 6) alcohols selected from the group consisting of 1-octen-3-ol, 4-ethylguiacol, 2-pentanol, 2,4,6-trimethylphenol (mesitol), p-cresol, and eugenol. In some embodiments, a nut butter replica as provided herein can include one or more (e.g., at least 1, 2, 3, 4, 5, or 6) alcohols selected from the group consisting of 1-octen-3-ol, furfuryl alcohol, p-cresol, eugenol, phenethyl alcohol, and 4-methyl-5-thiazoleethanol.

The alcohol(s) can be present in any suitable amount. In some embodiments, the alcohol(s) can be present in an amount of about 0.001 to about 1.0 ppm (e.g., about 0.001 to about 0.01 ppm, about 0.01 to about 0.10 ppm, about 0.10 to about 1.0 ppm). The alcohol(s) can make up any suitable proportion of the overall VOC content. Any suitable number of alcohols can be used, for example, at least one alcohol can be used. In some embodiments, a nut butter replica can include no alcohols.

Aldehydes can provide flavors and/or aromas that are important to the general character of nut butter. Non-limiting examples of aldehydes that may be used in nut butter replicas provided herein include 1-methyl-1h-pyrrole-2-carboxaldehyde, 2-methylbutyraldehyde, 3-methylbutyraldehyde, 5-methylfurfural, benzaldehyde, decanal, furfural, heptanal, hexanal, nonanal, phenylacetaldehyde, valeraldehyde, 2-phenyl-2-butenal, 3-methyl-2-butenal, trans-2-heptenal, 2-undecenal, piperonal, 3-phenylpropionaldehyde, pyruvaldehyde, octanal, trans-2-hexenal, 3-furaldehyde, 1-ethyl-2-pyrrolecarboxaldehyde, 2-methylpentanal, pentanal, cinnamaldehyde, 5-methyl-2-phenyl-2-hexenal, 3-(methylthio)propionaldehyde, trans,trans-2,4-octadienal, 4-methyl-2-phenyl-2-pentenal, acetaldehyde, octanal propyleneglycol acetal, (+/−)-trans- and cis-2-hexenal propylene glycol acetal, valeraldehyde propyleneglycol acetal, vanillin, 4-methyl-5-thiazoleethanol acetate, 5-methyl-2-furancarboxaldehyde, and mixtures thereof. In some embodiments, a nut butter replica as provided herein can include one or more (e.g, at least 2, 3, 4, 5, 10, or 15) aldehydes selected from the group consisting of (E,E)-2,4-decadienal, 5-methylfurfural, benzaldehyde, furfural, methional, 3-(methylthio)propionaldehyde, isobutyraldehyde, valeraldehyde, vanillin, octanal propyleneglycol acetal, (+/−)-trans- and cis-2-hexenal propylene glycol acetal, and valeraldehyde propyleneglycol acetal. In some embodiments, a nut butter replica as provided herein can include one or more (e.g., at least 2, 3, or 4) aldehydes selected from the group consisting of (E,E)-2,4-decadienal, methional, 3-(methylthio)propionaldehyde, isobutyraldehyde, valeraldehyde, octanal propyleneglycol acetal, (+/−)-trans- and cis-2-hexenal propylene glycol acetal, valeraldehyde propyleneglycol acetal, and vanillin. The aldehyde(s) can be present in any suitable amount. In some embodiments, the aldehyde(s) can be present in an amount of about 0.001 to about 500 ppm (e.g., about 0.001 to about 10 ppm, about 10 to about 100 ppm, about 100 to about 250 ppm, or about 250 to about 500 ppm). The aldehyde(s) can make up any suitable proportion of the overall VOC content. Any suitable number of aldehydes can be used, for example, 1 to 5, 1 to 3, 3 to 5, at least 1, at least 2, at least 3, or at least 4 aldehydes can be used. In some embodiments, a nut butter replica can include no aldehydes. In some embodiments, a nut butter replica as provided herein can include one or more (e.g., at least 1, 2, 3, 4, 5, or 6) aldehydes selected from the group consisting of (E,E)-2,4-decadienal, 5-methylfurfural, benzaldehyde, furfural, valeraldehyde, 3-(methylthio)propionaldehyde, hexanal, isobutyraldehyde, vanillin, methional, phenylacetaldehyde, 3-furaldehyde, pentanal, 3-methylbutyraldehyde, 3-methyl-2-butenal, 4-methyl-5-thiazoleethanol acetate, and 5-methyl-2-furancarboxaldehyde.

Ketones can provide flavors and/or aromas that are important to the general character of nut butter. Non-limiting examples of ketones that may be used in nut butter replicas provided herein include 1-penten-3-one, 2,3-pentanedione, 2-methyltetrahydrofuran-3-one, 2-nonanone, 2-octanone, 3-octen-2-one, 4-hexene-3-one, 4-methyl-3-penten-2-one, acetoin, methyl 2-pyrrolyl ketone, methylcyclopentenolone, (e,e)-3,5-octadien-2-one, 2-heptanone, 2-pyrrolidone, gamma-nonalactone, maltol, 3-octanone, gamma-hexalactone, 2-butanone, 2-decanone, 3-hepten-2-one, 4-heptanone, delta-octalactone, gamma-heptalactone, 1-octen-3-one, 3-penten-2-one, beta-angelicalactone, 3-methyl-2-cyclohexen-1-one, 4,5-dihydro-3(2h)thiophenone, 4-hydroxy-2,5-dimethyl-3(2h)-furanone, 4-hydroxy-5-methyl-3(2h)-furanone, acetophenone, cyclopentanone, 2-pentanone, hydroxyacetone, benzophenone, epsilon-decalactone, 2,6-dimethyl-4-heptanone, 2,3-hexanedione, 3,4-hexanedione, delta-hexadecalactone, cyclohexanone, gamma-valerolactone, 6-methyl-5-hepten-2-one, propiophenone, gamma-decalactone, 1-mercapto-2-propanone, 2-furyl methyl ketone, delta-hexalactone, and mixtures thereof. In some embodiments, a nut butter replica can include one or more (e.g., at least 2, 3, 4, 5, 10, or 15) one ketones selected from the group consisting of 2-heptanone, coffee furanone, cyclopentanone, gamma-decalactone, 2-furyl methylketone, acetoin, gamma-valerolactone, delta octalactone, delta decalactone, whiskey lactone, delta-octalactone, 5-methyl-2-hepten-4-one, beta-damascenone, 2,3-pentanedione, 4-hydroxy-2,5-dimethyl-3(2H)-furanone, and maltol. In some embodiments, a nut butter replica can include one or more (e.g., 2, 3, 4, 5, 6, 7, or 8) ketones selected from the group consisting of 2-heptanone, coffee furanone, gamma-decalactone, 2-furyl methylketone, acetoin, gamma-valerolactone, delta octalactone, delta decalactone, whiskey lactone, delta-octalactone, 5-methyl-2-hepten-4-one, beta-damascenone, 2,3-pentanedione, 4-hydroxy-2,5-dimethyl-3(2H)-furanone, and maltol. The ketone(s) can be present in any suitable amount. In some embodiments, the ketone(s) can be present in an amount of about 0.0001 to about 60 ppm (e.g., about 0.0001 to about 1.0 ppm, about 1.0 to about 10.0 ppm, about 10.0 to about 20.0 ppm, about 20.0 to about 30.0 ppm, about 30.0 to about 40.0 ppm, about 40.0 to about 50.0 ppm, and about 50.0 to about 60.0 ppm). The ketone(s) can make up any suitable proportion of the overall VOC content. Any suitable number of ketones can be used, for example, 1 to 8, 1 to 5, 1 to 3, 3 to 8, 3 to 5, 5 to 8, at least 1 at least 2, at least 3, at least 4, or at least 5 ketones can be used. In some embodiments, a nut butter replica can include no ketones. In some embodiments, a nut butter replica as provided herein can include one or more (e.g., at least 1, 2, 3, 4, 5, or 6) ketones selected from the group consisting of 2-heptanone, coffee furanone, cyclopentanone, gamma-decalactone, 2-methyltetrahydrofuran-3-one, 2-furyl methyl ketone, acetoin, acetophenone, delta-octalactone, 5-methyl-2-hepten-4-one, beta damascenone, 2,3-pentanedione, 4-hydroxy-2,5-dimethyl-3(2h)-furanone, maltol, and 3,4-hexanedione.

Acids may contribute to “sour” aromas and/or flavors, which can be important to the general character of nut butter. Acids that may be included in a nut butter replica include, without limitation, isovaleric acid, cinnamic acid, 2-methylbutyric acid, butyric acid, propanoic acid, 3-phenylpropionic acid, isobutyric acid, hexanoic acid, propionic acid, valeric acid, 3-phenylpropionic acid, and mixtures thereof. In some embodiments, a nut butter replica can include one or more (e.g., at least 2, 3, 4, 5, 6, or 7) acids selected from the group consisting of isovaleric acid, cinnamic acid, 2-methylbutyric acid, butyric acid, propanoic acid, 3-phenylpropionic acid, isobutyric acid, hexanoic acid, propionic acid, valeric acid, and 3-phenylpropionic acid. In some embodiments, a nut butter replica can include at one or more (e.g., 2 or 3) acids selected from the group consisting of isovaleric acid, cinnamic acid, 2-methylbutyric acid, butyric acid, propanoic acid, 3-phenylpropionic acid, isobutyric acid, and hexanoic acid. The acid(s) can be present in any suitable amount. In some embodiments, the acid(s) can be present in an amount of about 0.1 to about 70 ppm (e.g., about 0.1 to about 17.5 ppm, about 17.5 to about 35 ppm, about 35 to about 52.5 ppm, or about 52.5 to about 70 ppm). The acid(s) can make up any suitable proportion of the overall VOC content. Any suitable number of acids can be used, for example, 1 to 2, at least 1, or at least 2 acids can be used. In some embodiments, a nut butter replica can include no acids. In some embodiments, a nut butter replica as provided herein can include one or more (e.g., at least 1, 2, 3, or 4) acids selected from the group consisting of isovaleric acid, acetic acid, butyric acid, and 1-lactic acid.

Esters, including ethyl, methyl, and acetate esters, can contribute to the fruity and floral characteristics of a nut butter. Esters that may be used in a nut butter replica include, without limitation ethyl laurate, diethyl succinate, ethyl butyrate, ethyl 2-methylbutyrate, methyl butyrate, 2-methylbutyl isovalerate, ethyl hexanoate, methyl 2-methylbutyrate, ethyl isobutyrate, hexyl acetate, Ethyl phenylacetate, geranyl acetate, methyl para-anisate, ethyl lactate, isoamyl isobutyrate, ethyl heptanoate, butyl butyrate, isoamyl acetate, isobutyl acetate, benzyl acetate, butyl acetate, furfuryl acetate, hexyl isobutyrate, methyl benzoate, ethyl 3-hydroxybutanoate, ethyl-2-methylbutyrate, furfuryl propionate, isoamyl phenylacetate, dibutyl maleate, ethyl isovalerate, amyl acetate, isoamyl butyrate, phenethyl acetate, ethyl cinnamate, tetrahydrofurfuryl phenylacetate, ethyl acetate, ethyl octanoate, ethyl decanoate, methyl phenylacetate, ethyl 3-phenylpropionate, tricyclodecenyl isobutyrate, prenyl benzoate, ethyl benzoate, methyl salicylate, methyl 2-thiofuroate, isoamyl benzoate, propyl-2-furoate, methyl p-anisate, and mixtures thereof. In some embodiments, a nut butter replica can include one or more (e.g., at least 2, 3, 4, 5, 10, 15, 20, 25, 30, 35, or 40) esters selected from the group consisting of ethyl laurate, diethyl succinate, ethyl butyrate, ethyl 2-methylbutyrate, methyl butyrate, 2-methylbutyl isovalerate, ethyl hexanoate, methyl 2-methylbutyrate, ethyl isobutyrate, hexyl acetate, Ethyl phenylacetate, geranyl acetate, methyl para-anisate, ethyl lactate, isoamyl isobutyrate, ethyl heptanoate, butyl butyrate, isoamyl acetate, isobutyl acetate, benzyl acetate, butyl acetate, furfuryl acetate, hexyl isobutyrate, methyl benzoate, ethyl 3-hydroxybutanoate, ethyl-2-methylbutyrate, furfuryl propionate, isoamyl phenylacetate, dibutyl maleate, ethyl isovalerate, amyl acetate, isoamyl butyrate, phenethyl acetate, ethyl cinnamate, tetrahydrofurfuryl phenylacetate, ethyl acetate, ethyl octanoate, ethyl decanoate, methyl phenylacetate, ethyl 3-phenylpropionate, tricyclodecenyl isobutyrate, prenyl benzoate, ethyl benzoate, methyl salicylate, methyl 2-thiofuroate, isoamyl benzoate, propyl-2-furoate, and methyl p-anisate. In some embodiments, a nut butter replica can include one or more (e.g., at least 2, 3, 4, 5, 7, 9, 10, 11, or 13) esters selected from the group consisting of ethyl laurate, diethyl succinate, ethyl butyrate, ethyl 2-methylbutyrate, methyl butyrate, 2-methylbutyl isovalerate, ethyl hexanoate, methyl 2-methylbutyrate, ethyl isobutyrate, hexyl acetate, ethyl phenylacetate, geranyl acetate, methyl para-anisate, ethyl lactate, isoamyl isobutyrate, ethyl heptanoate, butyl butyrate, isoamyl acetate, isobutyl acetate, benzyl acetate, butyl acetate, furfuryl acetate, hexyl isobutyrate, methyl benzoate, ethyl 3-hydroxybutanoate, and ethyl-2-methylbutyrate. The ester(s) can be present in any suitable amount. In some embodiments, the ester(s) can be present in an amount of about 0.001 to about 50 ppm (e.g., about 0.001 to about 0.005 ppm, about 0.005 to about 0.01 ppm, about 0.01 to about 0.05 ppm, about 0.05 to about 0.1 ppm, about 0.1 to about 0.5 ppm, about 0.5 to about 1 ppm, about 1 to about 5 ppm, about 5 to about 10 ppm, about 10 to about 50 ppm). The ester(s) can make up any suitable proportion of the overall VOC content. Any suitable number of esters can be used, for example, 1 to 5, 1 to 3, 3 to 5, at least 1, at least 2, at least 3, or at least 4 esters can be used. In some embodiments, a nut butter replica can include no esters.

Furans can provide flavors and/or aromas that are important to the general character of nut butter. Non-limiting examples of furans that may be used in nut butter replicas provided herein include 1-(2-furanyl)-ethanone, 2-(2-furanylmethyl)-5-methyl-furan, 2-(2-propenyl)-furan, 2-(methoxymethyl)-furan, 2,2′-methylenebis-furan, 2,5-dimethyl-furan, 2-[(methylthio)methyl]-furan, 2-acetyl-5-methylfuran, 2-ethylfuran, 2-furfuryl acetate, 2-methyl-furan, 2-pentylfuran, 2-vinylfuran, 3-furanmethanol, 3-methyl-furan, 5-methylfurfural, difurfuryl ether, furan, furaneol, furfural, furfuryl alcohol, furfuryl propionate, and mixtures thereof. In some embodiments, a nut butter replica can include one or more (e.g., at least 2, 3, 4, 5, 6, 7, 8, 9, or 10) furans selected from the group consisting of 2-acetyl-5-methylfuran, 2-ethylfuran, 2-furfuryl acetate, 2-pentylfuran, 5-methylfurfural, difurfuryl ether, furaneol, furfural, furfuryl alcohol, and furfuryl propionate. In some embodiments, a nut butter replica can include one or more (e.g., at least 2, 3, 4, 5, or 6) furan selected from the group consisting of 2-methyl furan, 2-pentylfuran, 2-acetyl-5-methylfuran, 5-methylfurfural, difurfuryl ether, furaneol, furfural, and furfuryl alcohol. The furan(s) can be present in any suitable amount. In some embodiments, the furan(s) can be present in an amount of about 0.05 to about 5 ppm (e.g., about 0.05 to about 1.0 ppm, about 1.0 to about 2.0 ppm, about 2.0 to about 3.0 ppm, about 3.0 to about 4.0 ppm, or about 4.0 to about 5.0 ppm). The furan(s) can make up any suitable proportion of the overall VOC content. Any suitable number of furans can be used, for example, 1 to 12, 1 to 10, 1 to 5, 1 to 3, 3 to 12, 3 to 10, 3 to 5, 5 to 12, 5 to 10, 10 to 12, at least 1, at least 2, at least 3, at least 4, at least 5, at least 6, at least 7, at least 8, at least 9, or at least 10 furans can be used. In some embodiments, a nut butter replica can include no furans. In some embodiments, a nut butter replica as provided herein can include 2-ethyl furan, and/or 1-(2-furanyl)-ethanone.

Thiophenes can provide flavors and/or aromas that are important to the general character of nut butter. A non-limiting examples of a thiophene that may be used in nut butter replicas provided herein is thiophene. The thiophene(s) can be present in any suitable amount. The thiophene(s) can make up any suitable proportion of the overall VOC content. Any suitable number of thiophenes can be used, for example, at least one thiophene can be used. In some embodiments, a nut butter replica can include no thiophenes.

Pyrroles can provide flavors and/or aromas that are important to the general character of nut butter. Non-limiting examples of pyrroles that may be used in nut butter replicas provided herein include 1-(1H-pyrrol-2-yl)-ethanone, 1-(2-furanylmethyl)-1H-pyrrole, 1-ethyl-1H-pyrrole, 1-methyl-1H-pyrrole, 1-methyl-1H-pyrrole-2-carboxaldehyde, 2-acetyl-1-methylpyrrole, 2-acetylpyrrole, indole, pyrrole, and mixtures thereof. In some embodiments, a nut butter replica can include one or more (e.g., 2 or 3) pyrroles selected from the group consisting of 2-acetyl-1-methylpyrrole, 2-acetylpyrrole, and pyrrole. In some embodiments, a nut butter replica can include pyrrole. The pyrrole(s) can be present in any suitable amount. In some embodiments, the pyrrole(s) can be present in an amount of about 0.0001 to about 3 ppm (e.g., about 0.0001 to about 0.0005 ppm, about 0.0005 to about 0.001 ppm, about 0.001 to about 0.01 ppm, about 0.01 to about 0.05 ppm, about 0.05 to about 0.1 ppm, about 0.1 to about 0.5 ppm, about 0.5 to about 1 ppm, about 1 to about 2 ppm, about 2 to about 3 ppm, or about 1 to about 3 ppm). The pyrrole(s) can make up any suitable proportion of the overall VOC content. Any suitable number of pyrroles can be used, for example, 1 to 6, 1 to 5, 1 to 3, 3 to 6, 3 to 5, at least 1, at least 2, at least 3, at least 4, or at least 5 pyrroles can be used. In some embodiments, a nut butter replica can include no pyrroles. In some embodiments, a nut butter replica as provided herein can include indole.

Oxazoles can provide flavors and/or aromas that are important to the general character of nut butter. The oxazole(s) can be present in any suitable amount. The oxazole(s) can make up any suitable proportion of the overall VOC content. Any suitable number of oxazoles can be used. In some embodiments, a nut butter replica can include no oxazoles.

Thiazoles can provide flavors and/or aromas that are important to the general character of nut butter. The thiazole(s) can be present in any suitable amount. The thiazole(s) can make up any suitable proportion of the overall VOC content. Any suitable number of thiazoles can be used. In some embodiments, a nut butter replica can include no thiazoles.

Pyridines can provide flavors and/or aromas that are important to the general character of nut butter. Non-limiting examples of pyridines that may be used in nut butter replicas provided herein include 1-methyl-1,2,3,6-tetrahydropyridine, 1-methyl-piperidine, 2-acetylpyridine, 2-methyl-pyridine, 3-ethylpyridine, 3-ethyl-pyridine, 3-methyl-pyridine, 3-propyl-pyridine, 3-pyridinol, methyl nicotinate, and mixtures thereof. In some embodiments, a nut butter replica can include at least one (e.g., 2 or 3) pyridines selected from the group consisting of 2-acetylpyridine, 3-ethylpyridine, and methyl nicotinate. In some embodiments, a nut butter replica can include no 1-methyl-1,2,3,6-tetrahydropyridine. The pyridine(s) can be present in any suitable amount. In some embodiments, the pyridine(s) can be present in an amount of about 0.08 to about 0.2 ppm (e.g., about 0.08 to about 0.1 ppm or about 0.1 to about 0.2 ppm). The pyridine(s) can make up any suitable proportion of the overall VOC content. Any suitable number of pyridines can be used, for example, 1 to 8, 1 to 5, 1 to 3, 3 to 8, 3 to 5, 5 to 8, at least 1, at least 2, at least 3, at least 4, or at least 6 pyridines can be used. In some embodiments a nut butter replica can include no pyridines. In some embodiments, a nut butter replica as provided herein can include 2-acetylpyridine.

Pyrazines can provide flavors and/or aromas that are important to the general character of nut butter. Non-limiting examples of pyrazines that may be used in nut butter replicas provided herein include 2-(n-propyl)-pyrazine, 2,3-diethyl-5-methylpyrazine, 2,3-diethylpyrazine, 2,5-dimethylpyrazine, 2,5-dimethyl-pyrazine, 2,6-diethyl-pyrazine, 2,6-dimethylpyrazine, 2,6-dimethyl-pyrazine, 2-ethoxy-3-methylpyrazine, 2-ethyl-3-methyl-pyrazine, 2-ethyl-6-methyl-pyrazine, 2-ethylpyrazine, 2-isobutyl-3-methoxypyrazine (IBMP), 2-isobutyl-3-methyl pyrazine, 2-isopropyl-3-methoxypyrazine, 2-methylpyrazine, 3,5-diethyl-2-methyl-pyrazine, 3-ethyl-2,5-dimethyl-pyrazine, ethyl-pyrazine, isopropenyl pyrazine, methyl-pyrazine, pyrazine, 3-ethyl-3,6-dimethyl-2h-pyrazine, and mixtures thereof. In some embodiments, a nut butter replica can include one or more (e.g., at least 2, 3, 4, 5, 7, 9, or 11) pyrazines selected from the group consisting of 2,6-dimethylpyrazine, isopropenyl pyrazine, 2,3,5-trimethylpyrazine, 2,3-dimethylpyrazine, 2-Ethyl-3-methylpyrazine, 2-methylpyrazine, 2-ethylpyrazine, 2-isobutyl-3-methoxypyrazine, 2,3-diethyl-5-methylpyrazine, 2-ethoxy-3-methylpyrazine, 2,3-dimethylpyrazine, 2,3-diethylpyrazine, 2-methylpyrazine, 2,5-dimethylpyrazine, 2-methoxypyrazine, and 2-isopropyl-3-methoxypyrazine. In some embodiments, a nut butter replica can include one or more (e.g., at least 2, 3, 4, 5, 6, 7, 8, or 9) pyrazine selected from the group consisting of 2,6-dimethylpyrazine, isopropenyl pyrazine, 2,3,5-trimethylpyrazine, 2,3-dimethylpyrazine, 2-Ethyl-3-methylpyrazine, 2-methylpyrazine, and 2-ethylpyrazine. The pyrazine(s) can be present in any suitable amount. The pyrazine(s) can make up any suitable proportion of the overall VOC content. In some embodiments, the pyrazine(s) can be present in an amount of about 0.01 to about 7.0 ppm (e.g., about 0.01 to about 1.0 ppm, about 1.0 to about 2.0 ppm, about 2.0 to about 3.0 ppm, about 3.0 to about 4.0 ppm, about 4.0 to about 5.0 ppm, about 5.0 to about 6.0 ppm, or about 6.0 to about 7.0 ppm). Any suitable number of pyrazines can be used, for example, 1 to 12, 1 to 10, 1 to 5, 1 to 3, 3 to 12, 3 to 10, 3 to 5, 5 to 12, 5 to 10, 10 to 12, at least 1, at least 2, at least 3, at least 4, at least 5, at least 6, at least 7, at least 8, at least 9, or at least 10 pyrazines can be used. In some embodiments, nut butter replicas as described herein can have a greater amount (e.g., in a nut butter replica, in ppm) (e.g., at least 1.5-fold, at least 2-fold, at least 2.5-fold, at least 3-fold, at least 4-fold, at least 5-fold, at least 8-fold, at least 10-fold, at least 15-fold, or at least 20-fold) of pyrazines than a corresponding traditional nut butter product. In some embodiments, a nut butter replica can include no pyrazines. In some embodiments, a nut butter replica as provided herein can include one or more (e.g., at least 1, 2, 3, 4, 5, or 6) pyrazines selected from the group consisting of 2,3,5-trimethylpyrazine, 2,3-diethylpyrazine, 2,3-diethyl-5-methylpyrazine, 2,5-dimethylpyrazine, 2,6-dimethylpyrazine, 2,3-dimethylpyrazine, 2-ethyl-3-methylpyrazine, 2-ethylpyrazine, 2-methylpyrazine, isopropenyl pyrazine, tetramethylpyrazine, 2-methoxy-3(5 and 6)-isopropylpyrazine, 2-ethoxy-3-methylpyrazine, 2-ethyl-6-methylpyrazine, and 3-ethyl-3,6-dimethyl-2h-pyrazine.

Amines can provide flavors and/or aromas that are important to the general character of nut butter. Non-limiting examples of amines that may be used in nut butter replicas provided herein include 2-amino-1-naphthalenol, 2-methoxy-benzenamine, 5-amino-1-naphthol, N,N-dimethyl-ethanamine, and N,N-dimethyl-methylamine, and mixtures thereof. The amine(s) can be present in any suitable amount. The amine(s) can make up any suitable proportion of the overall VOC content. Any suitable number of amines can be used, for example, 1 to 2, at least 1, or at least 2 amines can be used. In some embodiments, a nut butter replica can include no amines.

Sulfur compounds (e.g., alkyl sulfides) can provide flavors and/or aromas that are important to the general character of nut butter. Non-limiting examples of sulfur compounds that may be used in nut butter replicas provided are diethyl disulfide, dimethyl disulfide, dimethyl sulfide, methyl sulfide, dimethyl sulfoxide, dimethyl trisulfide, methanethiol, and methional, and mixtures thereof. In some embodiments, a nut butter replica can include one or more (e.g., at least 2, 3, 4, 5, or 6) sulfur compounds selected from the group consisting of diethyl disulfide, dimethyl sulfide, methyl sulfide, dimethyl sulfoxide, dimethyl trisulfide, methanethiol, s-methyl 3-methylbutanethioate, furfuryl mercaptan, and methional. In some embodiments, a nut butter replica can include one or both of dimethyl trisulfide and methanethiol. The sulfur compound(s) can be present in any suitable amount. In some embodiments, the sulfur compound(s) can be present in an amount of about 0.0000007 to about 0.03 ppm (e.g., about 0.0000007 to about 0.000001 ppm, about 0.000001 to about 0.000005 ppm, about 0.000005 to about 0.00001 ppm, about 0.00001 to about 0.00005 ppm, about 0.00005 to about 0.0001 ppm, about 0.0001 to about 0.0005 ppm, about 0.0005 to about 0.001 ppm, about 0.001 to about 0.005 ppm, about 0.005 to about 0.01 ppm, or about 0.01 to about 0.03 ppm). The sulfur compound(s) can make up any suitable proportion of the overall VOC content. Any suitable number of sulfur compounds can be used, for example, at least 1 sulfur compound can be used. In some embodiments, a nut butter replica can include no sulfur compounds. In some embodiments, a nut butter replica as provided herein can include one or more (e.g., at least 1, 2, 3, or 4) sulfur compounds selected from the group consisting of dimethyl trisulfide, methyl sulfide, s-methyl 3-methylbutanethioate, and/or furfuryl mercaptan.

Sugars and sugar alcohols can provide flavors and/or aromas that are important to the general character of nut butter. Non-limiting examples of a sugars or sugar alcohols that may be used in nut butter replicas provided are ethyl maltol, maltol, and mixtures thereof. In some embodiments, a nut butter replica can include one or both of ethyl maltol and maltol. The sugar or sugar alcohol(s) can be present in any suitable amount. In some embodiments, the sugar or sugar alcohol(s) can be present in an amount of about 1.0 to about 3.0 ppm (e.g., about 1.0 to about 2.0 ppm, about 2.0 to about 3.0 ppm). The sugar or sugar alcohol(s) can make up any suitable proportion of the overall VOC content. Any suitable number of sugar or sugar alcohols can be used, for example, at least 1 sugar or sugar alcohol can be used. In some embodiments, a nut butter replica can include no sugar or sugar alcohols.

Other VOCs not belonging to the classes above can provide flavors and/or aromas that are important to the general character of nut butter. A non-limiting example of an other VOCs that may be used in nut butter replicas provided herein is methyl mercapten. The other VOC(s) can be present in any suitable amount. The other VOC(s) can make up any suitable proportion of the overall VOC content. Any suitable number of other VOCs can be used, for example, at least 1 other VOC can be used.

In some cases, the total amount (e.g., in ppm of a nut butter replica) of VOCs in a nut butter replica can be greater than the total amount of VOCs in a reference nut butter.

Further, the amount of any particular VOC in a nut butter replica may be different than the amount of that VOC in a corresponding reference nut butter. In some cases, the amount of a VOC in a nut butter replica can be 75% or less (e.g., 70% or less, 60% or less, 50% or less, 40% or less, 30% or less, 20% or less, or 10% or less), by concentration or percent mass, than the amount of the same VOC in a corresponding reference nut butter. In some cases, the amount of a VOC in a nut butter replica can be 125% or more (e.g., 150% or more, 200% or more, or 300% or more), by concentration or percent mass, than the amount of the same VOC in a corresponding reference nut butter.

A nut butter replica can include any appropriate number of VOCs. For example, a nut butter replica can include 1 to 100 (e.g., at least 5, at least 10, at least 20, at least 30, at least 40, at least 50, 1 to 90, 1 to 80, 1 to 70, 1 to 60, 1 to 50, 1 to 40, 1 to 30, 1 to 20, 1 to 10, 1 to 5, 5 to 100, 5 to 90, 5 to 80, 5 to 70, 5 to 60, 5 to 40, 5 to 30, 5 to 20, 5 to 0, 10 to 100, 10 to 90, 10 to 90, 10 to 70, 10 to 60, 10 to 50, 10 to 40, 10 to 30, 10 to 20, 20 to 100, 20 to 90, 20 to 80, 20 to 70, 20 to 60, 20 to 50, 20 to 40, 20 to 30, 30 to 100, 30 to 90, 30 to 80, 30 to 70, 30 to 60, 30 to 50, 30 to 40, 40 to 100, 40 to 90, 40 to 80, 40 to 70, 40 to 60, 40 to 50, 50 to 100, 50 to 90, 50 to 80, 50 to 70, or 50 to 60) VOCs. In some cases, the number of VOCs in nut butter replica can be less than the number of VOCs in a single reference nut butter.

In some cases, the overall population of VOCs in a nut butter can have less than 95% identity to the VOCs in a corresponding reference nut butter (e.g., from a single region, in a single variety, cultivar, species of plant, batch conditions (e.g., a degree of roast and/or roast conditions), or packaging unit (e.g., a bag)). For example, the VOCs in a nut butter replica can have less than 95%, less than 90%, less than 85%, less than 80%, less than 70%, less than 60%, less than 50%, or less than 40% identity to the population of VOCs in a corresponding reference nut butter. Some nut butter replicas may contain at least 10 (e.g., at least 15, at least 20, at least 25, at least 30, at least 35, at least 40, at least 45, or at least 50) VOCs that are not found in a single reference nut butter. Moreover, some nut butter replicas may contain no more than 55 (e.g., no more than 54, 53, 52, 51, 50, 45, 40, 35, 30, 25, 20, 15, or 10) VOCs that are present in a single reference nut butter. For example, in some embodiments, a nut butter replica can have at least n VOCs and wherein less than n (e.g., n−1, n−2, n−3, n−4, n−5, n−6, n−7, n−8, n−9, n−10, n−15, n−20, and the like, as applicable) of the VOCs are found in a single reference nut butter; in some embodiments, n can be equal to 5, 6, 7, 8, 9, 10, 11, 12, 13, 14, 15, 16, 17, 18, 19, 20, 25, 30, 35, 40, 41, 42, 43, 44, 45, 50, or 55.

In some embodiments, the amount of a particular VOC in a nut butter replica can be an amount, based on concentration or percent composition that is within a range 30% higher and lower than the amount disclosed for that VOC. For example, a VOC can be present in a nut butter replica in an amount that is 70 to 90%, 80 to 100%, 90 to 110%, 100 to 120%, 110 to 130%, 70 to 100%, 80 to 110%, 90 to 120%, or 100 to 130% of an amount for that VOC as disclosed herein.

In some embodiments, a nut butter replica can exclude one or more isolated VOCs.

In some cases, the total amount of VOCs in a nut butter replica can be greater than the total amount of VOCs in a reference nut butter. For example, a nut butter replica can have a total VOC content that is at least 100 ppm or more (e.g., 150, 200, 250, 300, 350, 400, 450, 500, 550, 600, 650, 700, 750, 800, 850, 900, 950, 1000 ppm, or more). In some embodiments, a nut butter replica can have a total VOC content from the VOCs in Group A that is at least 100 ppm or more (e.g., 150, 200, 250, 300, 350, 400, 450, 500, 550, 600, 650, 700, 750, 800, 850, 900, 950, 1000 ppm, or more). In some embodiments, a nut butter replica can have a total VOC content from the VOCs in Group B that is at least 100 ppm or more (e.g., 150, 200, 250, 300, 350, 400, 450, 500, 550, 600, 650, 700, 750, 800, 850, 900, 950, 1000 ppm, or more). In some embodiments, a nut butter replica can have a total VOC content from the VOCs in Group C that is at least 100 ppm or more (e.g., 150, 200, 250, 300, 350, 400, 450, 500, 550, 600, 650, 700, 750, 800, 850, 900, 950, 1000 ppm, or more).

### Non-Volatile Compounds

The nut butter replicas described herein can, in some cases, include at least one non-volatile compound that is not present in a corresponding reference nut butter. Non-limiting examples of non-volatile compounds that may not be present in a corresponding reference nut butter include acetovanillone, adipic acid, AMP, arginine, carnosine, cinnamic acid, citrulline, CMP, coumaric acid, cysteine, cystine, epicatechin, epicatechin gallate, GABA, glucosamine, glutamine, guanine, hesperetin, histidine, isoleucine, kynurenic acid, leucine, lysine, mannose, methionine, methyl gallate, ornithine, pantothenic acid, pipecolinic acid, piperine, polydatin, pyridoxine, quercetin, resveratrol, rutin, sinapinic acid, sorbic acid, syringaldehyde, threonine, trans-4-hydroxyproline, tryptophan, tyramine, tyrosine, and mixtures thereof. Therefore, in some embodiments, a nut butter replica can include one or more (e.g., at least 2, 3, 4, 5, 10, 15, 20, 25, 30, 35, or 40) compounds selected from the group consisting of pyridine, pyridoxine, 2(5H)-furanone, orientin, isoprenylpyrazine, 2-isopropyl-3-methoxypyrazine, 2-isobutyl-3-methoxypyrazine, adipic acid, methyl gallate, rutin, trans-ferulic acid, sinapinic acid, resveratrol, ellagic acid, propyl gallate, salicylic acid, AMP, hydroxymethylfurfural, caffeic acid, epicatechin gallate, syringic acid, homofuraneol, syringaldehyde, coumaric acid, acetovanillone, cinnamic acid, polydatin, cytosine, CMP, guanine, 4-guanidinobutyric acid, uracil, tryptamine, maple furanone, acetanilide, sorbic acid, ornithine, trans-4-hydroxyproline, carnosine, kynurenic acid, ribose, xylose, fucose, galactose, mannose, D-glucuronic acid, pyruvic acid, tartaric acid, ricinoleic acid, DL-hydroxystearic acid, 8-hydroxyquinoline, quinoline, 5-methoxyresorcinol, chlorogenic acid, eugenyl acetate.

Nut butter replicas herein can, in some cases, exclude one or more isolated non-volatile compounds that are present in a corresponding reference nut butter. Non-limiting examples of compounds present in reference nut butters include 2(5H)-furanone, 2,3,5,6-tetramethylpyrazine, 2,3,5-trimethylpyrazine, 2,3-dimethylpyrazine, 2-ethyl-2-hydroxybutyric acid, 2-furoic acid, 2-isopropylmalic acid, 3,4-dihydroxybenzoic acid, 4-methoxycinnamic acid, 5-ethyl-4-hydroxy-2-methyl-3(2H)-furanone, adenine, arabitol, betaine, caffeic acid, caffeine, choline, citric acid, cytidine, D-gluconic acid, D-glucuronic acid, fructose, galactose, glucose, glutamic acid, hydroxymethylfurfural, lactic acid, malic acid, mannitol, methyl-2-pyrrolyl ketone, inositol, pyruvic acid, quinic acid, sorbitol, sotolon, succinic acid, syringic acid, tartaric acid, tryptamine, uracil, vanillic acid, and combinations thereof. Therefore, in some embodiments, a nut butter replica can lack one or more (e.g., at least 2, 3, 4, 5, 10, 15, 20, 25, 30, 35, or 40) compounds selected from the group consisting of choline, caffeine, 2,3,5,6-tetramethylpyrazine, quercetin, luteolin, phenylalanine, arginine, asparagine, glutamic acid, homoserine, and cholic acid. In some embodiments, a nut butter replica can lack one or more (e.g., 2, 3, 4, 5) compounds selected from the group consisting of choline, caffeine, quercetin, luteolin, phenylalanine, arginine, asparagine, glutamic acid, homoserine, and cholic acid.

The non-volatile compounds present in a nut butter replica can include compounds that fall into a first set of categories, including acids; amino acids or derivatives thereof; sugars or sugar alcohols; xanthines (e.g., caffeine, or theobromine); fats or waxes; starches, fiber, gums, or polysaccharides; tannins, polyphenols, or anthocyanins; pH modifiers; salts; bitterants; coloring agents; surfactants or emulsifiers; minerals or metals; preservatives (e.g., sodium benzoate), antioxidants; or proteins or peptides. In some embodiments, a nut butter replica can include an acid, an amino acid or derivative thereof, a sugar or sugar alcohol, a tannin, polyphenol, or anthocyanin, and a protein or peptide.

The non-volatile compounds present in a nut butter replica can include compounds that fall into a second set of categories, including acids; aldehydes; alkaloids; amines; amino acids; furans; ketones; lactones; nucleotides, nucleotide monophosphates, or nucleobases; proteins or peptides; pyrazines; pyridines; sugars or sugar alcohols; tannins; phenols, polyphenols, or anthocyanins; or xanthines. In some embodiments, a nut butter replica can include one or more of: an acid, an aldehyde, an alkaloid, an amine, an amino acid, a furan, a ketone, a lactone, a nucleotide, a nucleotide monophosphate, or nucleobase, a protein or peptide, a pyrazine, a pyridine, a sugar or sugar alcohol, a tannin, phenol, polyphenol, or anthocyanin, a xanthine, or a combination thereof. In some embodiments, a nut butter replica can include at least one non-volatile compound that belongs to each of at least 3 (e.g., at least 4, at least 5, at least 5, at least 7, at least 8, at least 9, at least 10, at least 15, 3 to 15, 3 to 10, 3 to 5, 5 to 14, 5 to 10, 10 to 15, or 10 to 16) of the following categories: an acid, an aldehyde, an alkaloid, an amine, an amino acid, a furan, a ketone, a lactone, a nucleotide, a nucleotide monophosphate, or nucleobase, a protein or peptide, a pyrazine, a pyridine, a sugar or sugar alcohol, a tannin, phenol, polyphenol, or anthocyanin, or a xanthine. In some embodiments, a nut butter replica can include an acid, an aldehyde, an amino acid, a lactone, a pyrazine, a tannin, phenol, polyphenol, or anthocyanin, and a xanthine.

It will be appreciated that any of these components can be provided in any appropriate form. For example, it will be appreciated that amino acids can be provided in the form of a salt (e.g., an HCl salt). It will also be appreciated that any and all stereoisomers can be used when no stereochemistry is specified.

In some embodiments, a nut butter replica (e.g., a nut butter beverage replica) can include no preservatives.

Amino acids (e.g., including derivatives thereof) that may be present in a nut butter replica as provided herein include, without limitation, phenylalanine, leucine, glucosamine, Methionine, GABA, Tyrosine, lysine, Histidine, glycine, serine, Aspartic Acid, isoleucine, tryptophan, valine, proline, Carnitine, arginine, B-alanine-2, Threonine, Glutamine, asparagine, Glutamic Acid, Betaine, Pipecolinic Acid, Citrulline, carnosine, homoserine, and any combination thereof. In some embodiments, a nut butter replica can include one or more (e.g., 2, 3, 4, 5, 10, 15, 20, or 25) amino acids selected from the group consisting of phenylalanine, leucine, glucosamine, methionine, GABA, tyrosine, lysine, histidine, glycine, serine, aspartic acid, isoleucine, tryptophan, valine, proline, carnitine, arginine, B-alanine-2, threonine, glutamine, asparagine, glutamic acid, betaine, pipecolinic acid, citrulline, carnosine, and homoserine. The amino acid(s) can be present in any suitable amount. In some embodiments, the amino acid(s) can be present in an amount of about 2 to about 1000 ppm (e.g., about 2 to about 10 ppm, about 10 to about 100 ppm, about 100 to about 200 ppm, about 200 to about 300 ppm, about 300 to about 400 ppm, about 400 to about 500 ppm, about 500 to about 600 ppm, or about 600 to about 1000 ppm). The amino acid(s) can make up any suitable proportion of the overall non-volatile compound content. In some embodiments, a nut butter replica can include no amino acids. In some embodiments, an amino acid can be provided as the L-stereoisomer.

Examples of acids that can be included in a nut butter replica include, without limitation, Adipic Acid, Trans-Ferulic Acid, Sinapinic Acid, Salicylic Acid, Pantothenic Acid, Caffeic Acid, Vanillic Acid, Syringic Acid, Coumaric Acid, Sorbic Acid, Kynurenic Acid, D-Glucuronic Acid, Quinic Acid, Malic Acid, Pyruvic Acid, Tartaric Acid, lactic Acid, Citric Acid, Fumaric Acid, Succinic Acid, Gallic Acid, 2-Furoic Acid, 3,4-dihydroxybenzoic Acid, 2-Isopropylmalic Acid, D-Gluconic Acid, 4-methoxycinnamic acid, 2-ethyl-2-hydroxybutyric acid, Ricinoleic Acid, DL-hydroxystearic acid, Nicotinic Acid, Chlorogenic Acid, Cholic Acid, and any combination thereof. In some embodiments, a nut butter replica can include one or more (e.g., at least 2, 3, 4, 5, 10, 15, or 20) acids selected from the group consisting of adipic acid, trans-ferulic acid, sinapinic acid, salicylic acid, pantothenic acid, caffeic acid, vanillic acid, syringic acid, coumaric acid, sorbic acid, kynurenic acid, D-glucuronic acid, quinic acid, malic acid, pyruvic acid, tartaric acid, lactic acid, citric acid, fumaric acid, succinic acid, gallic acid, 2-furoic acid, 3,4-dihydroxybenzoic acid, 2-isopropylmalic acid, D-gluconic acid, 4-methoxycinnamic acid, 2-ethyl-2-hydroxybutyric acid, ricinoleic acid, DL-hydroxystearic acid, nicotinic acid, chlorogenic acid, and cholic acid. In some embodiments, a nut butter replica can include one or more (e.g., 2 or 3) acids selected from the group consisting of D-glucuronic acid, citric acid, lactic acid, tartaric acid, fumaric acid, malic acid, and succinic acid. The acid(s) can be present in any suitable amount. In some embodiments, the acid(s) can be present in an amount of about 3 ppm to about 5.0 g/L (e.g., about 3 to about 10 ppm, about 10 to about 50 ppm, about 50 to about 100 ppm, about 100 to about 500 ppm, about 500 ppm to about 1 g/L, about 1 g/L to about 2.5 g/L, or about 2.5 g/L to about 5.0 g/L). The acid(s) can make up any suitable proportion of the overall non-volatile compound content. Any suitable number of acids can be used, for example, 1 to 3, at least 2, or at least 3 acids can be used. In some embodiments, a nut butter replica can include no acids.

Examples of alkaloids that can be used in a nut butter replica include, without limitation, piperine. The alkaloid(s) can be present in any suitable amount. The alkaloid(s) can make up any suitable proportion of the non-volatile compound content. Any suitable number of alkaloids can be used. In some embodiments, a nut butter replica can include no alkaloids.

Examples of amines that can be used in a nut butter replica include, without limitation, tryptamine. The amine(s) can be present in any suitable amount. In some embodiments, the amine(s) can be present in an amount of about 0.05 to about 0.2 ppm (e.g., about 0.05 to about 0.1 ppm or 0.1 to about 0.2 ppm). The amine(s) can make up any suitable proportion of the non-volatile compound content. Any suitable number of amines can be used. In some embodiments, a nut butter replica can include no amines.

Examples of furans that can be used in a nut butter replica include, without limitation, hydroxymethylfurfural. The furan(s) can be present in any suitable amount. In some embodiments, the furan(s) can be present in an amount of about 10 to about 20 ppm (e.g., about 10 to about 15 ppm or about 15 to about 20 ppm). The furan(s) can make up any suitable proportion of the non-volatile compound content. Any suitable number of furans can be used. In some embodiments, a nut butter replica can include no furans.

Examples of nucleotides, nucleotide monophosphates, or nucleobases that can be used in a nut butter replica include, without limitation, adenine, AMP, CMP, cytidine, cytosine, guanine, and uracil. In some embodiments, a nut butter replica can include one or more (e.g., 2, 3, 4, 5, 6, or 7) nucleotide, nucleotide monophosphate, or nucleobase selected from the group consisting of adenine, AMP, CMP, cytidine, cytosine, guanine, and uracil. The nucleotides, nucleotide monophosphates, or nucleobase(s) can be present in any suitable amount. In some embodiments, the nucleotides, nucleotide monophosphates, or nucleobase(s) can be present in an amount of about 0.7 to about 5 ppm (e.g., about 0.7 to about 1 ppm, about 1 to about 5 ppm, about 1 to about 3 ppm, or about 3 to about 5 ppm). The nucleotides, nucleotide monophosphates, or nucleobase(s) can make up any suitable proportion of the non-volatile compound content. Any suitable number of nucleotides, nucleotide monophosphates, or nucleobases can be used. In some embodiments, a nut butter replica can include no nucleotides, nucleotide monophosphates, or nucleobases.

Examples of pyridines that can be used in a nut butter replica include, without limitation, pyridine and pyroxidine. In some embodiments, a nut butter replica can include pyridine, pyroxidine, or both. The pyridine(s) can be present in any suitable amount. In some embodiments, the pyridine(s) can be present in an amount of about 0.4 to about 150 ppm (e.g., about 0.4 to about 1 ppm, about 0.5 to about 1 ppm, about 1 to about 5 ppm, about 5 to about 10 ppm, about 10 to about 50 ppm, about 10 to about 60 ppm, about 10 to about 30 ppm, about 30 to about 50 ppm, about 20 to about 40 ppm, or about 40 to about 150 ppm). The pyridine(s) can make up any suitable proportion of the non-volatile compound content. Any suitable number of pyridines can be used. In some embodiments, a nut butter replica can include no pyridines.

Examples of sugars or sugar alcohols that can be used in a nut butter replica include, without limitation, sucrose arabitol, fructose, galactose, glucosamine, glucose, mannitol, mannose, inositol (e.g., myo-inositol), rhamnose, ribose, sorbitol, xylose, and any combination thereof. In some embodiments, a nut butter replica can include one or more (e.g., at least 2, 3, 4, 5, 6, 8, 10, or 12) sugars or sugar alcohols selected from the group consisting of sucrose, arabitol, fructose, galactose, glucosamine, glucose, mannitol, mannose, inositol, rhamnose, ribose, sorbitol, and xylose. The sugars or sugar alcohol(s) can be present in any suitable amount. In some embodiments, the sugars or sugar alcohol(s) can be present in an amount of about 50 to about 550 ppm (e.g., about 50 to about 100 ppm, about 100 to about 500 ppm, about 100 to about 550 ppm, about 100 to about 300 ppm, about 300 to about 500 ppm, about 300 to about 550 ppm, or about 200 to about 400 ppm). The sugars or sugar alcohol(s) can make up any suitable proportion of the non-volatile compound content. Any suitable number of sugars or sugar alcohols can be used. In some embodiments, a nut butter replica can include no sugars or sugar alcohols.

Examples of sugars that can be used in a nut butter replica include, without limitation, fructose, galactose, glucosamine, glucose, mannose, rhamnose, ribose, xylose, and any combination thereof.

Sugar alcohols that can be present in a nut butter replica include, without limitation, arabitol, inositol (e.g., myo-inositol), mannitol, sorbitol, and any combination thereof.

Examples of tannins, phenols, polyphenols, or anthocyanins that can be used in a nut butter replica include, without limitation, catechin, ellagic acid, epicatechin, epicatechin gallate, gallic acid, hesperetin, methyl gallate, polydatin, propyl gallate, quercetin, resveratrol, rutin, salicylic acid, sinapinic acid, syringaldehyde, syringic acid, trans-ferulic acid, tyramine, and vanillic acid. In some embodiments, the nut butter replica can include one or more (e.g., 2, 3, 4, 5, 6, 8, 10, 12, 14, 16, or 18) tannins, phenols, polyphenols, or anthocyanins selected from the group consisting of catechin, ellagic acid, epicatechin, epicatechin gallate, gallic acid, hesperetin, methyl gallate, polydatin, propyl gallate, quercetin, resveratrol, rutin, salicylic acid, sinapinic acid, syringaldehyde, syringic acid, trans-ferulic acid, tyramine, and vanillic acid. In some embodiments, the nut butter replica can include trans-ferulic acid, vanillic acid, or both. The tannins, phenols, polyphenols, or anthocyanin(s) can be present in any suitable amount. In some embodiments, the tannins, phenols, polyphenols, or anthocyanin(s) can be present in an amount of about 15 to about 55 ppm (e.g., about 15 to about 20 ppm, about 15 to about 25 ppm, about 25 to about 50 ppm, about 25 to about 55 ppm, about 20 to about 40 ppm, about 30 to about 50 ppm, or about 30 to about 55 ppm). The tannins, phenols, polyphenols, or anthocyanin(s) can make up any suitable proportion of the non-volatile compound content. Any suitable number of tannins, phenols, polyphenols, or anthocyanins can be used. In some embodiments, a nut butter replica can include no tannins, phenols, polyphenols, or anthocyanins.

Examples of xanthines that can be used in a nut butter replica include, without limitation, caffeine. The xanthine(s) can be present in any suitable amount. In some embodiments, the xanthine(s) can be present in an amount of about 100 to about 300 ppm (e.g., about 100 to about 200 ppm, about 150 to about 250 ppm, or about 200 to about 300 ppm). The xanthine(s) can make up any suitable proportion of the non-volatile compound content. Any suitable number of xanthines can be used. In some embodiments, a nut butter replica can include no xanthines.

Colorants that may be used in the nut butter replicas provided herein include, without limitation, natural colorants derived from fruits and vegetables such as beet, carrot, and cabbage [e.g., annatto extract, beet extract, beta carotene, caramel, carmine (cochineal extract), elderberry extract, grapeskin extract (enocianina), paprika, saffron, titanium dioxide, and turmeric], as well as synthetic dyes (e.g., FD+C/synthetic colors).

In some cases, the amount of any particular non-volatile compound in a nut butter replica may be different than the amount of that non-volatile compound in a corresponding reference nut butter. In some cases, the amount of a non-volatile compound in a nut butter replica can be 75% or less (e.g., 70% or less, 60% or less, 50% or less, 40% or less, 30% or less, 20% or less, or 10% or less), by concentration or percent mass, than the amount of the same non-volatile compound in a corresponding reference nut butter. In some cases, the amount of a non-volatile compound in a nut butter replica can be 125% or more (e.g., 150% or more, 200% or more, or 300% or more), by concentration or percent mass, than the amount of the same non-volatile compound in a corresponding reference nut butter.

In some cases, the total amount (e.g., in ppm of a nut butter replica) of non-volatile compounds in a nut butter replica can be less than the total amount of non-volatile compounds in a reference nut butter.

In some embodiments, non-volatile compounds can be placed in various groupings, and a nut butter replica can include certain non-volatile compounds according to their groupings.

A nut butter replica can include any appropriate number of non-volatile compounds. For example, a nut butter replica can include 1 to 100 (e.g., at least 5, at least 10, at least 20, at least 30, at least 40, at least 50, 1 to 90, 1 to 80, 1 to 70, 1 to 60, 1 to 50, 1 to 40, 1 to 30, 1 to 20, 1 to 10, 1 to 5, 5 to 100, 5 to 90, 5 to 80, 5 to 70, 5 to 60, 5 to 40, 5 to 30, 5 to 20, 5 to 10, 10 to 100, 10 to 90, 10 to 90, 10 to 70, 10 to 60, 10 to 50, 10 to 40, 10 to 30, 10 to 20, 20 to 100, 20 to 90, 20 to 80, 20 to 70, 20 to 60, 20 to 50, 20 to 40, 20 to 30, 30 to 100, 30 to 90, 30 to 80, 30 to 70, 30 to 60, 30 to 50, 30 to 40, 40 to 100, 40 to 90, 40 to 80, 40 to 70, 40 to 60, 40 to 50, 50 to 100, 50 to 90, 50 to 80, 50 to 70, or 50 to 60) non-volatile compounds. In some cases, the number of non-volatile compounds in a nut butter can be less than the number of non-volatile compounds in a single reference nut butter.

In some cases, the overall population of non-volatile compounds in a nut butter replica can have less than 95% identity to the non-volatile compounds in a corresponding reference nut butter (e.g., from a single region, in a single variety, cultivar, or packaging unit (e.g., a bag)). For example, the non-volatile compounds in a nut butter replica can have less than 95%, less than 90%, less than 85%, less than 80%, less than 70%, less than 60%, less than 50%, or less than 40% identity to the population of non-volatile compounds in a corresponding reference nut butter. Some nut butter replicas may contain at least 10 (e.g., at least 15, at least 20, at least 25, or at least 30) non-volatile compounds that are not found in a single reference nut butter. For example, in some embodiments, a nut butter replica can have at least m non-volatile compounds and less than m (e.g., m−1, m−2, m−3, m−4, m−5, m−6, m−7, m−8, m−9, m−10, m−15, m−20, and the like, as applicable) of the non-volatile compounds are found in a single reference nut butter; in some embodiments, m can be equal to 5, 6, 7, 8, 9, 10, 11, 12, 13, 14, 15, 16, 17, 18, 19, 20, 25, 30, 35, or 40.

Example 2 sets forth amounts of non-volatile compounds that were detected in traditional nut butter samples. In some embodiments, the amount of a particular non-volatile compound in a nut butter replica can be an amount, based on concentration or percent composition that is within a range 30% higher and lower than the amount disclosed for that non-volatile compound. For example, a non-volatile compound can be present in a nut butter replica in an amount that is 70 to 90%, 80 to 100%, 90 to 110%, 100 to 120%, 110 to 130%, 70 to 100%, 80 to 110%, 90 to 120%, or 100 to 130% of a disclosed amount for that non-volatile compound in a traditional nut butter.

In some embodiments, the non-volatile compounds can include one or more (e.g., 1 to 2, 1 to 3, 1 to 5, 1 to 10, 1 to 15, 1 to 20, 1 to 25, 1 to 28, 5 to 10, 10 to 15, 10 to 20, 15 to 20, 20 to 28, 20 to 25, or 25 to 28) of 2-furoic acid, 2-isopropylmalic acid, 3,4-dihydroxybenzoic acid, arabitol, aspartic acid, betaine, citric acid, D-glucuronic acid, fructose, galactose, gallic acid, glucose, glutamic acid, lactic acid, malic acid, mannitol, inositol, phenylalanine, pyruvic acid, quinic acid, sorbitol, succinic acid, tartaric acid, valine, ribose, rhamnose, and xylose.

In some cases, a nut butter replica can include a solid substrate. A solid substrate can be a food stream waste product. In some embodiments, a solid substrate can include processed or unprocessed grains. Processing of grains can result in the removal or partial removal of one or more of: starch, protein, sugar, fat-soluble components, and flavors. In some embodiments, a solid substrate can be any waste product where most of the starch, protein, sugar, fat-soluble components, and flavor is removed leaving behind cellulose, hemicellulose, lignin, and other insoluble fibers. In some embodiments, a solid substrate can include processed or unprocessed grains or grain products, legumes or legume seeds, oil plants or seeds, fruits or fruit products, roots, tubers, or root or tuber products, sugar processing by-products, or other plant by-products.

Non-limiting examples of grains or grain products that can be used in a solid substrate include atella, barley distillery by-products, broken rice or polished rice, barley grain, brown rice, white rice, rice starch, rice protein, wild rice, brewers grains, cockspur grass (Echinochloa crusgalli) grain, corn gluten feed, corn distillers grain, corn gluten meal, ear maize, finger millet (Eleusine coracana) grain, foxtail millet (Setaria italica) grain, fonio (Digitaria exilis) grain, maize bran or hominy feed, maize green forage, maize cobs, maize stover, maize germ meal or maize germ, malt culms, maize grain, millet hulls, oat hulls or oat mill feed, oats, pearl millet (Pennisetum glaucum) grain, proso millet (Panicum miliaceum) grain, quinoa (Chenopodium quinoa), red oat (Avena sativa) grain, rice protein concentrate, rice bran or other rice by-products, rough rice (paddy rice), rice hulls, rye grain or by-products, sorghum by-products, starches, sorghum grain, tef (Eragrostis tef) grain, triticale, Venezuela grass (Paspalum fasciculatum), wheat (general), wheat germ, wheat bran, wheat grain, wheat distillers grain, wheat shorts, wheat middlings, feed flour, and mixtures thereof.

Non-limiting examples of legumes or legume seeds that can be used in a solid substrate include african locust bean (Parkia biglobosa or Parkia filicoidea), African yam bean (Sphenostylis stenocarpa), bambara barnut (Vigna subterranea) crop residue and straw, black gram (Vigna mungo), bambara barnut (Vigna subterranea) pods, shells and offals, blue lupin (Lupinus angustifolius) seeds, bambara barnut (Vigna subterranea) seeds, butterfly pea (Clitoria ternatea), carob (Ceratonia siliqua), common bean (Phaseolus vulgaris), centro (Centrosema molle), common vetch (Vicia sativa), chickpea (Cicer arietinum), cowpea (Vigna unguiculata) seeds, faba bean (Vicia faba), grass pea (Lathyrus sativus), guar (Cyamopsis tetragonoloba) forage, seed and meal, guanacaste (Enterolobium cyclocarpum), hairy vetch (Vicia villosa), horse gram (Macrotyloma uniflorum), jack bean (Canavalia ensiformis), lablab (Lablab purpureus), lima bean (Phaseolus lunatus), lentil (Lens culinaris), mat bean (Vigna aconitifolia), mung bean (Vigna radiata), narbon vetch (Vicia narbonensis), pea by-products, peanut seeds, pea protein concentrate, peanut skins, pea seeds, pigeon pea (Cajanus cajan) seeds, peanut forage, prickly sesban (Sesbania bispinosa), peanut hulls, purple vetch (Vicia benghalensis), peanut meal, rain tree (Albizia saman), rice bean (Vigna umbellata), sesban (Sesbania sesban), soybean seeds, soybean (general), sword bean (Canavalia gladiata), soybean forage, syrian mesquite (Prosopis farcta), soybean meal, tamarind (Tamarindus indica), tamarugo (Prosopis tamarugo), velvet bean (Mucuna pruriens), white lupin (Lupinus albus) seeds, winged bean (Psophocarpus tetragonolobus), yellow lupin (Lupinus luteus) seeds, and mixtures thereof.

Non-limiting examples of oil plants or seeds than can be used in a solid substrate include Almond kernels and by-products, argan (Argania spinosa), babassu (Attalea speciosa), borneo tallow nut (Shorea stenoptera) oil meal, bactris (Bactris gasipaes), camelina (Camelina sativa) seeds and oil meal, cotton (general), cashew (Anacardium occidentale) nuts and by-products, castor (Ricinus communis) seeds, oil meal and by-products, cocoa butter, shea butter, shea kernel oil, cotton straw and cotton crop residues, ceylon ironwood (Mesua ferrea), cottonseed hulls, cottonseed meal, copra meal and coconut by-products, crambe (Crambe abyssinica), corozo (Attalea cohune) seed and oil meal, doum palm (Hyphaene thebaica), dragon's head (Lallemantia iberica), flax straw and flax crop by-products, grape seeds and grape seed oil meal, hemp, jatropha (Jatropha sp.) kernel meal and other jatropha products, jojoba (Simmondsia chinensis), kapok (Ceiba pentandra), kenaf (Hibiscus cannabinus), karanja (Millettia pinnata), kusum (Schleichera oleosa), linseed meal, luffa (Luffa aegyptiaca), linseeds, macadamia (Macadamia integrifolia), moringa (Moringa oleifera), mahua (Madhuca longifolia), mustard oil meal and mustard bran, maize germ meal and maize germ, neem (Azadirachta indica), niger (Guizotia abyssinica), oil palm fronds and oil palm crop residues, olive oil cake and by-products, oil palm kernels, palm kernel meal, peanut seeds, palm oil mill effluent, peanut skins, palm press fibre, pinto peanut (Arachis pintoi), peanut forage, poppy (Papaver somnferum), peanut hulls, pumpkin, squash, gourd and other Cucurbita species, peanut meal, rapeseed forage, rapeseed hulls, rapeseed meal, rapeseeds, rubber (Hevea brasiliensis), safflower (Carthamus tinctorius) seeds and oil meal, sal (Shorea robusta) seeds and oil meal, soybean meal, soybean seeds, seje (Oenocarpus bataua), sunflower (general) seeds and oil meal, sesame (Sesamum indicum) seeds and oil meal, sunflower forage and crop residues, sunflower hulls and sunflower screenings, sunflower meal, sunflower seeds, soybean (general), soybean forage, soybean hulls, tung tree (Aleurites fordii), tomato seed cake, walnut (Juglans regia), watermelon (Citrullus lanatus) seeds and oil meal, chia seed, sickle pods, and mixtures thereof.

Non-limiting examples of fruits or fruit products that can be used in a solid substrate include apple pomace and culled apples, banana (general), banana peels, banana fruits, banana leaves and pseudostems, breadfruit (Artocarpus altilis), breadnut (Brosimum alicastrum), cashew (Anacardium occidentale) nuts and by-products, citrus pulp, fresh, citrus fruits, citrus seed meal, citrus molasses, citrus pulp, dried, colocynth (Citrullus colocynthis), date molasses, date palm leaves and date pedicels, date palm fruits, grape pomace, guava (Psidium guajava), grape seeds and/or grape seed oil meal, jackfruit (Artocarpus heterophyllus), kokum (Garcinia indica), luffa (Luffa aegyptiaca), mango (Mangifera indica) fruit and by-products, moringa (Moringa oleifera), melon (Cucumis melo), olive oil cake and by-products, papaya (Carica papaya) fruits, leaves and by-products, pineapple by-products, pineapple leaves, pineapple mill juice, pumpkin, squash, gourd and other Cucurbita species, sapucaia (Lecythis pisonis), spanish lime (Melicoccus bijugatus), seje (Oenocarpus bataua), tomato fruits, tomato pomace, tomato skins and tomato seeds, tomato leaves and crop residues, tomato seed cake, walnut (Juglans regia), watermelon (Citrullus lanatus) forage and fruit, watermelon (Citrullus lanatus) seeds and oil meal, and mixtures thereof. In some embodiments, the solid substrate comprises grape seeds.

Non-limiting examples of roots, tubers, or root or tuber products that can be used in a solid substrate include arrowroot (Maranta arundinacea), beet molasses, canna (Canna indica), carrot (Daucus carota), cassava leaves and foliage, cassava peels, cassava pomace and other cassava by-products, cassava roots, chinese yam (Dioscorea esculenta), enset (Ensete ventricosum) corms and pseudostems, fodder beet roots, Jerusalem artichoke (Helianthus tuberosus), malanga (Xanthosoma sagittifolium), potato (Solanum tuberosum) by-products, potato (Solanum tuberosum) tubers, sugar beet pulp, dehydrated, sugar beet pulp, pressed or wet, sugar beet roots, sugar beet tops, sweet potato (Ipomoea batatas) by-products, sweet potato (Ipomoea batatas) forage, sweet potato (Ipomoea batatas) tubers, taro (Colocasia esculenta), white yam (Dioscorea rotundata), winged yam (Dioscorea alata), whitespot giant arum (Amorphophallus campanulatus), yacon (Smallanthus sonchifolius), yellow yam (Dioscorea cayenensis), maca root, dandelion root, chicory, marshmallow root, licorice root, sarsaparilla, and mixtures thereof.

Non-limiting examples of sugar processing by-products that can be used in a solid substrate include beet molasses, sugar, molasses, sugar beet pulp, pressed or wet, sugarcane bagasse, sugarcane forage, whole plant, sugarcane juice, sugarcane molasses, sugarcane press mud, sugarcane tops, and mixtures thereof.

Non-limiting examples of other plant by-products that can be used in a solid substrate include carob (Ceratonia siliqua), citrus molasses, date molasses, date palm leaves and date pedicels, date palm seeds, enset (Ensete ventricosum) corms and pseudostems, leaf protein concentrate and grass juice, mexican marigold (Tagetes erecta), mushrooms and spent mushroom substrate, molasses/urea blocks, potato (Solanum tuberosum) tubers, pyrethrum marc, spent hops, straws, sugarcane juice, sugarcane molasses, sugarcane press mud, vinasses, wood, wood sugar or wood molasses, and mixtures thereof.

In some embodiments, a solid substrate can have a composition (e.g., ratio of fats, proteins, and fibers) that is different from a traditional nut butter bean or traditional nut butter bars.

In some embodiments, nut butter bean replicas or nut butter bar replicas as described herein can also include an emulsifier.

In some embodiments, nut butter bean replicas can also include a shellac or a bulking agent (e.g., a grain meal)

In some embodiments, nut butter bean replicas as described herein can have a higher concentration of cellulose than a traditional nut butter bean. In some embodiments, nut butter bean replicas as described herein can have a lower concentration of cellulose than a traditional nut butter bean. In some embodiments, nut butter bean replicas as described herein can have a higher concentration of hemicellulose than a traditional nut butter bean. In some embodiments, nut butter bean replicas as described herein can have a lower concentration of hemicellulose than a traditional nut butter bean.

In some embodiments, nut butter bean replicas can have a different physical structure than a traditional nut butter bean. For example, some traditional nut butter beans have a continuous granular structure, while, in some embodiments, nut butter bean replicas as described herein can have a homogeneous structure.

In some embodiments, nut butter bean replicas can display a different fracture pattern than traditional nut butter beans when subjected to the same fracturing assay.

Because of the methods by which they are made, the nut butter replicas provided herein typically lack contaminants and other detrimental compounds that sometimes are encountered in traditional nut butters. These include, without limitation, organisms such as Escherichia coli, Salmonella sp., Brettanomyces sp., Lactobacillales, Aspergillus (e.g., A. ochraceus, A. carbonarius), Penicillium (e.g., P. verrucosum), Saccharomyces sp. (which are often used by distillers and brewers), Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, and Verticillium psalliotae, as well as mold, mildew, rot, insects, insect eggs, insect filth, rodent filth, mammalian excreta, insect lecithins, hydrogen sulfide, hydrogen disulfide, 2,4,6-trichloranisole, 2,4,6-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, dichloromethane, aluminum, antimony, arsenic, cadmium, chromium, cobalt, copper, lead, manganese, nickel, tin, acrylamide, ochratoxins, mycotoxins, and polycyclic aromatic hydrocarbons.

It is noted that while nut butter replicas can include volatile and non-volatile compounds as listed herein, the added compounds may react with one another to generate additional compounds, or to change the effective amount of one or more of the added compounds within the nut butter replica formulations.

Also provided herein are methods of generating a nut butter replica. In some embodiments, a method provided herein can include
a) forming an aqueous solution comprising:
   water,
   VOCs that are water-soluble, and
   non-volatile compounds that are water-soluble;
b) forming an emulsion comprising:
   an oil,
   VOCs that are fat-soluble, and
   non-volatile compounds that are fat-soluble; and
c) mixing the aqueous solution and the emulsion to form a flavor mixture.

The VOCs can be any appropriate VOCs. In some embodiments, the VOCs can be any of the VOCs described herein. The VOCs can be present in any appropriate amount.

The non-volatile compounds can be any appropriate non-volatile compounds. In some embodiments, the non-volatile compounds can be any of the non-volatile compounds described herein. The non-volatile compounds can be present in any appropriate amount.

In some embodiments, the VOCs and non-volatile compounds can include (a) one or more isolated VOCs, where at least one of the one or more isolated VOCs are not present in a corresponding reference nut butter; (b) one or more isolated VOCs, where the one or more isolated VOCs do not include one or more VOCs that are present in a corresponding reference nut butter; (c) one or more isolated non-volatile compounds, where the at least one of the one or more isolated non-volatile compounds are not present in a corresponding reference nut butter; (d) one or more isolated non-volatile compounds, where the one or more isolated non-volatile compounds do not include one or more non-volatile compounds that are present in a corresponding reference nut butter; or (e) any combination of (a), (b), (c), and (d) [(a) and (b); (a) and (c); (a) and (d); (b) and (c); (b) and (d); (c) and (d); (a), (b), and (c); (a), (b), and (d); (a), (c), and (d); (b), (c), and (d); or (a), (b), (c), and (d)]. In some embodiments, a liquid nut butter replica can be characterized by (f) one or more isolated VOCs, where the one or more isolated VOCs are present in the nut butter replica in a total amount of at least 100 ppm. Characteristic (f) can be combined with any combination of (a)-(d) as described above.

An aqueous solution can be made by any appropriate method. In some embodiments, forming an aqueous solution can comprise using low shear blending.

An emulsion can be made by any appropriate method. In some embodiments, forming an emulsion comprises homogenizing. In some embodiments, forming an emulsion comprises using a rotator stator high shear homogenizer. In some embodiments, forming an emulsion comprises using a high pressure inline recirculating homogenizer. In some embodiments, forming an emulsion can include the addition of an emulsifier, a starch, a gum, a polysaccharide, or a combination thereof.

An oil can be any appropriate oil. In some embodiments, an oil is a neutral oil. In some embodiments, an oil is a fully deodorized oil. In some embodiments, an oil includes corn oil, sunflower oil, or coconut oil.

### EXEMPLARY EMBODIMENTS

Embodiment 1 is a nut butter replica comprising: one or more isolated volatile organic compounds (VOCs); and one or more isolated non-volatile compounds; wherein: a) the one or more isolated VOCs comprise at least one VOC that is not present in a corresponding reference nut butter, b) the one or more isolated VOCs do not comprise at least one VOC that is present in a corresponding reference nut butter, c) the one or more isolated VOCs are present in the nut butter replica in a total amount of at least 100 ppm, d) the one or more isolated non-volatile compounds comprise at least one non-volatile compound that is not present in a corresponding reference nut butter, or e) the one or more isolated non-volatile compounds do not comprise at least one non-volatile compound that is present in a corresponding reference nut butter.

Embodiment 2 is the nut butter replica of embodiment 1, wherein the one or more isolated VOCs comprise at least one VOC that is not present in a corresponding reference nut butter.

Embodiment 3 is the nut butter replica of embodiment 1 or embodiment 2, wherein the one or more isolated VOCs do not comprise at least one VOC that is present in a corresponding reference nut butter.

Embodiment 4 is the nut butter replica of any one of embodiments 1-3, wherein the one or more isolated VOCs are present in the nut butter replica in a total amount of at least 100 ppm.

Embodiment 5 is the nut butter replica of any one of embodiments 1-4, wherein the one or more isolated non-volatile compounds comprise at least one non-volatile compound that is not present in a corresponding reference nut butter.

Embodiment 6 is the nut butter replica of any one of embodiments 1-5, wherein the one or more isolated non-volatile compounds do not comprise at least one non-volatile compound that is present in a corresponding reference nut butter.

Embodiment 7 is the nut butter replica of any one of embodiments 1-6, wherein the one or more isolated VOCs do not comprise at least one compound selected from the group consisting of (+/−) 2-methyl-1-butanol, 1-methyl-1h-pyrrole-2-carboxaldehyde, 1-octen−3-ol, 1-penten−3-one, 2,3,5,6-tetramethylpyrazine, 2,3,5-trimethylpyrazine, 2,3-diethyl-5-methylpyrazine, 2,3-dimethylpyrazine, 2,3-pentanedione, 2,5-dimethylpyrazine, 2-ethyl-6-methylpyrazine, 2-methyl-5-vinylpyrazine (re-gras), 2-methylbutyraldehyde, 2-methylbutyric acid, 2-methylpyrazine, 2-methyltetrahydrofuran−3-one, 2-nonanone, 2-octanone, 2-pentylfuran, 3,5-diethyl-2-methylpyrazine, 3-octen−2-one, 4-hexene-3-one, 4-hydroxy-2-butenoic acid gamma-lactone, 4-methyl-3-penten−2-one, 5-methylfurfural, acetoin, amyl alcohol, benzaldehyde, benzene, 1,3,5-trimethyl-, decanal, furfural, furfuryl alcohol, heptanal, heptyl alcohol, hexanal, hexanoic acid, hexyl alcohol, isoamyl alcohol, isobutyl isobutyrate, methyl 2-pyrrolyl ketone, methylcyclopentenolone, nonanal, nonyl alcohol, phenylacetaldehyde, pyrazine, pyridine, pyrrole, valeraldehyde, 2,3-butanediol, 2-phenyl-2-butenal, 3-ethyl-2,6-dimethylpyrazine, 5,6,7,8-tetrahydroquinoxaline, d-limonene, heptyl formate, trans-2-heptenal, 1-octanol, 2-acetyl-1-pyrroline, 2-undecenal, benzyl benzoate, cinnamaldehyde, (e)-, piperonal, vanillin, (e,e)-3,5-octadien−2-one, 2-ethyl-5-methylpyrazine, 2-ethylfuran, 2-heptanone, 2-pyrrolidone, caffeine, gamma-nonalactone, maltol, phenethyl acetate, 2-ethylpyrazine, 2-methoxy-4-vinylphenol, 3-octanone, 3-phenylpropionaldehyde, 4-hydroxybutanoic acid lactone, alpha-pinene, delta-3-carene, dihydrocoumarin, ethyl 2-methylbutyrate, ethyl benzoate, gamma-hexalactone, hexyl acetate, isobutyric acid, isovaleric acid, naphthalene, phenethyl alcohol, propylene glycol, styrene, 4-methylthiazole, alpha-phellandrene, methylsulfinylmethane, palmitic acid, pyruvaldehyde, pyruvic acid, 2,5-dimethylfuran, 2-butanone, 2-butylfuran, 2-decanone, 3-hepten−2-one, 4-carvomenthenol, 4-heptanone, 4-methyl-5-thiazoleethanol, 5-ethyl-2,3-dimethylpyrazine, butyric acid, delta-octalactone, gamma-heptalactone, heptanoic acid, methyl heptanoate, methyl hexanoate, methyl octanoate, methyl valerate, octanal, octanoic acid, o-methylanisole, p-mentha-1,4-diene, terpinolene, thiazole, trans-2-hexenal, valeric acid, 1-octen−3-one, 1-penten−3-ol, 3-hexanol, 3-penten−2-one, beta-angelicalactone, nonanoic acid, o-cymene, p-tolyl acetate, tetrahydrofurfuryl alcohol, 1-methylnaphthalene, 3-furaldehyde, 3-methyl-2-cyclohexen−1-one, 1-rhamnose, (e)-2-octen−1-ol, 1-ethyl-2-pyrrolecarboxaldehyde, 1-methylpyrrole, 2-acetyl-2-thiazoline, 2-methylpentanal, 3-n-butylphthalide, 4,5-dihydro-3(2h)thiophenone, 4-hydroxy-2,5-dimethyl-3(2h)-furanone, 4-hydroxy-5-methyl-3(2h)-furanone, 5h-5-methyl-6,7-dihydrocyclopenta(b)pyrazine, 5-isopropyl-2-methylpyrazine, 5-methylfurfuryl alcohol, acetophenone, benzoic acid, cyclopentanone, dimethyl disulfide, dimethyl trisulfide, indole, isopropenylpyrazine, n-furfurylpyrrole, oleic acid, phenethyl butyrate, propionic acid, trimethyloxazole, 2-heptanol, 2-pentanone, 1-tyrosine, methyl nicotinate, 1-nonene, 1-octene, cinnamaldehyde, hydroxyacetone, hexyl formate, phenethyl benzoate, 1-hexadecanol, 1-tetradecanol, 2-ethylhexyl benzoate, benzophenone, butyl isobutyrate, epsilon-decalactone, ethyl decanoate, ethyl laurate, ethyl myristate, ethyl octanoate, ethyl palmitate, guaiacol, lauric acid, methyl acetate, myristic acid, n-capric acid isobutyl ester, pentadecanoic acid, 3-methylbutyl ester, phenethyl decanoate, phenethyl octanoate, propyl p-hydroxybenzoate, stearic acid, 2,6-dimethylpyrazine, 2-acetyl-3-methylpyrazine, benzyl alcohol, menthol racemic, s-methyl thioacetate, 2-methoxy-3(5 and 6)-isopropylpyrazine, glycerol, 2-ethyl-1-hexanol, (tri-)acetin, 5-methyl-2-phenyl-2-hexenal, butyl acetate, undecyl alcohol, isobutyl acetate, propyl acetate, tetrahydrofurfuryl acetate, 2-isobutyl-4,5-dimethyloxazole, 2,6-dimethyl-4-heptanone, 4-methyl-5-vinylthiazole, beta-pinene, 2,3-hexanedione, 3-(methylthio)propionaldehyde, beta-caryophyllene, delta-hexadecalactone, difurfuryl ether, trans,trans-2,4-octadienal, 2-methylheptanoic acid, ethyl nonanoate, 2-heptylfuran, camphene, cyclohexanone, ethyl heptanoate, ethyl hexanoate, ethyl lactate, gamma-valerolactone, heptyl acetate, isopropenyl acetate, methyl butyrate, methyl levulinate, butylamine, methyl nonanoate, 3-methyl-2-butanol, 6-methyl-5-hepten−2-one, isoamyl acetate, 2-acetyl-3-ethylpyrazine, 2-acetylpyridine, butyl butyrate, lauryl alcohol, p-cymene, 3,4-dimethylthiophene, 4-hydroxybenzoic acid, 9-octadecenoic acid, ethyl ester, ethyl pyruvate, isopropylamine, 3-methyl-1-pentanol, 2-oxobutyric acid, 4-methyl-2-phenyl-2-pentenal, 2-acetyl-3,5(and 6)-dimethylpyrazine, trimethylamine, 2(3),5-dimethyl-6,7-dihydro-5h-cyclopentapyrazine, methyl cinnamate, amyl formate, 5-hydroxyundecanoic acid lactone, propiophenone, 2-isopropylpyrazine, 2-ethylbutyl acetate, 2-acetyl-5-methylfuran, acetaldehyde, gamma-decalactone, trans-2-decenol, 4,5-dimethylthiazole, isobutyl butyrate, tridecanoic acid, and 1-mercapto-2-propanone.

Embodiment 8 is the nut butter replica of any one of embodiments 1-7, wherein the one or more isolated VOCs do not comprise at least one compound selected from the group consisting of 2-ethyl furan, 5-methylfurfural, cyclopentanone, furfural, and limonene.

Embodiment 9 is the nut butter replica of any one of embodiments 1-8, wherein the one or more VOCs comprise at least one compound selected from the group consisting of 2,3,5-trimethylpyrazine, 2,3-diethylpyrazine, 2,3-diethyl-5-methylpyrazine, 2,5-dimethylpyrazine, 2,6-dimethylpyrazine, 2,3-dimethylpyrazine, 2-ethyl-3-methylpyrazine, 2-ethylpyrazine, 2-methylpyrazine, isopropenyl pyrazine, tetramethylpyrazine, (E,E)-2,4-decadienal, 1-octen−3-ol, 2-ethyl furan, 2-heptanone, 5-methylfurfural, benzaldehyde, coffee furanone, cyclopentanone, dimethyl trisulfide, furfural, gamma-decalactone, limonene, pyridine, isovaleric acid, syringol, valeraldehyde, esters, 4-ethylguaiacol, furfuryl mercaptan, 3-(methylthio)propionaldehyde, 2-methyltetrahydrofuran−3-one, acetic acid, 2-furyl methyl ketone, s-methyl 3-methylbutanethioate, acetoin, methyl sulfide, butyric acid, 4-methyl-5-thiazoleethanol, indole, hexanal, acetophenone, furfuryl alcohol, 2-methoxy-3(5 and 6)-isopropylpyrazine, 4-methyl-5-thiazoleethanol acetate, 2-ethoxy-3-methylpyrazine, pentanal, p-cresol, isobutyraldehyde, delta-octalactone, 5-methyl-2-hepten−4-one, linalool, beta damascenone, eugenol, vanillin, 2,3-pentanedione, 4-hydroxy-2,5-dimethyl-3(2h)-furanone, maltol, 1-lactic acid, 2-ethyl-6-methylpyrazine, 2-acetylpyridine, methional, 3-methylbutyraldehyde, phenylacetaldehyde, phenethyl alcohol, 3,4-Hexanedione, 1-(2-Furanyl)-ethanone, 5-Methyl-2-furancarboxaldehyde, 3-Methyl-2-butenal, 3-ethyl-3,6-dimethyl-2h-pyrazine, 3-furaldehyde, dihydrocoumarin, 5-hydroxy-2,4-decadienoic acid delta-lactone, 2,2,4-trimethyl-1,3-oxacyclopentane, delta-hexalactone, octanal propyleneglycol acetal, (+/−)-trans- and cis-2-hexenal propylene glycol acetal, 2-isobutyl-4-methyl-1,3-dioxolane, cis- and trans-ethyl 2,4-dimethyl-1,3-dioxolane-2-acetate, and valeraldehyde propyleneglycol acetal.

Embodiment 10 is the nut butter replica of any one of embodiments 1-9, wherein at least one of the following, in any combination, is true: (a) 2,3,5-trimethylpyrazine is present in an amount of no greater than about 4 ppm; (b) 2,3-diethyl-5-methylpyrazine is present in an amount of no greater than about 0.5 ppm; (c) 2,3-diethylpyrazine is present in an amount of no greater than about 10 ppm; (d) 2,5-dimethylpyrazine is present in an amount of no greater than about 10 ppm; (e) 2,6-dimethylpyrazine is present in an amount of no greater than about 10 ppm; (f) 2,3-dimethylpyrazine is present in an amount of no greater than about 10 ppm, and/or at least 2.0 ppm; (g) 2-ethyl-3-methylpyrazine is present in an amount of no greater than about 5.47 ppm; (h) 2-ethylpyrazine is present in an amount of no greater than about 10 ppm, and/or at least 6.0 ppm; (i) 2-methylpyrazine is present in an amount of no greater than about 10 ppm, and/or at least 6.0 ppm; (j) 2-methylpyrazine is present in an amount of no greater than about 10 ppm, and/or at least 6.0 ppm; (k) 2-methylpyrazine is present in an amount of no greater than about 10 ppm, and/or at least 6.0 ppm; (1) isopropenyl pyrazine is present in an amount of no greater than about 10 ppm, and/or at least 0.05 ppm; (m) tetramethylpyrazine is present in an amount of no greater than about 10 ppm; (n) (E,E)-2,4-decadienal is present in an amount of no greater than about 8.92 ppm; (o) 1-octen−3-ol is present in an amount of no greater than about 6 ppm; (p) 2-ethyl furan is present in an amount of no greater than about 22.5 ppm; (q) 2-heptanone is present in an amount of no greater than about 30 ppm, and/or at least 10 ppm; (r) 5-methylfurfural is present in an amount of no greater than about 2.25 ppm; (s) benzaldehyde is present in an amount of no greater than about 171.76 ppm, and/or at least about 10 ppm; (t) coffee furanone is present in an amount of no greater than about 10 ppm, and/or at least about 4.0 ppm; (u) cyclopentanone is present in an amount of no greater than about 2 ppm; (v) dimethyl trisulfide is present in an amount of no greater than about 1 ppm; (w) furfural is present in an amount of no greater than about 52.56 ppm; (x) gamma-decalactone is present in an amount of no greater than about 20.65 ppm, and/or at least about 5.0 ppm; (y) limonene is present in an amount of no greater than about 511 ppm, and/or at least about 14 ppm; (z) pyridine is present in an amount of no greater than about 1.68 ppm; (aa) isovaleric acid is present in an amount of no greater than about 7.76 ppm, and/or at least 0.7 ppm; (ab) syringol is present in an amount of no greater than about 5 ppm; (ac) valeraldehyde is present in an amount of no greater than about 6.15 ppm, and/or at least about 0.6 ppm; (ad) 4-ethylguaiacol is present in an amount of no greater than about 12 ppm; (ae) furfuryl mercaptan is present in an amount of no greater than about 3.55 ppm; (af) 3-(methylthio)propionaldehyde is present in an amount of no greater than about 4.6 ppm; (ag) 2-methyltetrahydrofuran−3-one is present in an amount of no greater than about 10 ppm; (ah) acetic acid is present in an amount of no greater than about 5900 ppm; (ai) 2-furyl methyl ketone is present in an amount of no greater than about 20 ppm; (aj) s-methyl 3-methylbutanethioate is present in an amount of no greater than about 0.1 ppm; (ak) acetoin is present in an amount of no greater than about 50 ppm; (al) methyl sulfide is present in an amount of no greater than about 1.77 ppm; (am) butyric acid is present in an amount of no greater than about 200 ppm; (an) 4-methyl-5-thiazoleethanol is present in an amount of no greater than about 55 ppm; (ao) indole is present in an amount of no greater than about 1.34 ppm; (ap) hexanal is present in an amount of no greater than about 9.51 ppm; (aq) acetophenone is present in an amount of no greater than about 28.25 ppm; (ar) furfuryl alcohol is present in an amount of no greater than about 19.48 ppm; (as) 2-methoxy-3(5 and 6)-isopropylpyrazine is present in an amount of no greater than about 0.2 ppm; (at) 4-methyl-5-thiazoleethanol acetate is present in an amount of no greater than about 55 ppm; (au) 2-ethoxy-3-methylpyrazine is present in an amount of no greater than about 5 ppm; (av) pentanal is present in an amount of no greater than about 6.15 ppm; (aw) p-cresol is present in an amount of no greater than about 7.7 ppm; (ax) isobutyraldehyde is present in an amount of no greater than about 5.8 ppm; (ay) delta-octalactone is present in an amount of no greater than about 15.53 ppm; (az) 5-methyl-2-hepten−4-one is present in an amount of no greater than about 20 ppm; (ba) linalool is present in an amount of no greater than about 40 ppm; (bb) beta-damascenone is present in an amount of no greater than about 0.2 ppm; (bc) eugenol is present in an amount of no greater than about 100 ppm; (bd) vanillin is present in an amount of no greater than about 407.99 ppm; (be) 2,3-pentanedione is present in an amount of no greater than about 10.98 ppm; (bf) 4-hydroxy-2,5-dimethyl-3(2h)-furanone is present in an amount of no greater than about 60 ppm; (bg) maltol is present in an amount of no greater than about 267.2 ppm; (bh) l-lactic acid is present in an amount of no greater than about 5000 ppm; (bi) 2-ethyl-6-methylpyrazine is present in an amount of no greater than about 5 ppm; (bj) 2-acetylpyridine is present in an amount of no greater than about 3 ppm; (bk) methional is present in an amount of no greater than about 4.6 ppm; (bl) 3-methylbutyraldehyde is present in an amount of no greater than about 16.81 ppm; (bm) phenylacetaldehyde is present in an amount of no greater than about 4.41 ppm; (bn) phenethyl alcohol is present in an amount of no greater than about 30.01 ppm; (bo) 3,4-hexanedione is present in an amount of no greater than about 10 ppm; (bp) 1-(2-furanyl)-ethanone is present in an amount of no greater than about 20 ppm; (bq) 5-methyl-2-furancarboxaldehyde is present in an amount of no greater than about 2.25 ppm; (br) 3-methyl-2-butenal is present in an amount of no greater than about 7.25 ppm; (bs) 3-ethyl-3,6-dimethyl-2h-pyrazine is present in an amount of no greater than about 10 ppm; (bt) 3-furaldehyde is present in an amount of no greater than about 500 ppm; (bu) dihydrocoumarin is present in an amount of no greater than about 130.7 ppm; or (by) 5-hydroxy-2,4-decadienoic acid delta-lactone is present in an amount of no greater than about 0.5 ppm.

Embodiment 11 is the nut butter replica of any one of embodiments 1-10, wherein the VOCs comprise one or more of: an acid, an alcohol, an alkane, an aldehyde, an amine, a benzene, an ester, a furan, a ketone, a lactone, a phenol, a pyrazine, a pyridine, a pyrrole, a sugar or sugar alcohol, a sulfur compound, a terpene, or a thiophene.

Embodiment 12 is the nut butter replica of any one of embodiments 1-11, wherein the VOCs comprise one or more of an acid, an alcohol, an aldehyde, a benzene, an ester, a furan, a ketone, a lactone, a pyridine, a pyrizine, a pyrrole, a phenol, a sulfur compound, and/or a terpene.

Embodiment 13 is the nut butter replica of any one of embodiments 1-12, wherein the VOCs comprise one or more acids.

Embodiment 14 is the nut butter replica of embodiment 13, wherein the one or more acids comprise at least one acid selected from the group consisting of isovaleric acid, acetic acid, L-lactic acid, butyric acid, 2-methylbutyric acid, 4-hydroxy-2-butenoic acid gamma-lactone, hexanoic acid, 4-hydroxybutanoic acid lactone, isobutyric acid, palmitic acid, pyruvic acid, heptanoic acid, octanoic acid, valeric acid, nonanoic acid, benzoic acid, oleic acid, propionic acid, lauric acid, myristic acid, n-capric acid isobutyl ester, pentadecanoic acid, 3-methylbutyl ester, stearic acid, 2-methylheptanoic acid, 4-hydroxybenzoic acid, 9-octadecenoic acid, ethyl ester, 2-oxobutyric acid, 5-hydroxyundecanoic acid lactone, and tridecanoic acid, or any combination thereof.

Embodiment 15 is the nut butter replica of embodiment 13 or 14, wherein the one or more acids comprise at least one acid selected from the group consisting of isovaleric acid, acetic acid, L-lactic acid, and butyric acid.

Embodiment 16 is the nut butter replica of any one of embodiments 1-15, wherein the VOCs comprise one or more alcohols.

Embodiment 17 is the nut butter replica of embodiment 16, wherein the one or more alcohols comprise at least one alcohol selected from the group consisting of 1-octen−3-ol, furfuryl alcohol, p-cresol, eugenol, phenethyl alcohol, 4-methyl-5-thiazoleethanol, (+/−) 2-methyl-1-butanol, amyl alcohol, heptyl alcohol, hexyl alcohol, isoamyl alcohol, nonyl alcohol, 2,3-butanediol, 1-octanol, 2-methoxy-4-vinylphenol, propylene glycol, 4-carvomenthenol, 1-penten−3-ol, 3-hexanol, tetrahydrofurfuryl alcohol, (e)-2-octen−1-ol, 5-methylfurfuryl alcohol, 2-heptanol, 1-hexadecanol, 1-tetradecanol, guaiacol, benzyl alcohol, glycerol, 2-ethyl-1-hexanol, undecyl alcohol, 3-methyl-2-butanol, lauryl alcohol, 3-methyl-1-pentanol, and trans-2-decenol, or any combination thereof.

Embodiment 18 is the nut butter replica of embodiment 16 or 17, wherein the one or more alcohols comprise at least one alcohol selected from the group consisting of 1-octen−3-ol, furfuryl alcohol, p-cresol, eugenol, phenethyl alcohol, and 4-methyl-5-thiazoleethanol.

Embodiment 19 is the nut butter replica of any one of embodiments 1-18, wherein the VOCs comprise one or more aldehydes.

Embodiment 20 is the nut butter replica of embodiment 19, wherein the one or more aldehydes comprise at least one aldehyde selected from the group consisting of (E,E)-2,4-decadienal, 5-methylfurfural, benzaldehyde, furfural, valeraldehyde, 3-(methylthio)propionaldehyde, hexanal, isobutyraldehyde, vanillin, methional, phenylacetaldehyde, 3-furaldehyde, pentanal, 3-methylbutyraldehyde, 3-methyl-2-butenal, 4-methyl-5-thiazoleethanol acetate, 5-methyl-2-furancarboxaldehyde, 1-methyl-1h-pyrrole-2-carboxaldehyde, 2-methylbutyraldehyde, decanal, heptanal, nonanal, 2-phenyl-2-butenal, trans-2-heptenal, 2-undecenal, piperonal, 3-phenylpropionaldehyde, pyruvaldehyde, octanal, trans-2-hexenal, 1-ethyl-2-pyrrolecarboxaldehyde, 2-methylpentanal, cinnamaldehyde, 5-methyl-2-phenyl-2-hexenal, trans,trans-2,4-octadienal, 4-methyl-2-phenyl-2-pentenal, acetaldehyde, octanal propyleneglycol acetal, (+/−)-trans- and cis-2-hexenal propylene glycol acetal, and valeraldehyde propyleneglycol acetal, or any combination thereof.

Embodiment 21 is the nut butter replica of embodiment 19 or 20, wherein the one or more aldehydes comprise at least one aldehyde selected from the group consisting of (E,E)-2,4-decadienal, 5-methylfurfural, benzaldehyde, furfural, valeraldehyde, 3-(methylthio)propionaldehyde, hexanal, isobutyraldehyde, vanillin, methional, phenylacetaldehyde, 3-furaldehyde, pentanal, 3-methylbutyraldehyde, 3-methyl-2-butenal, 4-methyl-5-thiazoleethanol acetate, and 5-methyl-2-furancarboxaldehyde.

Embodiment 22 is the nut butter replica of any one of embodiments 1-21, wherein the VOCs comprise one or more amines.

Embodiment 23 is the nut butter replica of embodiment 22, wherein the one or more amines comprise at least one amine selected from the group consisting of 2-amino-1-naphthalenol, 2-methoxy-benzenamine, 5-amino-1-naphthol, N,N-dimethyl-ethanamine, and N,N-dimethyl-methylamine, or any combination thereof.

Embodiment 24 is the nut butter replica of any one of embodiments 1-23, wherein the VOCs comprise one or more benzenes.

Embodiment 25 is the nut butter replica of embodiment 24, wherein the one or more benzenes comprise at least one benzene selected from the group consisting of dihydrocoumarin, styrene and toluene, or a combination thereof.

Embodiment 26 is the nut butter replica of any one of embodiments 1-25, wherein the VOCs comprise one or more esters.

Embodiment 27 is the nut butter replica of embodiment 26, wherein the one or more esters comprise at least one ester selected from the group consisting of isobutyl isobutyrate, heptyl formate, benzyl benzoate, phenethyl acetate, ethyl 2-methylbutyrate, ethyl benzoate, hexyl acetate, methyl heptanoate, methyl hexanoate, methyl octanoate, methyl valerate, p-tolyl acetate, phenethyl butyrate, methyl nicotinate, hexyl formate, phenethyl benzoate, 2-ethylhexyl benzoate, butyl isobutyrate, ethyl decanoate, ethyl laurate, ethyl myristate, ethyl octanoate, ethyl palmitate, methyl acetate, phenethyl decanoate, phenethyl octanoate, propyl p-hydroxybenzoate, s-methyl thioacetate, butyl acetate, isobutyl acetate, propyl acetate, tetrahydrofurfuryl acetate, ethyl nonanoate, ethyl heptanoate, ethyl hexanoate, ethyl lactate, heptyl acetate, isopropenyl acetate, methyl butyrate, methyl levulinate, methyl nonanoate, isoamyl acetate, butyl butyrate, ethyl pyruvate, methyl cinnamate, amyl formate, 2-ethylbutyl acetate, and isobutyl butyrate, or any combination thereof.

Embodiment 28 is the nut butter replica of any one of embodiments 26 or 27, wherein the nut butter replica comprises at least about 0.005 ppm of esters.

Embodiment 29 is the nut butter replica of any one of embodiments 1-28, wherein the VOCs comprise one or more furans.

Embodiment 30 is the nut butter replica of embodiment 29, wherein the one or more furans comprise at least one furan selected from the group consisting of 2-ethyl furan, 1-(2-furanyl)-ethanone, 2-pentylfuran, 2,5-dimethylfuran, 2-butylfuran, 2-heptylfuran, and 2-acetyl-5-methylfuran, or any combination thereof.

Embodiment 31 is the nut butter replica of embodiment 30, wherein the one or more furans comprise at least one furan selected from the group consisting of 2-ethyl furan and 1-(2-furanyl)-ethanone.

Embodiment 32 is the nut butter replica of any one of embodiments 1-31, wherein the VOCs comprise one or more ketones.

Embodiment 33 is the nut butter replica of embodiment 32, wherein the one or more ketones comprise at least one ketone selected from the group consisting of 2-heptanone, coffee furanone, cyclopentanone, gamma-decalactone, 2-methyltetrahydrofuran−3-one, 2-furyl methyl ketone, acetoin, acetophenone, delta-octalactone, 5-methyl-2-hepten−4-one, beta damascenone, 2,3-pentanedione, 4-hydroxy-2,5-dimethyl-3(2h)-furanone, maltol, 3,4-hexanedione, 1-penten−3-one, 2-nonanone, 2-octanone, 3-octen−2-one, 4-hexene-3-one, 4-methyl-3-penten−2-one, methyl 2-pyrrolyl ketone, methylcyclopentenolone, (e,e)-3,5-octadien−2-one, 2-pyrrolidone, gamma-nonalactone, 3-octanone, gamma-hexalactone, 2-butanone, 2-decanone, 3-hepten−2-one, 4-heptanone, gamma-heptalactone, 1-octen−3-one, 3-penten−2-one, beta-angelicalactone, 3-methyl-2-cyclohexen−1-one, 4,5-dihydro-3(2h)thiophenone, 4-hydroxy-5-methyl-3(2h)-furanone, 2-pentanone, hydroxyacetone, benzophenone, epsilon-decalactone, 2,6-dimethyl-4-heptanone, 2,3-hexanedione, delta-hexadecalactone, cyclohexanone, gamma-valerolactone, 6-methyl-5-hepten−2-one, propiophenone, 1-mercapto-2-propanone, and delta-hexalactone, or any combination thereof.

Embodiment 34 is the nut butter replica of embodiment 33, wherein the one or more ketones comprise at least one ketone selected from the group consisting of 2-heptanone, coffee furanone, cyclopentanone, gamma-decalactone, 2-methyltetrahydrofuran−3-one, 2-furyl methyl ketone, acetoin, acetophenone, delta-octalactone, 5-methyl-2-hepten−4-one, beta damascenone, 2,3-pentanedione, 4-hydroxy-2,5-dimethyl-3(2h)-furanone, maltol, and 3,4-hexanedione.

Embodiment 35 is the nut butter replica of any one of embodiments 32-34, wherein the nut butter replica comprises at least about 0.0001 ppm of ketones.

Embodiment 36 is the nut butter replica of any one of embodiments 1-35, wherein the VOCs comprise one or more lactones.

Embodiment 37 is the nut butter replica of embodiment 36, wherein the one or more lactones comprise at least one lactone selected from the group consisting of 5-hydroxy-2,4-decadienoic acid delta-lactone, 4,5-dimethyl-3-hydroxy-2,5-dihydro-furan−2-one, gamma decalactone, massoia lactone, and sotolone, or any combination thereof.

Embodiment 38 is the nut butter replica of embodiment 36 or 37, wherein the one or more lactones comprise 5-hydroxy-2,4-decadienoic acid delta-lactone.

Embodiment 39 is the nut butter replica of any one of embodiments 1-38, wherein the VOCs comprise one or more phenols.

Embodiment 40 is the nut butter replica of embodiment 39, wherein the one or more phenols comprise at least one phenol selected from the group consisting of syringol, 4-ethylguaiacol, 1-(2-hydroxy-5-methylphenyl)-ethanone, 2,5-dimethylphenol, 2-methoxy-4-methylphenol, 2-methoxy-4-vinylphenol, 2-methoxy-phenol, 2-methyl-phenol, 4-ethyl guaiacol, 4-ethyl phenol, 4-ethyl-2-methoxy-phenol, 4-vinylphenol, eugenol, guaiacol, isoeugenol, p-cresol, phenol, syringol (2,6-dimethoxyphenol), vanillin erythro and/or threo-butan−2,3-diol acetal, and vanillyl ethyl ether, or any combination thereof.

Embodiment 41 is the nut butter replica of embodiment 39 or 40, wherein the one or more phenols comprise at least one phenol selected from the group consisting of syringol and 4-ethylguaiacol.

Embodiment 42 is the nut butter replica of any one of embodiments 39-41, wherein the nut butter replica comprises at least about 0.05 ppm of phenols.

Embodiment 43 is the nut butter replica of any one of embodiments 1-42, wherein the VOCs comprise one or more pyrazines.

Embodiment 44 is the nut butter replica of embodiment 43, wherein the one or more pyrazines comprise at least one pyrazine selected from the group consisting of 2,3,5-trimethylpyrazine, 2,3-diethylpyrazine, 2,3-diethyl-5-methylpyrazine, 2,5-dimethylpyrazine, 2,6-dimethylpyrazine, 2,3-dimethylpyrazine, 2-ethyl-3-methylpyrazine, 2-ethylpyrazine, 2-methylpyrazine, isopropenyl pyrazine, tetramethylpyrazine, 2-methoxy-3(5 and 6)-isopropylpyrazine, 2-ethoxy-3-methylpyrazine, 2-ethyl-6-methylpyrazine, 3-ethyl-3,6-dimethyl-2h-pyrazine, 2,3,5,6-tetramethylpyrazine, 2-methyl-5-vinylpyrazine (re-gras), 3,5-diethyl-2-methylpyrazine, pyrazine, 3-ethyl-2,6-dimethylpyrazine, 2-ethyl-5-methylpyrazine, 5-ethyl-2,3-dimethylpyrazine, 5h-5-methyl-6,7-dihydrocyclopenta(b)pyrazine, 5-isopropyl-2-methylpyrazine, isopropenylpyrazine, 2-acetyl-3-methylpyrazine, 2-acetyl-3-ethylpyrazine, 2-acetyl-3,5(and 6)-dimethylpyrazine, and 2(3),5-dimethyl-6,7-dihydro-5h-cyclopentapyrazine, and 2-isopropylpyrazine, or any combination thereof.

Embodiment 45 is the nut butter replica of embodiment 43 or 44, wherein the one or more pyrazines comprise at least one pyrazine selected from the group consisting of 2,3,5-trimethylpyrazine, 2,3-diethylpyrazine, 2,3-diethyl-5-methylpyrazine, 2,5-dimethylpyrazine, 2,6-dimethylpyrazine, 2,3-dimethylpyrazine, 2-ethyl-3-methylpyrazine, 2-ethylpyrazine, 2-methylpyrazine, isopropenyl pyrazine, tetramethylpyrazine, 2-methoxy-3(5 and 6)-isopropylpyrazine, 2-ethoxy-3-methylpyrazine, 2-ethyl-6-methylpyrazine, and 3-ethyl-3,6-dimethyl-2h-pyrazine.

Embodiment 46 is the nut butter replica of any one of embodiments 1-45, wherein the VOCs comprise one or more pyridines.

Embodiment 47 is the nut butter replica of embodiment 46, wherein the one or more pyridines comprise at least one pyridine selected from the group consisting of 2-acetylpyridine, pyridine, 1-methyl-1,2,3,6-tetrahydropyridine, 1-methyl-piperidine, 2-methyl-pyridine, 3-ethylpyridine, 3-ethyl-pyridine, 3-methyl-pyridine, 3-propyl-pyridine, 3-pyridinol, and methyl nicotinate, or any combination thereof.

Embodiment 48 is the nut butter replica of embodiment 46 or 47, wherein the one or more pyridines comprise 2-acetylpyridine.

Embodiment 49 is the nut butter replica of any one of embodiments 46-48, wherein the nut butter replica comprises no greater than about 1.68 ppm of pyridines.

Embodiment 50 is the nut butter replica of any one of embodiments 1-49, wherein the VOCs comprise one or more pyrroles.

Embodiment 51 is the nut butter replica of embodiment 50, wherein the one or more pyrroles comprise at least one pyrrole selected from the group consisting of indole, 1-(1H-pyrrol-2-yl)-ethanone, 1-(2-furanylmethyl)-1H-pyrrole, 1-ethyl-1H-pyrrole, 1-methyl-1H-pyrrole, 1-methyl-1H-pyrrole-2-carboxaldehyde, 2-acetyl-1-methylpyrrole, 2-acetylpyrrole, and pyrrole, or any combination thereof.

Embodiment 52 is the nut butter replica of embodiment 50 or 51, wherein the one or more pyrroles comprise indole.

Embodiment 53 is the nut butter replica of any one of embodiments 1-52, wherein the VOCs comprise one or more sugars or sugar alcohols.

Embodiment 54 is the nut butter replica of embodiment 53, wherein the one or more sugars or sugar alcohols comprise at least one sugars or sugar alcohol selected from the group consisting of ethyl maltol and maltol, or a combination thereof.

Embodiment 55 is the nut butter replica of any one of embodiments 1-54, wherein the VOCs comprise one or more sulfur compounds.

Embodiment 56 is the nut butter replica of embodiment 55, wherein the one or more sulfur compounds comprise at least one sulfur compound selected from the group consisting of dimethyl trisulfide, methyl sulfide, s-methyl 3-methylbutanethioate, furfuryl mercaptan, diethyl disulfide, dimethyl disulfide, dimethyl sulfide, dimethyl sulfoxide, methanethiol, and methional, or any combination thereof.

Embodiment 57 is the nut butter replica of embodiment 55 or 56, wherein the one or more sulfur compounds comprise at least one sulfur compound selected from the group consisting of dimethyl trisulfide, methyl sulfide, s-methyl 3-methylbutanethioate, and furfuryl mercaptan.

Embodiment 58 is the nut butter replica of any one of embodiments 1-57, wherein the VOCs comprise one or more terpenes.

Embodiment 59 is the nut butter replica of embodiment 58, wherein the one or more terpenes comprise at least one terpene selected from the group consisting of limonene, linalool, pyrrole, d-alpha-pinene, delta-3-carene, naphthalene, styrene, 4-methylthiazole, alpha-phellandrene, o-methylanisole, p-mentha-1,4-diene, terpinolene, thiazole, o-cymene, 1-methylnaphthalene, 1-methylpyrrole, indole, n-furfurylpyrrole, trimethyloxazole, 1-nonene, 1-octene, 2-isobutyl-4,5-dimethyloxazole, 4-methyl-5-vinylthiazole, beta-pinene, beta-caryophyllene, camphene, p-cymene, 3,4-dimethylthiophene, and 4,5-dimethylthiazole, or any combination thereof.

Embodiment 60 is the nut butter replica of embodiment 59, wherein the one or more terpenes comprise at least one terpene selected from the group consisting of limonene and linalool.

Embodiment 61 is the nut butter replica of any one of embodiments 1-60, wherein the VOCs comprise one or more thiophenes.

Embodiment 62 is the nut butter replica of any one of embodiments 1-61, wherein the VOCs comprise 2,7-dimethyl-oxepine.

Embodiment 63 is the nut butter replica of any one of embodiments 1-62, wherein the VOCs comprise at least 20, at least 30, at least 40, or at least 50 compounds selected from the group consisting of (+/−) 2-methyl-1-butanol, 1-methyl-1h-pyrrole-2-carboxaldehyde, 1-octen−3-ol, 1-penten−3-one, 2,3,5,6-tetramethylpyrazine, 2,3,5-trimethylpyrazine, 2,3-diethyl-5-methylpyrazine, 2,3-dimethylpyrazine, 2,3-pentanedione, 2,5-dimethylpyrazine, 2-ethyl-6-methylpyrazine, 2-methyl-5-vinylpyrazine (re-gras), 2-methylbutyraldehyde, 2-methylbutyric acid, 2-methylpyrazine, 2-methyltetrahydrofuran−3-one, 2-nonanone, 2-octanone, 2-pentylfuran, 3,5-diethyl-2-methylpyrazine, 3-octen−2-one, 4-hexene-3-one, 4-hydroxy-2-butenoic acid gamma-lactone, 4-methyl-3-penten−2-one, 5-methylfurfural, acetoin, amyl alcohol, benzaldehyde, benzene, 1,3,5-trimethyl-, decanal, furfural, furfuryl alcohol, heptanal, heptyl alcohol, hexanal, hexanoic acid, hexyl alcohol, isoamyl alcohol, isobutyl isobutyrate, methyl 2-pyrrolyl ketone, methylcyclopentenolone, nonanal, nonyl alcohol, phenylacetaldehyde, pyrazine, pyridine, pyrrole, valeraldehyde, 2,3-butanediol, 2-phenyl-2-butenal, 3-ethyl-2,6-dimethylpyrazine, 5,6,7,8-tetrahydroquinoxaline, d-limonene, heptyl formate, trans-2-heptenal, 1-octanol, 2-acetyl-1-pyrroline, 2-undecenal, benzyl benzoate, cinnamaldehyde, (e)-, piperonal, vanillin, (e,e)-3,5-octadien−2-one, 2-ethyl-5-methylpyrazine, 2-ethylfuran, 2-heptanone, 2-pyrrolidone, caffeine, gamma-nonalactone, maltol, phenethyl acetate, 2-ethylpyrazine, 2-methoxy-4-vinylphenol, 3-octanone, 3-phenylpropionaldehyde, 4-hydroxybutanoic acid lactone, alpha-pinene, delta-3-carene, dihydrocoumarin, ethyl 2-methylbutyrate, ethyl benzoate, gamma-hexalactone, hexyl acetate, isobutyric acid, isovaleric acid, naphthalene, phenethyl alcohol, propylene glycol, styrene, 4-methylthiazole, alpha-phellandrene, methylsulfinylmethane, palmitic acid, pyruvaldehyde, pyruvic acid, 2,5-dimethylfuran, 2-butanone, 2-butylfuran, 2-decanone, 3-hepten−2-one, 4-carvomenthenol, 4-heptanone, 4-methyl-5-thiazoleethanol, 5-ethyl-2,3-dimethylpyrazine, butyric acid, delta-octalactone, gamma-heptalactone, heptanoic acid, methyl heptanoate, methyl hexanoate, methyl octanoate, methyl valerate, octanal, octanoic acid, o-methylanisole, p-mentha-1,4-diene, terpinolene, thiazole, trans-2-hexenal, valeric acid, 1-octen−3-one, 1-penten−3-ol, 3-hexanol, 3-penten−2-one, beta-angelicalactone, nonanoic acid, o-cymene, p-tolyl acetate, tetrahydrofurfuryl alcohol, 1-methylnaphthalene, 3-furaldehyde, 3-methyl-2-cyclohexen−1-one, 1-rhamnose, (e)-2-octen−1-ol, 1-ethyl-2-pyrrolecarboxaldehyde, 1-methylpyrrole, 2-acetyl-2-thiazoline, 2-methylpentanal, 3-n-butylphthalide, 4,5-dihydro-3(2h)thiophenone, 4-hydroxy-2,5-dimethyl-3(2h)-furanone, 4-hydroxy-5-methyl-3(2h)-furanone, 5h-5-methyl-6,7-dihydrocyclopenta(b)pyrazine, 5-isopropyl-2-methylpyrazine, 5-methylfurfuryl alcohol, acetophenone, benzoic acid, cyclopentanone, dimethyl disulfide, dimethyl trisulfide, indole, isopropenylpyrazine, n-furfurylpyrrole, oleic acid, phenethyl butyrate, propionic acid, trimethyloxazole, 2-heptanol, 2-pentanone, 1-tyrosine, methyl nicotinate, 1-nonene, 1-octene, cinnamaldehyde, hydroxyacetone, hexyl formate, phenethyl benzoate, 1-hexadecanol, 1-tetradecanol, 2-ethylhexyl benzoate, benzophenone, butyl isobutyrate, epsilon-decalactone, ethyl decanoate, ethyl laurate, ethyl myristate, ethyl octanoate, ethyl palmitate, guaiacol, lauric acid, methyl acetate, myristic acid, n-capric acid isobutyl ester, pentadecanoic acid, 3-methylbutyl ester, phenethyl decanoate, phenethyl octanoate, propyl p-hydroxybenzoate, stearic acid, 2,6-dimethylpyrazine, 2-acetyl-3-methylpyrazine, benzyl alcohol, menthol racemic, s-methyl thioacetate, 2-methoxy-3(5 and 6)-isopropylpyrazine, glycerol, 2-ethyl-1-hexanol, (tri-)acetin, 5-methyl-2-phenyl-2-hexenal, butyl acetate, undecyl alcohol, isobutyl acetate, propyl acetate, tetrahydrofurfuryl acetate, 2-isobutyl-4,5-dimethyloxazole, 2,6-dimethyl-4-heptanone, 4-methyl-5-vinylthiazole, beta-pinene, 2,3-hexanedione, 3-(methylthio)propionaldehyde, beta-caryophyllene, delta-hexadecalactone, difurfuryl ether, trans,trans-2,4-octadienal, 2-methylheptanoic acid, ethyl nonanoate, 2-heptylfuran, camphene, cyclohexanone, ethyl heptanoate, ethyl hexanoate, ethyl lactate, gamma-valerolactone, heptyl acetate, isopropenyl acetate, methyl butyrate, methyl levulinate, butylamine, methyl nonanoate, 3-methyl-2-butanol, 6-methyl-5-hepten−2-one, isoamyl acetate, 2-acetyl-3-ethylpyrazine, 2-acetylpyridine, butyl butyrate, lauryl alcohol, p-cymene, 3,4-dimethylthiophene, 4-hydroxybenzoic acid, 9-octadecenoic acid, ethyl ester, ethyl pyruvate, isopropylamine, 3-methyl-1-pentanol, 2-oxobutyric acid, 4-methyl-2-phenyl-2-pentenal, 2-acetyl-3,5(and 6)-dimethylpyrazine, trimethylamine, 2(3),5-dimethyl-6,7-dihydro-5h-cyclopentapyrazine, methyl cinnamate, amyl formate, 5-hydroxyundecanoic acid lactone, propiophenone, 2-isopropylpyrazine, 2-ethylbutyl acetate, 2-acetyl-5-methylfuran, acetaldehyde, gamma-decalactone, trans-2-decenol, 4,5-dimethylthiazole, isobutyl butyrate, tridecanoic acid, and 1-mercapto-2-propanone.

Embodiment 64 is the nut butter replica of any one of embodiments 1-63, wherein the VOCs comprise at least 10, at least 20, at least 30, at least 40, or at least 50 compounds selected from the group consisting of 2,3,5-trimethylpyrazine, 2,3-diethyl-5-methylpyrazine, 2,3-diethylpyrazine, 2,5-dimethylpyrazine, 2,6-dimethylpyrazine, 2,3-dimethylpyrazine, 2-ethyl-3-methylpyrazine, 2-ethylpyrazine, 2-methylpyrazine, isopropenyl pyrazine, tetramethylpyrazine, (E,E)-2,4-decadienal, 1-octen−3-ol, 2-ethyl furan, 2-heptanone, 5-methylfurfural, benzaldehyde, coffee furanone, cyclopentanone, DMTS, furfural, gamma-decalactone, limonene, pyridine, 4-ethylguiacol, furfuryl mercaptan, 2-pentanol, methional, acetic acid, 2-furyl methylketone, methyl thio isovalerate, acetoin, 3-methylbutanoic acid, dimethyl sulfide, butyric acid, propyl 2-mercaptopropionate, 2,4,6-trimethylphenol (mesitol), gamma-valerolactone, delta octalactone, delta decalactone, whiskey lactone, p-cresol, 3-(methylthio)propionaldehyde, isobutyraldehyde, delta-octalactone, 5-methyl-2-hepten−4-one, linalool, valeraldehyde, beta-damascenone, eugenol, vanillin, 2,3-pentanedione, 4-hydroxy-2,5-dimethyl-3(2H)-furanone, maltol, L-lactic acid, and 2-acetylpyridine.

Embodiment 65 is the nut butter replica of any one of embodiments 1-64, wherein the VOCs have less than about 95% or less than about 85% identity to the VOCs in a single reference nut butter.

Embodiment 66 is the nut butter replica of any one of embodiments 1-65, wherein the nut butter replica comprises at least 71 VOCs and wherein no more than 70 of the VOCs are found in a single reference nut butter.

Embodiment 67 is the nut butter replica of any one of embodiments 1-66, wherein the nut butter replica comprises at least 51 VOCs and wherein no more than 50 of the VOCs are found in a single reference nut butter.

Embodiment 68 is the nut butter replica of any one of embodiments 1-67, wherein the one or more isolated non-volatile compounds do not comprise at least one compound selected from the group consisting of homoserine, nicotinic acid, valine, proline, arginine, B-alanine-2, asparagine, glutamic acid, phenylalanine, leucine, lysine, glycine, serine, arabitol, fructose, mannitol, catechin, epicatechin, sorbitol, sucrose, trehalose, sotolon, vanillin, 2-ethyl-2-hydroxybutyricacid, and ricinoleic acid.

Embodiment 69 is the nut butter replica of any one of embodiments 1-68, wherein the one or more isolated non-volatile compounds comprise at least one compound selected from the group consisting of 8-hydroxyquinoline, quinoline, chlorogenic acid, fraxetin, strawberry furanone acetate, luteolin−7-O-glucoside, inosine, trigonelline, trans-4-hydroxyproline, carnosine, cystine, kynurenic acid, ornithine, cysteine, pyridoxine, adenine, glucosamine, D-glucuronic acid, quinic acid, tartaric acid, fumaric acid, succinic acid, 3,4-dihydroxybenzoic acid, 2-furoic acid, camphoric acid, ribose, adipic acid, rutin, xylose, galactose, vanillic acid, syringic acid, polydatin, cytosine, 4-guanidinobutyric acid, uracil, tyramine, tryptamine, maple furanone, acetanilide, benzaldehyde, sorbic acid, B-ionone, muramic acid, trans,trans-muconic acid, gentisic acid, 6,7-dihydroxycoumarin, tropic acid, 6-hydroxy-2-naphthoic acid, propyl gallate, hesperetin, and caffeic acid.

Embodiment 70 is the nut butter replica of any one of embodiments 1-69, wherein at least one of the following, in any combination, is true: (a) chlorogenic acid is present in an amount of at least about 32 ppm; (b) propyl gallate is present in an amount of at least about 5.0 ppm; (c) hesperetin is present in an amount of at least about 0.08 ppm; or (d) caffeic acid is present in an amount of at least about 0.15 ppm.

Embodiment 71 is the nut butter replica of any one of embodiments 1-70, wherein the one or more isolated non-volatile compounds comprise one or more of: an acid, an aldehyde, an alkaloid, an amine, an amino acid, a furan, a ketone, a lactone, a nucleotide, a nucleotide monophosphate, or nucleobase, a protein or peptide, a pyrazine, a pyridine, a sugar or sugar alcohol, a tannin, phenol, a fat, a salt, an emulsifier, polyphenol, or anthocyanin, or a xanthine.

Embodiment 72 is the nut butter replica of any one of embodiments 1-71, wherein the one or more isolated non-volatile compounds comprise one or more of: an acid, an aldehyde, an amino acid, a lactone, a pyrazine, a tannin, phenol, a fat, a salt, an emulsifier, polyphenol, or anthocyanin, or a xanthine.

Embodiment 73 is the nut butter replica of any one of embodiments 1-72, wherein the one or more isolated non-volatile compounds comprise one or more acids.

Embodiment 74 is the nut butter replica of embodiment 73, wherein the one or more acids comprise at least one acid selected from the group consisting of adipic acid, trans-ferulic acid, sinapinic acid, salicylic acid, pantothenic acid, caffeic acid, vanillic acid, syringic acid, coumaric acid, sorbic acid, kynurenic acid, D-glucuronic acid, quinic acid, malic acid, pyruvic acid, tartaric acid, lactic acid, citric acid, fumaric acid, succinic acid, gallic acid, 2-furoic acid, 3,4-dihydroxybenzoic acid, 2-isopropylmalic acid, D-Gluconic acid, 4-methoxycinnamic acid, 2-ethyl-2-hydroxybutyric acid, ricinoleic acid, DL-hydroxystearic acid, nicotinic acid, chlorogenic acid, cholic acid, and hydroxybutyricacid, or any combination thereof.

Embodiment 75 is the nut butter replica of any one of embodiments 1-74, wherein the one or more isolated non-volatile compounds comprise one or more aldehydes.

Embodiment 76 is the nut butter replica of embodiment 75, wherein the one or more aldehydes comprise vanillin.

Embodiment 77 is the nut butter replica of embodiment 75 or 76, wherein the aldehydes are present in an amount of at least about 0.001 ppm.

Embodiment 78 is the nut butter replica of any one of embodiments 1-77, wherein the one or more isolated non-volatile compounds comprise one or more alkaloids.

Embodiment 79 is the nut butter replica of embodiment 78, wherein the one or more alkaloids comprise piperine.

Embodiment 80 is the nut butter replica of any one of embodiments 1-79, wherein the one or more isolated non-volatile compounds comprise one or more amines.

Embodiment 81 is the nut butter replica of embodiment 80, wherein the one or more amines comprise tryptamine.

Embodiment 82 is the nut butter replica of any one of embodiments 1-81, wherein the one or more isolated non-volatile compounds comprise one or more amino acids.

Embodiment 83 is the nut butter replica of embodiment 82, wherein the one or more amino acids comprise at least one amino acid selected from the group consisting of phenylalanine, leucine, glucosamine, methionine, GABA, Tyrosine, lysine, histidine, glycine, serine, aspartic acid, isoleucine, tryptophan, valine, proline, carnitine, arginine, B-alanine-2, Threonine, glutamine, asparagine, glutamic acid, betaine, pipecolinic acid, citrulline, carnosine, and homoserine, or any combination thereof.

Embodiment 84 is the nut butter replica of any one of embodiments 1-83, wherein the one or more isolated non-volatile compounds comprise one or more furans.

Embodiment 85 is the nut butter replica of embodiment 84, wherein the one or more furans comprise hydroxymethylfurfural.

Embodiment 86 is the nut butter replica of any one of embodiments 1-85, wherein the one or more isolated non-volatile compounds comprise one or more ketones.

Embodiment 87 is the nut butter replica of embodiment 86, wherein the one or more ketones comprise at least one ketone selected from the group consisting of 2(5H)-furanone, 5-ethyl-4-hydroxy-2-methyl-3(2H)-furanone, acetovanillone, and methyl-2-pyrrolyl ketone, or any combination thereof.

Embodiment 88 is the nut butter replica of any one of embodiments 1-87, wherein the one or more isolated non-volatile compounds comprise one or more lactones.

Embodiment 89 is the nut butter replica of embodiment 88, wherein the one or more lactones comprise sotolon.

Embodiment 90 is the nut butter replica of any one of embodiments 1-89, wherein the one or more isolated non-volatile compounds comprise one or more nucleotides, nucleotide monophosphates, or nucleobases.

Embodiment 91 is the nut butter replica of embodiment 90, wherein the one or more nucleotides, nucleotide monophosphates, or nucleobases comprise at least one nucleotides, nucleotide monophosphates, or nucleobase selected from the group consisting of adenine, AMP, CMP, cytidine, cytosine, guanine, and uracil, or any combination thereof.

Embodiment 92 is the nut butter replica of any one of embodiments 1-91, wherein the one or more isolated non-volatile compounds comprise one or more proteins or peptides.

Embodiment 93 is the nut butter replica of embodiment 92, wherein the one or more proteins or peptides comprise carnosine.

Embodiment 94 is the nut butter replica of any one of embodiments 1-93, wherein the one or more isolated non-volatile compounds comprise one or more pyrazines.

Embodiment 95 is the nut butter replica of embodiment 94, wherein the one or more pyrazines comprise at least one pyrazine selected from the group consisting of 2,3,5,6-tetramethylpyrazine, 2,3,5-trimethylpyrazine, and 2,3-dimethylpyrazine, or any combination thereof.

Embodiment 96 is the nut butter replica of any one of embodiments 1-95, wherein the one or more isolated non-volatile compounds comprise one or more pyridines.

Embodiment 97 is the nut butter replica of embodiment 96, wherein the one or more pyridines comprise at least one pyridine selected from the group consisting of pyridine and pyroxidine, or a combination thereof.

Embodiment 98 is the nut butter replica of any one of embodiments 1-97, wherein the one or more isolated non-volatile compounds comprise one or more sugars or sugar alcohols.

Embodiment 99 is the nut butter replica of embodiment 98, wherein the one or more sugars or sugar alcohols comprise at least one sugar or sugar alcohol selected from the group consisting of arabitol, fructose, rhamnose, mannitol, glucose, lactose, xylose, sorbitol, fucose, galactose, mannose, sucrose, myo-inositol, trehalose, allulose, monkfruit, stevia, maltitol, isomalt, tagatose, and stachyose, or any combination thereof.

Embodiment 100 is the nut butter replica of any one of embodiments 1-99, wherein the one or more isolated non-volatile compounds comprise one or more tannins, phenols, polyphenols, or anthocyanins.

Embodiment 101 is the nut butter replica of embodiment 100, wherein the one or more tannins, phenols, polyphenols, or anthocyanins comprise at least one tannin, phenol, polyphenol, or anthocyanin selected from the group consisting of catechin, ellagic acid, epicatechin, epicatechin gallate, gallic acid, hesperetin, methyl gallate, polydatin, propyl gallate, quercetin, resveratrol, rutin, salicylic acid, sinapinic acid, syringaldehyde, syringic acid, trans-ferulic acid, tyramine, and vanillic acid, or any combination thereof.

Embodiment 102 is the nut butter replica of any one of embodiments 1-101, wherein the one or more isolated non-volatile compounds comprise one or more xanthines.

Embodiment 103 is the nut butter replica of embodiment 102, wherein the one or more xanthines comprise theobromine.

Embodiment 104 is the nut butter replica of any one of embodiments 1-103, wherein the one or more isolated non-volatile compounds comprise stabilizer fats.

Embodiment 105 is the nut butter replica of embodiment 104, wherein the one or more stabilizer fats comprise hydrogenated oil, palm oil, kernel oil, shea oil, cottonseed oil, and/or other fats and plant oils.

Embodiment 106 is the nut butter replica of any one of embodiments 1-105, wherein the one or more isolated non-volatile compounds comprise cocoa products.

Embodiment 107 is the nut butter replica of embodiment 106, wherein the one or more cocoa products comprise cocoa powder, cocoa butter, and/or chocolate.

Embodiment 108 is the nut butter replica of any one of embodiments 1-107, wherein the one or more isolated non-volatile compounds comprise an emulsifier.

Embodiment 109 is the nut butter replica of embodiment 108, wherein the one or more emulsifiers comprise lecithin.

Embodiment 110 is the nut butter replica of any one of embodiments 1-109, wherein the one or more isolated non-volatile compounds comprise a substrate.

Embodiment 111 is the nut butter replica of embodiment 110, wherein the substrate comprises grape seeds, sunflower seeds, sunflower kernels, sunflower meal or flour, sunflower oil, other processed or unprocessed grains or grain products, legumes or legume seeds, oil plants or seeds, fruits or fruit products, roots, tubers, or root or tuber products, sugar processing by-products, and/or other plant by-products.

Embodiment 112 is the nut butter replica of any one of embodiments 1-111, wherein the one or more isolated non-volatile compounds comprise a liquid medium.

Embodiment 113 is the nut butter replica of embodiment 112, wherein the liquid medium comprises water, milk, plant-based milk, and/or other alternative dairy products.

Embodiment 114 is the nut butter replica of any one of embodiments 1-113, wherein the one or more nonvolatile compounds comprise at least 10 compounds selected from the group consisting of 2(5H)-furanone, 2,3,5,6-tetramethylpyrazine, 2,3,5-trimethylpyrazine, 2,3-dimethylpyrazine, 2-ethyl-2-hydroxybutyric acid, 2-furoic acid, 2-isopropylmalic acid, 3,4-dihydroxybenzoic acid, 4-guanidinobutyric acid, 4-methoxycinnamic acid, 5-ethyl-4-hydroxy-2-methyl-3(2H)-furanone, acetovanillone, adenine, adipic acid, AMP, arabitol, arginine, asparagine, aspartic acid, beta-alanine, betaine, caffeic acid, caffeine, carnitine, carnosine, catechin, choline, cinnamic acid, citric acid, citrulline, CMP, coumaric acid, cysteine, cystine, cytidine, cytosine, D-gluconic acid, D-glucuronic acid, DL-hydroxystearic acid, ellagic acid, epicatechin, epicatechin gallate, fructose, fumaric acid, GABA, galactose, gallic acid, glucosamine, glucose, glutamic acid, glutamine, glycine, guanine, hesperetin, histidine, homoserine, hydroxymethylfurfural, isoleucine, kynurenic acid, lactic acid, leucine, lysine, malic acid, mannitol, mannose, methionine, methyl gallate, methyl-2-pyrrolyl ketone, inositol, ornithine, pantothenic acid, phenylalanine, pipecolinic acid, piperine, polydatin, proline, propyl gallate, pyridine, pyridoxine, pyruvic acid, quercetin, quinic acid, resveratrol, rhamnose, ribose, rutin, salicylic acid, serine, sinapinic acid, sorbic acid, sorbitol, sotolon, succinic acid, syringaldehyde, syringic acid, tartaric acid, threonine, trans-4-hydroxyproline, trans-ferulic acid, tryptamine, tryptophan, tyramine, tyrosine, uracil, valine, vanillic acid, vanillin, and xylose.

Embodiment 115 is the nut butter replica of any one of embodiments 1-114, wherein the one or more isolated non-volatile compounds comprise at least 5 or at least 10 compounds selected from the group consisting of 2,3,5-trimethylpyrazine, 2,3-dimethylpyrazine, aspartic acid, caffeine, choline, citric acid, lactic acid, sotolon, succinic acid, trans-ferulic acid, vanillic acid, and vanillin.

Embodiment 116 is the nut butter replica of any one of embodiments 1-115, wherein the one or more isolated non-volatile compounds have less than about 95% or less than about 85% identity to the isolated non-volatile compounds in a single reference nut butter.

Embodiment 117 is the nut butter replica of any one of embodiments 1-116, wherein the nut butter replica comprises at least 11 isolated non-volatile compounds and wherein no more than 10 of the isolated non-volatile compounds are found in a single reference nut butter.

Embodiment 118 is the nut butter replica of any one of embodiments 1-117, wherein the nut butter replica does not comprise one or more of E. coli, Salmonella sp., Brettanomyces sp., Lactobacillales, Saccharomyces sp., Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, Verticillium psalliotae, mold, mildew, rot, insects, insect eggs, insect filth, rodent filth, mammalian excreta, hydrogen sulfide, hydrogen disulfide, 2,4,6-trichloranisole, 2,4,6-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, dichloromethane, tree nut protein allergens, peanut protein allergens, and heavy metals.

Embodiment 119 is the nut butter replica of any one of embodiments 1-118, wherein the nut butter replica is a solution, suspension, or emulsion.

Embodiment 120 is the nut butter replica of embodiment 119, wherein the solution, suspension, or emulsion is a nut butter spread or a nut butter coating.

Embodiment 121 is the nut butter replica of any one of embodiments 1-120, wherein the nut butter replica is soluble in water.

Embodiment 122 is a method of preparing a nut butter replica, the method comprising: forming a mixture comprising: water, one or more isolated VOCs that are water-soluble, and one or more isolated non-volatile compounds that are water-soluble; forming a substrate emulsion comprising: an oil, one or more isolated VOCs that are fat-soluble, and one or more isolated non-volatile compounds that are fat-soluble; and mixing the aqueous solution and the emulsion to form a nut butter replica.

Embodiment 123 is the method of embodiment 122, wherein forming an emulsion comprises homogenizing.

Embodiment 124 is the method of embodiment 122 or 123, wherein the oil comprises corn oil, sunflower oil, palm oil, soybean oil, cocoa butter, shea oil, kernel oil, or coconut oil.

Embodiment 125 is the method of any one of embodiments 122-124, wherein the method further comprises agglomerating the flavor mixture.

Embodiment 126 is the method of embodiment 125, wherein agglomerating the flavor mixture comprises pneumatic mixing, steam-jet, fluid-bed, pan, or spray drying, drum, mixer, roller, or extrusion agglomeration.

Embodiment 127 is the method of any one of embodiments 122-126, wherein the nut butter replica comprises a solid substrate.

Embodiment 128 is the method of embodiment 127, wherein the method further comprises applying the flavor mixture to the solid substrate.

Embodiment 129 is the method the method of embodiment 128, wherein applying the flavor mixture comprises spray applying the flavor mixture.

Embodiment 130 is the method of any one of embodiments 127-129, wherein the solid substrate comprises processed or unprocessed grains or grain products, legumes or legume seeds, oil plants or seeds, fruits or fruit products, roots, tubers, or root or tuber products, sugar processing by-products, or other plant by-products.

Embodiment 131 is the method of any one of embodiments 127-130, wherein the solid substrate comprises grape seeds or other fruit seeds (e.g., seeds from raspberry, cranberry, blackberry, and/or strawberry).

Embodiment 132 is the method of any one of embodiments 122-131, wherein: a) the one or more isolated VOCs comprise at least one VOC that is not present in a corresponding reference nut butter, b) the one or more isolated VOCs do not comprise at least one VOC that is present in a corresponding reference nut butter, c) the one or more isolated VOCs are present in the nut butter replica in a total amount of at least 100 ppm, d) the one or more isolated non-volatile compounds comprise at least one non-volatile compound that is not present in a corresponding reference nut butter, or e) the one or more isolated non-volatile compounds do not comprise at least one non-volatile compound that is present in a corresponding reference nut butter.

### EXAMPLES

### Example 1—LCMS of Reference Nut Butters

LC-MS was used to measure the levels of various non-volatile compounds in several reference nut butter samples, according to the following method.

All analyses were performed on a Thermo Ultimate 3000 Ultra-Performance Liquid Chromatograph (UPLC) coupled with a Thermo Scientific Q-Exactive high resolution mass spectrometer (MS). XCalibur software was used for data acquisition, and the mass spectrometer instrument parameters were as follows for all methods:

Polarity: positive or negative mode, as indicated for each method

Resolution: 70,000

Scan range: 60-900 m/z for all methods with the exception of the lipid method, which is 134-2000 m/z

Isolation window: 1.5 m/z

MS/MS collision energy: 30

Preparation of analytical standards: Stock solutions at a concentration of 1 mg/mL were made for each compound in 50% methanol. Serial dilutions were then made of each compound to create a 15-point standard curve, ranging from 10 ng/mL to 20 μg/mL. Standard curves were run in combinations of 7-12 compounds from each category per set, so long as there were no overlaps in retention time, which would have hindered quantitation.

Retention times were pre-determined for each compound by running the analytical standard at a 20 μg/mL dilution, and identifying the compound based on its accurate mass.

In all cases, five μL of each standard mix was injected through the autosampler and LC to the MS. Separation took place on a chromatographic column that was specific to each class of compounds. The conditions for each chromatographic method are described below, including the column, mobile phase and gradient used for each method.

Several types of columns were used for the different compounds, and different limits of detection (LODs) as indicated in TABLES 1A-D.

TABLE 1A
List of compounds quantified by each method in Round 1 assays

| HILIC positive | HILIC negative | Omega negative | C18 positive |
|---|---|---|---|
| methionine | rhamnose | tartaric acid | quinic acid |
| histidine | glucose | citric acid | trans-4-hydroxy proline |
| lysine | mannitol | lactic acid | L-citrulline |
| serine | fructose | 3,4-dihydroxybenzoic acid | kynurenic acid |
| leucine | ribose | gallic acid | |
| isoleucine | arabitol | glucuronic acid | |
| phenylalanine | inositol | fumaric acid | |
| aspartic acid | mannose | malic acid | |
| tyrosine | xylose | 2-isopropylmalic acid | |
| glycine | sorbitol | 2-furoic acid | |
| γ-aminobutyric acid | galactose | pyruvic acid | |
| glucosamine | beta-alanine | succinic acid | |
| arginine | citrulline | | |
| valine | | | |
| proline | | | |
| cystine | | | |
| asparagine | | | |
| glutamic acid | | | |
| tryptophan | | | |
| ornithine | | | |
| glutamine | | | |
| threonine | | | |
| carnitine | | | |
| betaine | | | |
| camosine | | | |
| homoserine | | | |
| pipecolinic acid | | | |

TABLE 1B
LODs for standards being quantified
(in pg/mL, ng/mL, or ug/mL) in Round 1
assays

| Cassette | Compound | LOD |
|---|---|---|
| 10 | methionine | 500 pg |
| 10 | histidine | 10 ng |
| 10 | lysine | 10 ng |
| 10 | serine | 2 ng |
| 10 | leucine | 500 pg |
| 10 | phenylalanine | 500 pg |
| 10 | aspartic acid | 5 ug |
| 10 | tyrosine | 2 ng |
| 10 | GABA | 2 ng |
| 10 | glucosamine | 50 ng |
| 11 | arginine | 10 ng |
| 11 | valine | 100 ng |
| 11 | proline | 2 ng |
| 11 | isoleucine | 10 ng |
| 11 | cysteine | 1 ug |
| 11 | asparagine | 10 ng |
| 11 | glutamic acid | 10 ng |
| 11 | tryptophan | 2 ng |
| 11 | ornithine | 10 ng |
| 11 | glutamine | 10 ng |
| 11 | threonine | 10 ng |
| 11 | carnitine | 500 pg |
| 12 | tartaric acid | 100 pg |
| 12 | citric acid | 10 ng |
| 12 | 2-isopropylmalic acid | 100 pg |
| 12 | lactic acid | 2 ng |
| 12 | 3,4-dihydroxybenzoic acid | 100 pg |
| 12 | gallic acid | 500 pg |
| 12 | D-glucuronic acid | 100 pg |
| 12 | fumaric acid | 500 pg |
| 12 | malic acid | 100 pg |
| 12 | 2-furoic acid | 10 ng |
| 12 | pyruvic acid | 100 pg |
| 12 | succinic acid | 500 pg |
| 13 | rhamnose | 10 ng |
| 13 | glucose | 100 ng |
| 13 | mannitol | 2 ng |
| 13 | fructose | 2 ng |
| 13 | ribose | 10 ng |
| 13 | arabitol | 2 ng |
| 15 | inositol | 10 ng |
| 15 | mannose | 10 ng |
| 15 | xylose | 100 ng |
| 15 | sorbitol | 2 ng |
| 15 | galactose | 10 ng |
| 16 | quinic acid | 1 ng |
| 17 | trans-4-hydroxy proline | 200 pg |
| 17 | L-citrulline | 200 pg |
| 17 | kynurenic acid | 200 pg |

TABLE 1C
Additional LODs for standards being quantified

| Compound | LOD |
|---|---|
| beta alanine | 100 ppb |
| citrulline | 100 ppb |
| betaine | <10 ppb |
| carnosine | <10 ppb |
| cystine | <100 ppb |
| D-glucuronic acid | 500 ppb |
| homoserine | <10 ppb |
| myo-inositol | 50 ppb |
| pipecolinic acid | <10 ppb |
| glycine | 50 ppb |

TABLE ID
Methods and LODs for compounds detected

| Compound Name | Method | LOD |
|---|---|---|
| 2(5H)-furanone | Cl8 Positive | 50 ppb |
| 2,3,5,6-Tetramethylpyrazine | Cl8 Positive | <1 ppb |
| 2,3,5-trimethylpyrazine | C18 Positive | <1 ppb |
| 2,3-dimethylpyrazine | C18 Positive | <1 ppb |
| 2-ethyl-2-hydroxybutyric acid | Synergi Neg | <10 ppb |
| 2-furoic acid | Synergi Neg | 10 ng |
| 2-isopropylmalic acid | Synergi Neg | 100 pg |
| 3,4-dihydroxybenzoic acid | Synergi Neg | 100 pg |
| 4-Guanidinobutyric acid | C18 Positive | 100 ppb |
| 4-methoxycinnamic acid | Synergi Neg | 1.75 ppm |
| 5-ethyl-4-hydroxy-2-methyl-3(2H)- | Cl8 Positive | |
| furanone | | |
| Acetovanillone | Cl8 Positive | 1 ng |
| adenine | Cl8 Positive | 200 pg |
| Adipic acid | Cl 8 Negative | <10 ppb |
| AMP | Cl8 Positive | 10 ppb |
| arabitol | HILIC neg | 2 ng |
| arginine | HILIC Pos | 10 ng |
| asparagine | HILIC Pos | 10 ng |
| aspartic acid | HILIC Pos | 5 ug |
| beta-alanine | HILIC neg | 100 ppb |
| betaine | HILIC Pos | <10 ppb |
| Caffeic acid | Cl8 Positive | 20 ng |
| Caffeine | Cl8 Positive | <10 ppb |
| carnitine | HILIC Pos | 500 pg |
| carnosine | HILIC Pos | <10 ppb |
| catechin | Cl 8 Negative | 1 ng |
| Choline | HILIC Positive | 2 ng |
| Cinnamic acid | C18 Positive | 500 ng |
| citric acid | Omega Neg | 10 ng |
| citrulline | C18 pos | 100 ppb |
| CMP | Cl8 Positive | <10 ppb |
| Coumaric acid | Cl8 Positive | 4 ng |
| cysteine | HILIC Pos | 1 ug |
| cystine | HILIC Pos | <100 ppb |
| Cytidine | Cl8 Positive | 5 ppb |
| cytosine | C18 Positive | 100 ppb |
| D-Gluconic acid | Synergi Neg | <10ppb |
| DL-hydroxystearic acid | Synergi Neg | 1.75 ppm |
| Ellagic acid | Cl8 Negative | 1 ng |
| epicatechin | C18 Negative | 1 ng |
| epicatechin Gallate | Cl8 Positive | <10 ppb |
| fructose | HILIC neg | 2 ng |
| fumaric acid | Synergi Neg | 500 pg |
| galactose | HILIC neg | 10 ng |
| gallic acid | Synergi Neg | 500 pg |
| glucosamine | HILIC Pos | 50 ng |
| glucose | HILIC neg | 100 ng |
| glucuronic acid | Synergi Neg | 500 ppb |
| glutamic acid | HILIC Pos | 10 ng |
| glutamine | HILIC Pos | 10 ng |
| glycine | HILIC Pos | 50 ppb |
| Guanine | Cl8 Positive | 200 pg |
| hesperetin | C18 Negative | 200 pg |
| histidine | HILIC Pos | 10 ng |
| homoserine | HILIC Pos | <10 ppb |
| inositol | HILIC neg | 50 ppb |
| isoleucine | HILIC Pos | 10 ng |
| kynurenic acid | C18 pos | 200 pg |
| lactic acid | Synergi Neg | 2 ng |
| leucine | HILIC Pos | 500 pg |
| lysine | HILIC Pos | 10 ng |
| malic acid | Synergi Neg | 100 pg |
| mannitol | HILIC neg | 2 ng |
| mannose | HILIC neg | 10 ng |
| methionine | HILIC Pos | 500 pg |
| Methyl Gallate | Cl 8 Negative | <10 ppb |
| Methyl2-pyrrolyl ketone | Cl8 Positive | <5 ppb |
| ornithine | HILIC Pos | 10 ng |
| Pantothenic acid | C18 Positive | 0.2 ng |
| phenylalanine | HILIC Pos | 500 pg |
| pipecolinic acid | HILIC Pos | <10 ppb |
| Piperine | C18 Positive | <1 ppb |
| polydatin | Cl8 Positive | 4 ng |
| proline | HILIC Pos | 2 ng |
| Propyl Gallate | Cl 8 Negative | <10 ppb |
| Pyridine | Cl8 Positive | <1 ppb |
| pyridoxine | HILIC Positive | 100 pg |
| pyruvic acid | Synergi Neg | 100 pg |
| Quercetin | Cl 8 Negative | 1 ng |
| quinic acid | C18 pos | 1 ng |
| Resveratrol | C18 Negative | 4 ng |
| rhamnose | HILIC neg | 10 ng |
| ribose | HILIC neg | 10 ng |
| rutin | C18 Negative | 1 ng |
| Salicylic acid | Cl 8 Negative | 200 pg |
| serine | HILIC Pos | 2 ng |
| Sinapinic acid | C18 Negative | 200 pg |
| Sorbic acid | Cl8 Positive | 100 ng |
| sorbitol | HILIC neg | 2 ng |
| sotolon | C18 Positive | 25 ppb |
| succinic acid | Synergi Neg | 500 pg |
| Syringaldehyde | C18 Positive | 1 ng |
| Syringic acid | Cl8 Positive | 50 ng |
| tartaric acid | Synergi Neg | 100 pg |
| threonine | HILIC Pos | 10 ng |
| trans-4-hydroxy proline | C18 pos | 200 pg |
| Trans-4-hydroxyproline | HILIC Positive | <10 ppb |
| Trans-Ferulic acid | C18 Negative | 1 ng |
| Tryptamine | C18 Positive | 200 pg |
| tryptophan | HILIC Pos | 2 ng |
| tyramine | C18 Positive | 1 ng |
| tyrosine | HILIC Pos | 2 ng |
| uracil | Cl8 Positive | 5 ppb |
| valine | HILIC Pos | 100 ng |
| Vanillic acid | Cl8 Positive | 10 ng |
| vanillin | C18 Positive | 200 pg |
| xylose | HILIC neg | 100 ng |
| y-aminobutyric acid | HILIC Pos | 2 ng |

Quantitation of Amino Acids and Similar Polar Compounds: A HILIC (hydrophilic interaction liquid chromatography) column was used to assess polar compounds that can retain a positive charge. The mobile phase used with this column included A: H₂O+5 mM Ammonium Acetate+0.1% TFA (trifluoroacetic acid), and B: 90/10 ACN (Acetonitrile)/H₂O+5 mM Ammonium Acetate+0.1% TFA. Each chromatographic run was 27.5 minutes long, and the column temperature was maintained at 40° C. The column used was a Phenomenex Luna, 3 μm NH2, 100 Å, 150×2 mm (Product # 00F-4377-B0), and the guard column was a Phenomenex Security Guard Cartridges, NH2, 4×2 mm (# PRD-196870).

TABLE 2
HILIC positive mode gradient conditions

| Time | Flow Rate (mL/min) | % A | % B |
|---|---|---|---|
| 0 | 0.5 | 5 | 95 |
| 6 | 0.5 | 5 | 95 |
| 18 | 0.5 | 60 | 40 |
| 20 | 0.5 | 80 | 20 |
| 22 | 0.5 | 5 | 95 |
| 27 | 0.5 | 5 | 95 |

Quantitation of Sugars and Sugar Alcohols: The same HILIC column used for quantitation of the amino acids was used for quantitation of sugars, but the polarity of the MS was run in negative mode. While the same mobile phases were used, the gradient was slightly modified to help with retention. The temperature of the column also was held at 50° C. for better peak shape and separation of the isobaric sugars.

TABLE 3
HILIC negative mode gradient conditions

| Time | Flow Rate (mL/min) | % A | % B |
|---|---|---|---|
| 0 | 0.5 | 0 | 100 |
| 3 | 0.5 | 0 | 100 |
| 18 | 0.5 | 18 | 82 |
| 19 | 0.5 | 26 | 74 |
| 20 | 0.5 | 60 | 40 |
| 21 | 0.4 | 80 | 20 |
| 23 | 0.4 | 0 | 100 |
| 28 | 0.4 | 0 | 100 |

Quantitation of Non-Polar Compounds: A C18 column was used to assess non-polar compounds, as they are retained in the long carbon chains under polar conditions. This method was run in both positive and negative modes, depending on each compound and whether it ionizes better with a positive or negative charge, respectively. The mobile phases used for this method were A: H2O+0.1% FA, and B: Methanol, and the temperature of the column was held at 50° C. The column used was an Agilent Poroshell 120, EC-C18 2.7 μm, 3.0×100 mm (Product #695975-302).

TABLE 4
C18 positive/negative mode gradient conditions

| Time | Flow Rate (mL/min) | % A | % B |
|---|---|---|---|
| 0 | 0.6 | 100 | 0 |
| 1.5 | 0.6 | 100 | 0 |
| 4 | 0.6 | 0 | 100 |
| 6 | 0.6 | 0 | 100 |
| 6.1 | 0.6 | 100 | 0 |
| 9 | 0.6 | 100 | 0 |

Quantitation of Organic Acids and Similarly Charged Polar Compounds: To look at organic acids, a charged C18 column was used. The gradient used for the organic method was the same as for the C18 non-polar methods, as shown in TABLE 8. There was a modification to mobile phase B for this method, in that B: ACN+0.1% FA. The column used was a Phenomenex Luna Omega, 1.6 μm, PS C18 100 Å, 100×2.1 mm (Product #00D-4752-AN).

Data analysis: Data analysis methods were developed with the XCalibur Processing Setup program, where methods were made for each standard cassette for each LC method. The compound mass and retention time was added for each standard, and calibration levels were applied for each standard. To calculate concentrations in samples, the samples and standards for each run were processed together using XCalibur Quan software, and concentrations calculated based on the respective compound calibration curve. Limits of detection were determined for each standard by running each standard curve at low levels until nothing was detected.

Quantitation of Organic Acids: A Synergi Hydro reversed phase column was used to assess organic acids, as they are retained in charged stationary phase under polar conditions. This method was run in negative ionization mode. The mobile phases used for this method were A: H2O+0.1% FA, and B: Acetonitrile+0.1% FA, and the temperature of the column was held at 50° C. The column used was a Phenomenex Synergi 2.5 μm Hydro RP, 100 Å, 100×2 mm (Product #00D-4387-B0).

TABLE 5
Synergi Hydro negative mode gradient conditions

| Time | Flow Rate (mL/min) | % A | % B |
|---|---|---|---|
| 0 | 0.2 | 100 | 0 |
| 1.3 | 0.2 | 100 | 0 |
| 4 | 0.2 | 0 | 100 |
| 6 | 0.4 | 0 | 100 |
| 6.1 | 0.4 | 100 | 0 |
| 8.5 | 0.4 | 100 | 0 |

The levels of the non-volatile compounds measured in the reference nut butter samples are shown in TABLE 6.

TABLE 6
LCMS of reference nut butters

| | 1 | 2 | 3 | 4 | 5 | 6 | 7 | 8 |
|---|---|---|---|---|---|---|---|---|
| Ascorbic Acid | NF | NF | NF | NF | NF | NF | NF | NF |
| Nicotinic Acid | 0.005 | 0.008 | 0.134 | 0.152 | 0.091 | 0.094 | 0.148 | 0.040 |
| 8-Hydroxyquinoline | NF | NF | NF | NF | NF | NF | NF | NF |
| Quinoline | NF | NF | NF | NF | NF | NF | NF | NF |
| Theobromine | NF | 33.328 | NF | NF | NF | NF | 1.044 | NF |
| 5-Methoxyresorcinol | NF | 0.003 | 0.003 | 0.004 | 0.002 | 0.004 | 0.005 | NF |
| Chlorogenic_Acid | NF | NF | NF | NF | NF | NF | NF | NF |
| Epicatechin_Gallate | NF | NF | NF | NF | NF | NF | NF | 0.017 |
| Fraxetin | NF | NF | NF | NF | NF | NF | NF | NF |
| Strawberry_Furanone_Acetate | NF | NF | NF | NF | NF | NF | NF | NF |
| Luteolin-7-O-Glucoside | NF | NF | NF | NF | NF | NF | NF | NF |
| Inosine | NF | NF | NF | NF | NF | NF | NF | NF |
| Betaine | NF | NF | NF | NF | NF | NF | NF | NF |
| Pipecolinic_Acid | NF | NF | 0.270 | 0.398 | 0.375 | 0.317 | 0.274 | NF |
| Trigonelline | NF | NF | NF | NF | NF | NF | NF | NF |
| Trans-4-Hydroxyproline | NF | NF | NF | NF | NF | NF | NF | NF |
| Carnosine | NF | NF | NF | NF | NF | NF | NF | NF |
| Citrulline | NF | 0.099 | NF | NF | NF | NF | NF | 0.048 |
| Homoserine | 0.141 | 0.177 | 0.107 | 0.124 | 0.104 | 0.137 | 0.126 | 0.142 |
| Cystine | NF | NF | NF | NF | NF | NF | NF | NF |
| Kynurenic_Acid | NF | NF | NF | NF | NF | NF | NF | NF |
| Isoleucine | 0.218 | 0.678 | NF | 0.103 | 0.015 | 0.119 | 0.026 | 0.382 |
| Tyrptophan | 0.135 | 2.386 | NF | 0.113 | 0.018 | 0.043 | 0.207 | 0.893 |
| Valine | 0.419 | 8.896 | 2.881 | 2.675 | 2.807 | 2.045 | 3.123 | 11.623 |
| Proline | 2.742 | 0.613 | 0.251 | 0.687 | 0.524 | 1.136 | 0.841 | 1.892 |
| Carnitine | NF | NF | NF | NF | NF | NF | NF | NF |
| Arginine | 5.506 | 4.354 | 3.430 | 3.341 | 1.963 | 1.896 | 6.292 | 1.370 |
| Ornithine | NF | NF | NF | NF | NF | NF | NF | NF |
| B-Alanine-2 | 0.987 | 2.268 | 0.568 | 1.156 | 0.435 | 1.192 | 1.026 | 1.838 |
| Threonine | 0.178 | 0.423 | NF | 0.064 | NF | 0.153 | 0.069 | 0.188 |
| Glutamine | NF | NF | NF | NF | NF | NF | NF | NF |
| Asparagine | 5.197 | 0.589 | 0.324 | 0.426 | 0.344 | 0.283 | 1.354 | 2.689 |
| Cysteine | NF | NF | NF | NF | NF | NF | NF | NF |
| Glutamic Acid | 6.783 | 14.437 | 2.272 | 9.042 | 6.584 | 10.768 | 10.539 | 5.789 |
| Pyridoxine | NF | NF | NF | NF | NF | NF | NF | NF |
| Adenine | NF | NF | NF | NF | NF | NF | NF | NF |
| Cytidine | NF | 0.062 | NF | NF | NF | NF | NF | NF |
| Phenylalanine | 0.120 | 1.750 | 0.849 | 1.478 | 1.225 | 1.637 | 1.626 | 0.267 |
| Leucine | 0.337 | 1.860 | 0.133 | 0.247 | 0.170 | 0.258 | 0.208 | 0.461 |
| Glucosamine | NF | NF | NF | NF | NF | NF | NF | NF |
| Methionine | NF | NF | NF | NF | NF | NF | NF | NF |
| Gaba | NF | 0.199 | 0.033 | 0.046 | 0.023 | 0.026 | 0.100 | 0.137 |
| Tyrosine | 0.004 | 0.721 | 0.034 | NF | 0.034 | 0.208 | 0.069 | NF |
| Lysine | 0.110 | 0.309 | 0.127 | 0.141 | 0.076 | 0.056 | 0.223 | 0.116 |
| Histidine | 0.039 | 0.171 | 0.057 | NF | 0.032 | NF | 0.099 | 0.053 |
| Glycine | 0.035 | 0.080 | 0.033 | 0.051 | 0.027 | 0.045 | 0.061 | 0.066 |
| Serine | 0.061 | 0.121 | 0.040 | 0.055 | 0.036 | 0.042 | 0.138 | 0.120 |
| D-Glucuronic Acid | NF | NF | NF | NF | NF | NF | NF | NF |
| Quinic Acid | NF | NF | NF | NF | NF | NF | NF | NF |
| Tartaric Acid | NF | NF | NF | NF | NF | NF | NF | NF |
| Fumaric Acid | NF | NF | NF | NF | NF | NF | NF | NF |
| Malic Acid | NF | NF | 0.882 | 0.975 | NF | 0.866 | 1.118 | 2.953 |
| Lactic Acid | NF | NF | 0.561 | NF | 0.567 | NF | NF | NF |
| Citric Acid | 0.689 | NF | 0.718 | 0.594 | 0.459 | 0.632 | 0.973 | 1.906 |
| Succinic Acid | NF | NF | NF | NF | NF | NF | NF | NF |
| 3,4-Dihydroxybenzoic_Acid | NF | NF | NF | NF | NF | NF | NF | NF |
| 2-Furoic_Acid | NF | NF | NF | NF | NF | NF | NF | NF |
| Camphoric Acid | NF | NF | NF | NF | NF | NF | NF | NF |
| Ribose | NF | NF | NF | NF | NF | NF | NF | NF |
| Arabitol | 0.313 | 1.216 | 0.981 | 1.046 | 0.747 | 0.383 | 0.711 | 1.559 |
| Fructose | 5.631 | 17.524 | 20.928 | 5.520 | 21.763 | 3.322 | 58.397 | 13.590 |
| Rhamnose | NF | 1.836 | NF | NF | 0.764 | NF | NF | NF |
| Mannitol | 0.307 | 2.460 | 1.070 | 0.706 | 0.928 | 0.305 | 0.802 | 1.355 |
| Glucose | NF | NF | NF | NF | NF | NF | 11.339 | NF |
| Lactose | NF | NF | NF | NF | NF | NF | NF | NF |
| Catechin | 0.421 | 3.297 | 0.465 | 0.529 | 0.464 | 0.559 | 0.578 | 1.726 |
| Adipic Acid | NF | NF | NF | NF | NF | NF | NF | NF |
| Methyl Gallate | NF | NF | NF | NF | NF | NF | NF | 1.935 |
| Epicatechin | 0.420 | 3.302 | 0.464 | 0.528 | 0.463 | 0.557 | 0.576 | 0.889 |
| Rutin | NF | NF | NF | NF | NF | NF | NF | NF |
| Trans-Ferulic Acid | NF | 0.238 | 0.236 | 0.280 | 0.201 | 0.174 | 0.156 | NF |
| Sinapinic_Acid | NF | 0.313 | 0.280 | 0.299 | 0.262 | 0.211 | 0.213 | NF |
| Resveratrol | NF | NF | NF | 0.015 | NF | 0.018 | 0.019 | NF |
| Ellagic_Acid | NF | NF | NF | NF | NF | NF | NF | 13.226 |
| Propyl_Gallate | NF | NF | NF | NF | NF | NF | NF | NF |
| Hesperetin | NF | NF | NF | NF | NF | NF | NF | NF |
| Xylose | NF | NF | NF | NF | NF | NF | NF | NF |
| Sorbitol | 0.433 | 3.226 | 1.311 | 0.934 | 1.114 | 0.401 | 0.991 | 1.687 |
| Fucose | NF | 6.298 | NF | NF | NF | NF | NF | NF |
| Galactose | NF | NF | NF | NF | NF | NF | NF | NF |
| Mannose | 0.037 | 0.686 | 3.103 | 0.049 | 2.789 | 0.868 | 8.417 | 1.044 |
| Sucrose | 294.813 | 467.467 | 398.130 | 127.962 | 370.550 | 160.106 | 408.493 | 229.969 |
| Myo-Inositol | 0.366 | NF | NF | 0.253 | NF | 0.189 | NF | 1.073 |
| Trehalose | 309.055 | 473.841 | 421.791 | 130.375 | 376.724 | 160.928 | 402.572 | 232.666 |
| Stachyose | 1.627 | 40.488 | 7.490 | 10.069 | 4.912 | 7.462 | 12.590 | 25.679 |
| Amp | 0.015 | 0.020 | 0.011 | 0.018 | 0.010 | 0.053 | 0.022 | 0.025 |
| Hydroxymethylfurfural | 0.053 | NF | 0.059 | 0.060 | 0.038 | 0.044 | 0.043 | 0.151 |
| Procyanidin_B1 | NF | 0.013 | 0.061 | 0.102 | 0.065 | 0.070 | 0.080 | 0.187 |
| Pantothenic Acid | NF | 0.005 | 0.007 | 0.008 | 0.005 | 0.005 | 0.009 | 0.003 |
| Sotolon | 0.163 | 0.455 | 1.042 | 1.807 | 1.879 | 2.291 | 0.453 | 2.259 |
| Caffeic_Acid | NF | NF | NF | NF | NF | NF | NF | NF |
| Vanillic Acid | NF | NF | NF | NF | NF | NF | NF | NF |
| Syringic Acid | NF | 0.079 | NF | NF | NF | NF | NF | NF |
| Vanillin | 0.006 | 1.021 | 0.011 | 0.014 | 0.010 | 0.010 | 0.030 | 0.008 |
| Syringaldehyde | NF | NF | 0.002 | 0.001 | NF | 0.000 | 0.002 | NF |
| Coumaric Acid | NF | 0.170 | 1.310 | 1.630 | 1.106 | 1.198 | 1.091 | NF |
| Acetovanillone | NF | 0.033 | NF | NF | NF | NF | NF | NF |
| Cinnamic Acid | NF | 26.604 | 2.831 | 11.647 | 7.866 | 8.927 | 0.455 | NF |
| Polydatin | NF | NF | NF | NF | NF | NF | NF | NF |
| Cytosine | NF | NF | NF | NF | NF | NF | NF | NF |
| 4-Guanidinobutyric Acid | NF | NF | NF | NF | NF | NF | NF | NF |
| Uracil | NF | NF | NF | NF | NF | NF | NF | NF |
| Tyramine | NF | NF | NF | NF | NF | NF | NF | NF |
| Tyrptamine | NF | NF | NF | NF | NF | NF | NF | NF |
| Maltol | NF | 0.844 | NF | NF | NF | NF | NF | NF |
| Maple Furanone | NF | NF | NF | NF | NF | NF | NF | NF |
| Acetanilide | NF | NF | NF | NF | NF | NF | NF | NF |
| Benzaldehyde | NF | NF | NF | NF | NF | NF | NF | NF |
| Sorbic Acid | NF | NF | NF | NF | NF | NF | NF | NF |
| B-Ionone | NF | NF | NF | NF | NF | NF | NF | NF |
| 4-Methoxycinnamic Acid | 2.740 | #DIV/0! | 2.695 | 5.168 | 4.795 | 6.085 | 4.453 | 1.463 |
| D-Gluconic Acid | #DIV/0! | 0.266 | 0.890 | 0.250 | 0.281 | 0.169 | 0.009 | 0.866 |
| 2-Ethyl-2-Hydroxybutyricacid | 0.098 | 0.058 | 0.091 | 0.067 | 0.085 | 0.061 | 0.074 | 0.094 |
| Ricinoleicacid | 0.406 | 0.276 | 0.460 | 0.510 | 0.786 | 0.582 | 0.520 | 0.521 |
| Caffeine | NF | 2.571 | NF | NF | NF | NF | NF | NF |
| Methyl 2-Pyrrolyl Ketone | NF | NF | 0.005 | 0.013 | 0.001 | 0.007 | 0.001 | 0.007 |
| Muramic Acid | NF | NF | NF | NF | NF | NF | NF | NF |
| Trans,Trans-Muconic_Acid | NF | NF | NF | NF | NF | NF | NF | NF |
| Gentisic_Acid | NF | NF | NF | NF | NF | NF | NF | NF |
| 6,7-Dihydroxycoumarin | NF | NF | NF | NF | NF | NF | NF | NF |
| Tropic_Acid | NF | NF | NF | NF | NF | NF | NF | NF |
| 6-Hydroxy-2-Naphthoic_Acid | NF | NF | NF | NF | NF | NF | NF | NF |
| Azelaic_Acid | 0.270 | NF | NF | NF | NF | NF | NF | NF |
| | 9 | 10 | 11 | 12 | 13 | 14 | 15 | 16 |
| Ascorbic Acid | NF | NF | NF | NF | NF | NF | NF | NF |
| Nicotinic Acid | 0.004 | 0.024 | 0.041 | 0.076 | 0.105 | 0.081 | 0.139 | 0.031 |
| 8 -Hydroxyquinoline | NF | NF | NF | NF | NF | NF | NF | NF |
| Quinoline | NF | NF | NF | NF | NF | NF | NF | NF |
| Theobromine | 0.094 | 32.520 | NF | NF | NF | NF | NF | NF |
| 5-Methoxyresorcinol | NF | 0.034 | NF | 0.002 | 0.004 | 0.003 | 0.004 | 0.004 |
| Chlorogenic_Acid | NF | NF | NF | NF | NF | NF | NF | NF |
| Epicatechin_Gallate | 0.007 | 0.007 | NF | NF | NF | NF | NF | NF |
| Fraxetin | NF | NF | NF | NF | NF | NF | NF | NF |
| Strawberry_Furanone_Acetate | NF | NF | NF | NF | NF | NF | NF | NF |
| Luteolin-7-O-Glucoside | NF | NF | NF | NF | NF | NF | NF | NF |
| Inosine | NF | NF | NF | NF | NF | NF | NF | NF |
| Betaine | 0.953 | 0.376 | NF | NF | NF | NF | NF | NF |
| Pipecolinic_Acid | NF | NF | NF | 0.066 | 0.238 | 0.257 | 0.343 | NF |
| Trigonelline | NF | NF | NF | NF | NF | NF | NF | NF |
| Trans-4-Hydroxyproline | NF | NF | NF | NF | NF | NF | NF | NF |
| Carnosine | NF | NF | NF | NF | NF | NF | NF | NF |
| Citrulline | 0.174 | 0.101 | NF | NF | NF | 0.181 | NF | 0.118 |
| Homoserine | 0.122 | 0.134 | 0.306 | 0.144 | 0.124 | 0.123 | 0.101 | 0.144 |
| Cystine | NF | NF | NF | NF | NF | NF | NF | NF |
| Kynurenic_Acid | NF | NF | NF | NF | NF | NF | NF | NF |
| Isoleucine | 0.053 | NF | 1.491 | 0.063 | 0.018 | 0.405 | NF | 0.142 |
| Tyrptophan | 0.045 | 0.187 | 0.615 | NF | NF | 0.106 | NF | 0.236 |
| Valine | 59.486 | 50.163 | 3.117 | 1.204 | 6.695 | 1.765 | 2.585 | 3.183 |
| Proline | 0.193 | 0.882 | 4.595 | 0.394 | 0.789 | 0.675 | 0.641 | 0.111 |
| Carnitine | 0.728 | 0.093 | NF | NF | NF | NF | NF | NF |
| Arginine | NF | NF | 4.478 | 2.967 | 6.332 | 1.581 | 2.525 | 0.095 |
| Ornithine | NF | NF | NF | NF | NF | NF | NF | NF |
| B-Alanine-2 | 1.070 | 1.593 | 3.223 | 0.861 | 0.798 | 0.766 | 0.323 | 1.607 |
| Threonine | 0.054 | 0.138 | 1.288 | 0.191 | 0.063 | 0.056 | NF | 0.200 |
| Glutamine | 0.017 | 0.112 | NF | NF | NF | NF | NF | NF |
| Asparagine | 0.323 | 0.255 | 18.578 | 0.639 | 0.498 | 0.186 | 0.246 | 0.013 |
| Cysteine | NF | NF | NF | NF | NF | NF | NF | NF |
| Glutamic Acid | 4.439 | 10.193 | 14.987 | 6.609 | 8.955 | 4.519 | 3.866 | 6.174 |
| Pyridoxine | NF | NF | NF | NF | NF | NF | NF | NF |
| Adenine | NF | NF | NF | NF | NF | NF | NF | NF |
| Cytidine | 0.157 | 0.195 | NF | NF | NF | NF | NF | NF |
| Phenylalanine | 0.079 | 1.194 | 0.868 | 1.498 | 1.161 | 1.136 | 0.600 | 0.112 |
| Leucine | 0.211 | 1.761 | 1.285 | 0.208 | 0.179 | 1.209 | 0.134 | 0.283 |
| Glucosamine | NF | NF | NF | NF | NF | NF | NF | NF |
| Methionine | NF | NF | NF | NF | NF | 0.008 | NF | NF |
| Gaba | 0.032 | 0.284 | 0.149 | 0.170 | 0.043 | 0.087 | 0.029 | 0.063 |
| Tyrosine | 0.037 | 0.201 | 0.160 | 0.063 | 0.082 | 0.134 | 0.049 | 0.048 |
| Lysine | 0.004 | 0.027 | 0.237 | 0.180 | 0.251 | 0.099 | 0.054 | 0.016 |
| Histidine | NF | 0.014 | 0.279 | 0.067 | 0.107 | 0.009 | NF | 0.021 |
| Glycine | 0.070 | 0.176 | 0.258 | 0.036 | 0.028 | 0.070 | 0.032 | 0.057 |
| Serine | 0.018 | 0.090 | 0.484 | 0.105 | 0.038 | 0.077 | 0.039 | 0.067 |
| D-Glucuronic Acid | NF | NF | NF | NF | NF | NF | NF | NF |
| Quinic Acid | NF | NF | NF | NF | NF | NF | NF | NF |
| Tartaric Acid | NF | NF | NF | NF | NF | NF | NF | NF |
| Fumaric Acid | NF | NF | NF | NF | NF | NF | NF | NF |
| Malic Acid | 3.090 | 1.955 | NF | 1.021 | NF | NF | 0.829 | 6.651 |
| Lactic Acid | NF | 1.193 | NF | NF | NF | 1.712 | NF | NF |
| Citric Acid | 0.932 | 3.298 | 2.246 | 0.765 | 0.605 | 0.672 | 1.055 | 0.897 |
| Succinic Acid | NF | NF | NF | NF | NF | NF | NF | NF |
| 3,4-Dihydroxybenzoic_Acid | NF | NF | NF | NF | NF | NF | NF | NF |
| 2-Furoic_Acid | NF | NF | NF | NF | NF | NF | NF | NF |
| Camphoric Acid | NF | NF | NF | NF | NF | NF | NF | NF |
| Ribose | NF | NF | NF | NF | NF | NF | NF | NF |
| Arabitol | 0.932 | 1.304 | 0.483 | 0.667 | 0.584 | 0.693 | 0.922 | 0.401 |
| Fructose | 21.073 | 31.734 | 4.414 | 4.070 | 7.422 | 3.370 | 26.312 | 3.456 |
| Rhamnose | NF | 1.815 | NF | NF | NF | NF | NF | NF |
| Mannitol | 1.295 | 1.730 | 0.714 | 0.265 | 0.555 | 0.365 | 0.366 | 0.394 |
| Glucose | NF | 8.279 | NF | NF | NF | NF | NF | NF |
| Lactose | 75.312 | 52.096 | NF | NF | NF | NF | NF | NF |
| Catechin | 0.549 | 4.455 | 0.598 | 0.415 | 0.675 | 0.429 | 0.602 | 0.395 |
| Adipic Acid | NF | NF | NF | NF | NF | NF | NF | NF |
| Methyl Gallate | NF | NF | NF | NF | NF | NF | NF | NF |
| Epicatechin | 0.549 | 4.458 | 0.597 | 0.414 | 0.671 | 0.428 | 0.606 | 0.394 |
| Rutin | NF | NF | NF | NF | NF | NF | NF | NF |
| Trans-Ferulic Acid | NF | NF | NF | 0.139 | 0.181 | 0.145 | 0.189 | NF |
| Sinapinic_Acid | NF | NF | NF | 0.133 | 0.213 | 0.168 | 0.260 | NF |
| Resveratrol | NF | NF | NF | NF | 0.019 | NF | 0.024 | NF |
| Ellagic_Acid | 0.219 | NF | NF | NF | NF | NF | NF | 0.020 |
| Propyl_Gallate | NF | NF | NF | NF | NF | NF | NF | NF |
| Hesperetin | NF | NF | NF | NF | NF | NF | NF | NF |
| Xylose | NF | NF | NF | NF | NF | NF | NF | NF |
| Sorbitol | 1.730 | 1.915 | 0.935 | 0.335 | 0.767 | 0.436 | 0.438 | 0.498 |
| Fucose | NF | 9.224 | NF | NF | NF | NF | NF | NF |
| Galactose | NF | NF | NF | NF | NF | NF | NF | NF |
| Mannose | 3.732 | 6.166 | 0.082 | NF | NF | 0.410 | 2.126 | 0.176 |
| Sucrose | 388.319 | 405.792 | 189.970 | 285.208 | 420.330 | 362.535 | 121.653 | 152.454 |
| Myo-Inositol | NF | NF | 1.345 | NF | 0.231 | NF | NF | 0.372 |
| Trehalose | 396.296 | 409.331 | 192.597 | 289.405 | 425.930 | 370.125 | 123.778 | 151.133 |
| Stachyose | NF | 2.509 | 15.871 | 8.517 | 8.591 | 5.197 | 7.477 | 14.750 |
| Amp | NF | 0.004 | 0.134 | 0.024 | 0.024 | 0.019 | 0.018 | 0.034 |
| Hydroxymethylfurfural | NF | NF | 0.090 | 0.041 | 0.047 | 0.027 | 0.044 | 0.068 |
| Procyanidin_B1 | 0.157 | NF | 0.004 | 0.016 | 0.085 | 0.029 | 0.146 | NF |
| Pantothenic Acid | 0.088 | 0.096 | NF | 0.001 | 0.006 | 0.000 | 0.004 | 0.013 |
| Sotolon | 0.824 | 0.250 | 0.775 | 2.035 | 2.583 | 0.820 | 1.544 | 0.127 |
| Caffeic_Acid | NF | NF | NF | NF | NF | NF | NF | NF |
| Vanillic Acid | NF | NF | NF | NF | NF | NF | NF | NF |
| Syringic Acid | NF | NF | NF | NF | NF | NF | NF | NF |
| Vanillin | 0.033 | 2.862 | 0.010 | 0.008 | 0.009 | 0.012 | 0.011 | 0.006 |
| Syringaldehyde | 0.001 | NF | NF | 0.000 | NF | 0.002 | 0.002 | 0.000 |
| Coumaric Acid | 0.081 | NF | NF | 1.072 | 1.184 | 0.845 | 1.243 | 0.101 |
| Acetovanillone | NF | 0.114 | NF | NF | NF | NF | NF | NF |
| Cinnamic Acid | NF | NF | NF | 6.149 | 10.817 | NF | 0.855 | NF |
| Polydatin | NF | NF | NF | NF | NF | NF | NF | NF |
| Cytosine | NF | NF | NF | NF | NF | NF | NF | NF |
| 4-Guanidinobutyric Acid | NF | NF | NF | NF | NF | NF | NF | NF |
| Uracil | NF | NF | NF | NF | NF | NF | NF | NF |
| Tyramine | NF | NF | NF | NF | NF | NF | NF | NF |
| Tyrptamine | NF | NF | NF | NF | NF | NF | NF | NF |
| Maltol | 1.590 | NF | NF | NF | NF | NF | NF | NF |
| Maple Furanone | NF | NF | NF | NF | NF | NF | NF | NF |
| Acetanilide | NF | NF | NF | NF | NF | NF | NF | NF |
| Benzaldehyde | NF | NF | NF | NF | NF | NF | NF | NF |
| Sorbic Acid | NF | NF | NF | NF | NF | NF | NF | NF |
| B-Ionone | NF | NF | NF | NF | NF | NF | NF | NF |
| 4-Methoxycinnamic Acid | 0.741 | 0.591 | 6.261 | 4.691 | 0.595 | 1.960 | 5.959 | 4.299 |
| D-Gluconic Acid | 0.572 | 0.445 | 0.402 | 0.225 | 0.221 | 0.220 | 0.278 | 0.515 |
| 2-Ethyl-2-Hydroxybutyricacid | 0.129 | 0.076 | 0.121 | 0.069 | 0.064 | 0.272 | 0.064 | 0.145 |
| Ricinoleicacid | 0.748 | 0.816 | 0.492 | 0.403 | 0.422 | 0.646 | 0.915 | 0.493 |
| Caffeine | NF | 3.505 | NF | NF | NF | NF | NF | NF |
| Methyl 2-Pyrrolyl Ketone | NF | NF | NF | 0.006 | 0.002 | 0.002 | 0.009 | NF |
| Muramic_Acid | NF | NF | NF | NF | NF | NF | NF | NF |
| Trans,Trans-Muconic_Acid | NF | NF | NF | NF | NF | NF | NF | NF |
| Gentisic_Acid | NF | NF | NF | NF | NF | NF | NF | NF |
| 6,7-Dihydroxycoumarin | NF | NF | NF | NF | NF | NF | NF | NF |
| Tropic_Acid | NF | NF | NF | NF | NF | NF | NF | NF |
| 6-Hydroxy-2-Naphthoic_Acid | NF | NF | NF | NF | NF | NF | NF | NF |
| Azelaic_Acid | NF | NF | NF | NF | NF | NF | NF | NF |

NF = not found

### Example 2—Generating a Nut Butter Replica from Plant Seeds and Other Plant Materials

To generate a nut butter replica, the following procedure was used. First, whole seeds were cleaned with various cleaning house pieces of equipment (e.g., a destoner, scalping deck, aspiration channel, sizing deck, optical sorter, and/or sieving steps). This can remove unwanted chaff and broken materials as well as other products of agricultural origin (e.g., stones, grape skins, stems, sticks, etc.). Next, the seeds were treated with caustic solution (e.g., sodium hydroxide, potassium hydroxide, etc.), and then placed in water at elevated temperatures (75° C. for example) with agitation for 30 minutes-2 hours to reach a pH of 8-9. After dutched, the seed mixture was dried (e.g., by tray dry, spray dry, drum dry, or vacuum dry methods). The dried seeds were either sieved and the two streams were dried separately; or the moisture was evaporated from the slurry in vacuum. Next, the seeds were roasted using convection, conduction, or a combination of the two. The roasting process can include air/convective roasting, oil roasting, impingement oven roasting, convection oven roasting, steam injection roasting, or drum roasting. The seeds from the roasting step were dry grinded using a mill (e.g., a crushing mill, burr mill, espresso grinder, stone mill, or jet milling). The grined seeds were sifted if necessary using a vibrating sieve. Next, the grinded seeds were combined and mixed with sugar, seed meals/flour and other nonvolatiles to the seeds in a jacketed mixer. The slurry can be pumped into a continuous rotor stator particle size reduction machine. Next, the mixture was pumped directly onto a refiner, to refine the material. Next, the mixture was transferred into a jacketed mixer and mixed with stabilizing fats, volatiles, syrups, other nonvolatiles, and wet ground plant kernel. Finally, after the above steps were finished, the nut butter replicas were packaged.

### Example 3—GCMS of Reference Nut Butters

GC-MS/MS was used to assess the amounts of various VOCs in traditional nut butters.

GC-MSMS Conditions: All analyses were performed using an Agilent 7890B GC interfaced with a 7000D Triple Quadrupole mass spectrometer, and equipped with a PAL RSI 85 autosampler with HS-SPME attachment. For Headspace (HS) Solid Phase Microextraction (SPME) experiments, the SPME fiber was a 1 cm, 50/30 μm DVB/CAR/PDMS fiber (Supelco; Bellefonte, Pa.). HS-SPME autosampler conditions were as follows: pre-incubation time of 5 minutes, incubation temperature of 60° C., extraction time of 15 minutes, and desorption time of 10 minutes. Post-desorption fiber conditioning time was 30 minutes. For liquid injection experiments, the injection volume was 0.5 μL. SPME injections were run in splitless mode, while liquid injections were run with a split ratio of 1:20 or 1:10, with a desorption temperature of 250° C. The column was a 30 m×0.25 mm×0.25 Agilent DBHeavyWax (ultra inert). Helium was used as the carrier gas at a constant flow rate of 1 mL/min. The MS ion source temperature and interface temperature were 250° C. The temperature program was as follows: initial temperature of 40° C., held for 0.5 minutes, then increased to 240° C. at a rate of 10° C./min, and held for 10 minutes, for a total run time of 30 minutes.

Selection of target compounds and MRM method development: An outline of the general workflow for GC-MS analyses is as follows. Real samples were first analyzed by HS-SPME-GC/MS in full scan mode (m/z 30-300) to identify potential target compounds. Collected data were analyzed manually using Agilent MassHunter Qualitative Analysis Version B.07.00, or using Agilent MassHunter Unknowns Analysis Version B.08.00. Additional compounds may have been targeted based on literature research. Multiple Reaction Monitoring (MRM) optimization was performed using commercially available standards. First, full scan experiments were repeated with liquid injection (5 ppm in pure EtOH) to verify retention time and potential precursor ions. Product ion scans were performed using liquid injection and varying collision energies across a range of 5-25 V. Optimized MRM transitions and collision energies were selected, and are displayed in TABLE 7. A dynamic MRM (dMRM) method was developed for the generation of calibration curves, as described below. Compounds were divided into multiple methods to minimize simultaneous transitions (no greater than 6).

Quantification: Calibration for all compounds was performed using the method of standard additions. Solutions were prepared for SPME as 10 mL sample, or as 1 mL sample diluted with 9 mL milliQ water, or as 0.1 mL sample diluted with 9.9 mL milliQ water, in 20-mL amber vials. Concentration range of spiked standards was varied by compound based on the expected range in real samples. Spiking solutions were prepared in EtOH for standard addition of analytes, except in the case of acids, which were prepared in milliQ water. Spiking solutions were spiked into samples at 10, 20, 30, and 40 uL

Data were analyzed using Agilent Quantitative Analysis (for QQQ). Values reported as not detected (nd, zero) may be considered to be below the limits of detection (LODs) listed in TABLE 7. LODs were approximated based on S/N ratios as generated by the MassHunter software.

Various reference nut butter samples were assayed by GC-MS; the levels of VOCs therein are shown in TABLE 8.

TABLE 7
GCMS Transitions and Figures of Merit

| | | Collision | | Collision | | |
|---|---|---|---|---|---|---|
| Compound | Transition 1 | Energy 1 | Transition 2 | Energy 2 | LOD (ug/L) | LOD (ppm) |
| 1-heptanol | 70−>55 | 5 | 69−>41 | 10 | 0.1 | 0.0001 |
| 1-octanol | 56.0−>41.0 | 15 | 70.0−>55.0 | 15 | 0.01 | 0.00001 |
| l-octen-3-ol | 57.0−>31.0 | 25 | 72.0−>43.0 | 15 | 0.01 | 0.00001 |
| 2,3,5,6-tetramethylpyrazine | 136−>54 | 15 | 136−>95 | 5 | 0.01 | 0.00001 |
| 2,3,5-trimethylpyrazine | 122−>81 | 5 | 122−>42 | 20 | 1 | 0.001 |
| 2,3-butanediol | 45−>29 | 15 | 45−>27 | 15 | 10 | 0.01 |
| 2,3-butanedione | 86−>43 | 5 | 43−>42 | 15 | | |
| 2,3-diethyl-5-methylpyrazine | 150−>135 | 10 | 149−>133 | 20 | 1 | 0.001 |
| 2,3-diethylpyrazine | 136−>121 | 10 | 121−>120 | 15 | 0.1 | 0.0001 |
| 2,3-dimethylpyrazine | 108−>67 | 15 | 67−>26 | 20 | 1 | 0.001 |
| 2,3-Hexanedione | 71−>43 | 5 | 114−>71 | 5 | | |
| 2,3-pentadione | 100.0−>57.0 | 5 | 57.0−>42.0 | 30 | 100 | 0.1 |
| 2,5-dimethylphenol | 122−>107 | 15 | 108−>78 | 10 | 0.1 | 0.0001 |
| 2,5-dimethylpyrazine | 108−>42 | 15 | 108−>81 | 10 | 10 | 0.01 |
| 2,6-dimethylpyrazine | 108−>42 | 20 | 108−>107 | 15 | 1 | 0.001 |
| 2-acetyl-1-methylpyrrole | 123−>108 | 10 | 108−>53 | 20 | 0.001 | 0.000001 |
| 2-acetyl-5-methylfuran | 124−>109 | 5 | 109−>53 | 15 | 0.1 | 0.0001 |
| 2-acetylpyridine | 121−>93 | 5 | 79−>52 | 10 | 1 | 0.001 |
| 2-acetylpyrrole | 109−>94 | 10 | 94−>66 | 5 | 100 | 0.1 |
| 2-ethyl-1-hexanol | 83−>55 | 5 | 70−>55 | 10 | 0.1 | 0.0001 |
| 2-ethyl-3-methylpyrazine | 122−>121 | 10 | 121−>93 | 15 | | |
| 2-ethylfuran | 96−>81 | 10 | 81−>53 | 10 | 0.1 | 0.0001 |
| 2-ethylpyrazine | 108−>107 | 10 | 107−>79 | 15 | 1 | 0.001 |
| 2-furfuryl acetate | 140−>98 | 5 | 98−>70 | 5 | 1 | 0.001 |
| 2-heptanol | 83−>55 | 5 | 70−>55 | 10 | 1 | 0.001 |
| 2-heptanone | 58.0−>43.0 | 15 | 71.0−>43.0 | 15 | 0.01 | 0.00001 |
| 2-isopropyl-3- | 152−>137 | 5 | 137−>109 | 10 | 0.01 | 0.00001 |
| methoxypyrazine | | | | | | |
| 2-methoxy-4-methylphenol | 123−>95 | 5 | 138−>123 | 5 | 0.001 | 0.000001 |
| 2-methoxy-4-vinylphenol | 135−>107 | 5 | 150−>135 | 10 | 0 | 0 |
| 2-methylbutyl isovalerate | 85.0−>57.0 | 10 | 70.0−>55.0 | 10 | 0.1 | 0.0001 |
| 2-methylbutyraldehyde | 58−>31 | 25 | 57−>39 | 25 | 1 | 0.001 |
| 2-methylbutyric acid | 74−>73 | 10 | 87−>59 | 10 | 1 | 0.001 |
| 2-methylpyrazine | 94−>67 | 15 | 67−>26 | 15 | 100 | 0.1 |
| 2-nonanol | 83.0−>55.0 | 10 | 98.0−>56.0 | 10 | 0.1 | 0.0001 |
| 2-nonanone | 71.0−>43.0 | 15 | 58.0−>43.0 | 15 | 0.01 | 0.00001 |
| 2-octanol | 97−>55 | 5 | 45−>27 | 20 | 0.001 | 0.000001 |
| 2-octanone | 71−>43 | 20 | 58−>43 | 10 | 0.01 | 0.00001 |
| 2-pentanol | 73−>55 | 5 | 55−>29 | 5 | 1 | 0.001 |
| 2-pentylfuran | 138−>81 | 10 | 81−>53 | 10 | 0.01 | 0.00001 |
| 2-phenyl-2-butenal | 146−>117 | 10 | 117−>115 | 10 | 0.01 | 0.00001 |
| 2-phenylethanol | 122.0−>91.0 | 15 | 92.0−>65.0 | 25 | 1 | 0.001 |
| 2-phenylpropionaldehyde | 105−>77 | 20 | 105−>78 | 15 | 0.1 | 0.0001 |
| 2-tridecanone | 71−>43 | 5 | 58−>43 | 10 | 0.1 | 0.0001 |
| 2-undecanone | 58.0−>43.0 | 25 | 71.0−>43.0 | 25 | 0.1 | 0.0001 |
| 3-ethylpyridine | 107−>106 | 10 | 96−>65 | 10 | 1 | 0.001 |
| 3-hexanone | 100−>43 | 10 | 71−>43 | 10 | 1 | 0.001 |
| 3-octanol | 83−>55 | 5 | 59−>31 | 5 | 0.01 | 0.00001 |
| 3-octanone | 99−>43 | 5 | 72−>43 | 5 | 0.001 | 0.000001 |
| 4-carvomenthenol | 111.0−>77.0 | 25 | 71.0−>43.0 | 25 | 0.1 | 0.0001 |
| 4-ethyl guaiacol | 137.0−>66.0 | 35 | 152.0−>94.0 | 35 | 1 | 0.001 |
| 4-ethylphenol | 108.0−>78.0 | 25 | 121.0−>77.0 | 25 | | |
| 4-methyl-2-phenyl-2-pentenal | 174−>103 | 15 | 103−>77 | 15 | 0.01 | 0.00001 |
| 4′-methylacetophenone | 119−>91 | 10 | 134−>119 | 10 | 0.1 | 0.0001 |
| 4-vinylphenol | 120−>91 | 15 | 91−>65 | 15 | 1 | 0.001 |
| 5-methyl-2-phenyl-2-hexenal | 117−>115 | 15 | 104−>78 | 10 | 0.01 | 0.00001 |
| 5-methylfurfural | 110−>109 | 10 | 109−>53 | 10 | 10 | 0.01 |
| amyl acetate | 70−>29 | 15 | 70−>55 | 5 | 0.001 | 0.000001 |
| amyl alcohol | 70.0−>55.0 | 5 | 55.0−>53.0 | 35 | 1 | 0.001 |
| benzaldehyde | 105−>51 | 35 | 106−>77 | 35 | 0.1 | 0.0001 |
| benzyl acetate | 108.0−>79.0 | 15 | 91.0−>56.0 | 35 | 0.1 | 0.0001 |
| benzyl alcohol | 108−>79 | 15 | 79−>51 | 25 | 0 | 0 |
| benzyl isovalerate | 108−>107 | 10 | 108−>79 | 15 | 0.01 | 0.00001 |
| beta-damascenone | 121−>77 | 20 | 69−>41 | 20 | | |
| beta-ionone | 177.0−>147.0 | 35 | 135.0−>43.0 | 35 | 0 | 0 |
| butyl acetate | 56.0−>41.0 | 15 | 73.0−>43.0 | 5 | 0.01 | 0.00001 |
| butyl alcohol | 56.0−>41.0 | 10 | 56.0−>39.0 | 15 | 0 | 0 |
| butyric acid | 73−>55 | 10 | 60−>42 | 10 | 1 | 0.001 |
| nut butter furanone | 100−>73 | 5 | 72−>43 | 5 | 100 | 0.1 |
| damascenone | 121−>77 | 20 | 69−>41 | 20 | 0.01 | 0.00001 |
| decanal | 82−>67 | 15 | 57−>41 | 25 | 0.1 | 0.0001 |
| delta-decalactone | 99−>43 | 10 | 71−>41 | 25 | | |
| diethyl disulfide | 122−>94 | 5 | 94−>66 | 5 | 0.1 | 0.0001 |
| diethyl succinate | 129−>101 | 5 | 101−>73 | 5 | 0.01 | 0.00001 |
| difurfuryl ether | 82−>54 | 10 | 81−>53 | 10 | 1 | 0.001 |
| dimethyl sulfide | 62−>47 | 15 | 61−>35 | 5 | 1 | 0.001 |
| dimethyl sulfoxide | 78−>63 | 10 | 63−>45 | 10 | 0.1 | 0.0001 |
| dimethyl trisulfide | 126−>79 | 15 | 126−>61 | 5 | 0.01 | 0.00001 |
| ethyl 2-methylbutyrate | 102.0−>74.0 | 10 | 85.0−>57.0 | 5 | 0.1 | 0.0001 |
| ethyl 3-phenylpropionate | 178−>104 | 5 | 107−>79 | 10 | 0.001 | 0.000001 |
| ethyl acetate | 61.0−>43.0 | 15 | 45.0−>43.0 | 35 | 1 | 0.001 |
| ethyl benzoate | 105.0−>77.0 | 10 | 150.0−>77.0 | 10 | 0.01 | 0.00001 |
| ethyl butanoate | 71.0−>43.0 | 10 | 88.0−>61.0 | 10 | 0.1 | 0.0001 |
| ethyl cinnamate | 131.0−>103.0 | 10 | 131.0−>77.0 | 25 | 0.1 | 0.0001 |
| ethyl decanoate | 88.0−>43.0 | 20 | 61.0−>43.0 | 20 | 0.01 | 0.00001 |
| ethyl heptanoate | 88.0−>61.0 | 15 | 113.0−>57.0 | 10 | 0.1 | 0.0001 |
| ethyl hexanoate | 88.0−>61.0 | 5 | 99.0−>43.0 | 5 | 0.01 | 0.00001 |
| ethyl isobutyrate | 71.0−>43.0 | 10 | 43.0−>27.0 | 20 | 0.1 | 0.0001 |
| ethyl isovalerate | 88.0−>61.0 | 5 | 70.0−>55.0 | 5 | 0.001 | 0.000001 |
| ethyl lactate | 45.0−>27.0 | 15 | 45.0−>29.0 | 15 | 10 | 0.01 |
| ethyl laurate | 88.0−>61.0 | 15 | 101.0−>55.0 | 25 | 0.01 | 0.00001 |
| ethyl myristate | 101.0−>73.0 | 5 | 88.0−>61.0 | 5 | 5 | 0.005 |
| ethyl octanoate | 88.0−>43.0 | 25 | 101.0−>55.0 | 25 | 0.1 | 0.0001 |
| ethyl oleate | 97−>55 | 10 | 101−>73 | 10 | 15 | 0.015 |
| ethyl phenylacetate | 164.0−>91.0 | 10 | 91.0−>65.0 | 35 | 0.0001 | 0.0000001 |
| ethyl salicylate | 120.0−>92.0 | 10 | 166.0−>120.0 | 10 | 0.001 | 0.000001 |
| ethyl tiglate | 83−>55 | 5 | 100−>82 | 5 | 0.1 | 0.0001 |
| ethyl valerate | 88.0−>61.0 | 10 | 57.0−>41.0 | 10 | 0.001 | 0.000001 |
| eugenol | 164.0−>149.0 | 10 | 164.0−>104.0 | 15 | | |
| furfural | 96−>95 | 25 | 95−>53 | 35 | 1 | 0.001 |
| furfuryl propionate | 154−>98 | 5 | 81−>53 | 10 | 0.1 | 0.0001 |
| gamma-decalactone | 99.0−>43.0 | 25 | 71.0−>41.0 | 25 | 5 | 0.005 |
| gamma-nonalactone | 85.0−>57.0 | 25 | 114.0−>70.0 | 25 | 0 | 0 |
| gamma-valerolactone | 85−>57 | 5 | 56−>41 | 5 | 5 | 0.005 |
| geraniol | 69.0−>41.0 | 30 | 93.0−>51.0 | 15 | 0.1 | 0.0001 |
| geranyl acetate | 136−>121 | 5 | 121−>93 | 5 | 0.001 | 0.000001 |
| guaiacol | 109.0−>81.0 | 15 | 124.0−>109.0 | 15 | 0.01 | 0.00001 |
| hexanal | 56−>39 | 15 | 57−>31 | 25 | 1 | 0.001 |
| hexanol | 56.0−>41.0 | 15 | 69.0−>41.0 | 15 | 1 | 0.001 |
| hexyl acetate | 69.0−>41.0 | 15 | 84.0−>69.0 | 5 | 0.01 | 0.00001 |
| indole | 117−>90 | 10 | 90−>89 | 10 | | |
| isoamyl acetate | 70.0−>55.0 | 10 | 55.0−>29.0 | 10 | 0 | 0 |
| isoamyl alcohol | 70.0−>55.0 | 15 | 55.0−>39.0 | 15 | 0 | 0 |
| isoamyl benzoate | 105−>77 | 10 | 123−>79 | 10 | 0 | 0 |
| isoamyl butyrate | 70−>55 | 10 | 71−>43 | 5 | 0.001 | 0.000001 |
| isoamyl isobutyrate | 70.0−>55.0 | 10 | 115.0−>71.0 | 5 | 5 | 0.005 |
| isobutyl acetate | 73.0−>43.0 | 5 | 56.0−>41.0 | 15 | 0 | 0 |
| isobutyl alcohol | 43.0−>39.0 | 35 | 74.0−>41.0 | 25 | 100 | 0.1 |
| isobutyraldehyde | 72.0−>43.0 | 5 | 72.0−>57.0 | 5 | 5 | 0.005 |
| isobutyric acid | 88−>73 | 5 | 73−>55 | 20 | 1 | 0.001 |
| isoeugenol | 164−>104 | 15 | 164−>149 | 10 | | |
| isovaleraldehyde | 58−>31 | 25 | 71−>41 | 25 | 0.01 | 0.00001 |
| isovaleric acid | 87−>41 | 15 | 60−>42 | 25 | 1 | 0.001 |
| limonene | 93.0−>77.0 | 15 | 68.0−>53.0 | 15 | 0 | 0 |
| linalool | 71.0−>43.0 | 15 | 55.0−>39.0 | 25 | 0.001 | 0.000001 |
| maltol | 126−>71 | 20 | 71−>43 | 10 | 1 | 0.001 |
| massoia lactone | 97−>69 | 5 | 68−>41 | 10 | 0.1 | 0.0001 |
| methional | 76−>61 | 5 | 104−>48 | 10 | 1 | 0.001 |
| methyl 2-methylbutyrate | 101−>69 | 5 | 88−>57 | 5 | 5 | 0.005 |
| methyl anthranilate | 151−>119 | 10 | 119−>92 | 5 | 1 | 0.001 |
| methyl benzoate | 105−>77 | 5 | 136−>105 | 5 | 0.01 | 0.00001 |
| methyl cinnamate | 103−>77 | 10 | 131−>103 | 10 | 0 | 0 |
| methyl hexanoate | 74.0−>43.0 | 15 | 87.0−>55.0 | 15 | 0.01 | 0.00001 |
| methyl nicotinate | 137−>106 | 10 | 106−>78 | 10 | 0.1 | 0.0001 |
| methyl phenylacetate | 150−>91 | 5 | 91−>65 | 20 | 0.001 | 0.000001 |
| methyl salicylate | 92.0−>63.0 | 25 | 120.0−>64.0 | 15 | 0 | 0 |
| myrcene | 69.0−>41.0 | 10 | 93.0−>77.0 | 25 | 0 | 0 |
| nonanal | 98−>56 | 5 | 57−>39 | 15 | 0.01 | 0.00001 |
| octanal | 84−>55 | 10 | 84−>69 | 5 | 0 | 0 |
| p-anisaldehyde | 135−>77 | 25 | 77−>51 | 25 | 1 | 0.001 |
| p-cresol | 107−>77 | 20 | 108−>107 | 15 | 0 | 0 |
| phenethyl acetate | 104.0−>78.0 | 25 | 91.0−>65.0 | 35 | 0.01 | 0.00001 |
| phenylacetaldehyde | 120−>91 | 10 | 91−>65 | 15 | 1 | 0.001 |
| propanol | 59.0−>31.0 | 10 | 42.0−>39.0 | 35 | 5 | 0.005 |
| propionaldehyde | 58−>57 | 5 | 57−>29 | 10 | 100 | 0.1 |
| propionic acid | 73−>55 | 10 | 74−>45 | 35 | 1 | 0.001 |
| propyl propionate | 87−>57 | 5 | 75−>57 | 5 | 0.1 | 0.0001 |
| pyridine | 52−>51 | 10 | 52−>50 | 10 | 10 | 0.01 |
| pyrrole | 67−>41 | 20 | 67−>28 | 20 | 0.1 | 0.0001 |
| sotolon | 128−>83 | 5 | 83−>55 | 5 | 10 | 0.01 |
| syringol | 154−>139 | 15 | 139−>93 | 5 | 1 | 0.001 |
| trans,trans-2,4-decadienal | 152−>81 | 5 | 81−>53 | 15 | 0.01 | 0.00001 |
| trans-2-nonenal | 83−>55 | 5 | 70−>69 | 5 | 0.1 | 0.0001 |
| valeraldehyde | 58−>57 | 10 | 57−>29 | 5 | 10 | 0.01 |
| valeric acid | 73−>55 | 15 | 60−>42 | 15 | 1 | 0.001 |
| vanillin | 152−>151 | 10 | 151−>123 | 5 | 1 | 0.001 |
| vanillyl ethyl ether | 137.0−>94.0 | 20 | 182.0−>138.0 | 5 | | |

TABLE 8
GCMS of reference nut butters

| | 1 | 2 | 3 | 4 | 5 | 6 | 7 |
|---|---|---|---|---|---|---|---|
| 2,3,5-trimethylpyrazine | 3.92E−01 | 3.01E−01 | 0.00E+00 | 2.73E+00 | 2.33E+00 | 3.33E−01 | 1.36E+00 |
| 2,3-diethyl-5-methylpyrazine | 3.98E−02 | 2.46E−02 | 6.86E−03 | 6.28E−02 | 1.02E−01 | 3.62E−02 | 6.92E−02 |
| 2,3-diethylpyrazine | 3.04E−03 | 0.00E+00 | 6.16E−04 | 3.56E−02 | 1.21E−02 | 0.00E+00 | 6.72E−03 |
| 2,5-dimethylpyrazine | 1.53E+00 | 8.01E−01 | 2.24E−01 | 4.05E+00 | 4.65E+00 | 3.08E+00 | 4.16E+00 |
| 2,6-dimethylpyrazine | 3.35E−01 | 2.29E−01 | 2.87E−02 | 1.88E+00 | 1.75E+00 | 2.58E−01 | 1.27E+00 |
| 2,3-dimethylpyrazine | 4.10E−02 | 4.98E−02 | 9.55E−03 | 2.37E−01 | 2.57E−01 | 1.00E−01 | 2.08E−01 |
| 2-ethyl-3-methylpyrazine | 4.14E−02 | 2.54E−02 | 6.89E−04 | 2.24E−01 | 1.72E−01 | 4.24E−03 | 8.72E−02 |
| 2-ethylpyrazine | 3.27E−02 | 8.51E−03 | 3.08E−02 | 1.66E−01 | 1.26E−01 | 1.04E−01 | 8.78E−02 |
| 2-methylpyrazine | 2.87E−01 | 2.40E−01 | 4.89E−02 | 1.61E+00 | 2.11E+00 | 2.76E−01 | 1.68E+00 |
| isopropenyl pyrazine | 0.00E+00 | 0.00E+00 | 0.00E+00 | 0.00E+00 | 0.00E+00 | 0.00E+00 | 0.00E+00 |
| tetramethylpyrazine | 4.15E−03 | 0.00E+00 | 2.49E−04 | 1.68E−02 | 2.52E−02 | 5.58E−03 | 1.64E−02 |
| (E,E)-2,4-decadienal | 0.00E+00 | 0.00E+00 | 6.81E−01 | 1.22E+00 | 9.75E+00 | 1.90E+00 | 5.72E+00 |
| 1-octen-3-ol | 3.36E−01 | 1.02E−01 | 6.18E−01 | 3.99E−01 | 6.47E−02 | 3.66E−02 | 1.30E−02 |
| 2-ethyl furan | 3.14E−03 | 2.50E−02 | 0.00E+00 | 3.17E−03 | 9.94E−03 | 1.38E−02 | 7.29E−03 |
| 2-heptanone | 5.36E−02 | 4.36E−02 | 4.82E−01 | 1.20E−01 | 1.17E−01 | 2.03E−01 | 2.04E−03 |
| 5-methylfurfural | 3.74E−02 | 1.23E−02 | 2.03E−02 | 4.91E−02 | 3.50E−02 | 2.41E−02 | 1.66E−02 |
| benzaldehyde | 5.22E−01 | 4.22E−01 | 6.11E−01 | 1.35E+00 | 1.25E+00 | 9.91E−01 | 8.71E−01 |
| coffee furanone | 3.51E−01 | 9.69E−03 | 1.39E−01 | 1.69E−01 | 3.15E−01 | 1.03E−01 | 5.59E−02 |
| cyclopentanone | 7.19E−03 | 0.00E+00 | 7.49E−03 | 8.34E−03 | 1.18E−02 | 4.54E−02 | 1.42E−02 |
| dimethyl trisulfide (DMTS) | 1.33E−03 | 1.70E−03 | 2.54E−03 | 9.19E−03 | 4.27E−02 | 1.58E−02 | 7.40E−03 |
| furfural | 2.13E+00 | 6.46E−01 | 1.64E+00 | 1.62E+00 | 4.43E−01 | 5.39E−01 | 4.67E−01 |
| gamma-decalactone | 0.00E+00 | 0.00E+00 | 0.00E+00 | 0.00E+00 | 0.00E+00 | 0.00E+00 | 0.00E+00 |
| limonene | 0.00E+00 | 1.42E+00 | 0.00E+00 | 4.43E+00 | 1.51E+00 | 0.00E+00 | 0.00E+00 |
| pyridine | 2.56E−02 | 9.14E−03 | 3.12E−02 | 1.39E−02 | 1.97E−02 | 2.70E−02 | 1.32E−02 |

| | 9 | 10 | 11 | 12 | 13 | 14 | 15 | 16 |
|---|---|---|---|---|---|---|---|---|
| 2,3,5-trimethylpyrazine | 2.95E−01 | 4.07E−02 | 2.95E−04 | 1.81E−01 | 1.92E+00 | 3.20E+00 | 9.84E−01 | 1.26E+00 |
| 2,3-diethyl-5-methylpyrazine | 4.61E−02 | 4.36E−03 | 4.61E−05 | 3.15E−02 | 7.36E−02 | 8.23E−02 | 6.89E−02 | 4.29E−02 |
| 2,3-diethylpyrazine | 1.96E−03 | 1.35E−03 | 1.96E−06 | 1.41E−03 | 7.16E−03 | 3.07E−02 | 0.00E+00 | 0.00E+00 |
| 2,5-dimethylpyrazine | 2.02E+00 | 1.04E−01 | 2.02E−03 | 1.03E+00 | 5.51E+00 | 4.41E+00 | 5.36E+00 | 3.15E+00 |
| 2,6-dimethylpyrazine | 4.13E−01 | 6.77E−02 | 4.13E−04 | 2.30E−01 | 1.67E+00 | 1.85E+00 | 1.44E+00 | 1.04E+00 |
| 2,3-dimethylpyrazine | 6.96E−02 | 1.17E−02 | 6.96E−05 | 3.81E−02 | 2.70E−01 | 2.62E−01 | 2.25E−01 | 1.46E−01 |
| 2-ethyl-3-methylpyrazine | 4.09E−02 | 2.95E−03 | 4.09E−05 | 1.82E−02 | 1.60E−01 | 2.54E−01 | 7.39E−02 | 8.18E−02 |
| 2-ethylpyrazine | 8.54E−02 | 9.64E−04 | 8.54E−05 | 7.50E−03 | 4.21E−01 | 2.45E−01 | 8.32E−02 | 1.15E−01 |
| 2-methylpyrazine | 5.60E−01 | 8.01E−02 | 5.60E−04 | 2.83E−01 | 1.63E+00 | 1.90E+00 | 1.78E+00 | 9.97E−01 |
| isopropenyl pyrazine | 0.00E+00 | 0.00E+00 | 0.00E+00 | 0.00E+00 | 0.00E+00 | 0.00E+00 | 0.00E+00 | 0.00E+00 |
| tetramethylpyrazine | 4.02E−03 | 7.12E−04 | 4.02E−06 | 9.07E−03 | 1.52E−02 | 2.88E−02 | 9.89E−03 | 1.15E−02 |
| (E,E)-2,4-decadienal | 0.00E+00 | 0.00E+00 | 0.00E+00 | 0.00E+00 | 0.00E+00 | 6.30E−01 | 5.04E+00 | 2.24E+00 |
| 1-octen-3-ol | 8.83E−02 | 1.88E−02 | 9.97E−01 | 1.68E−01 | 5.20E−02 | 5.92E−02 | 3.11E−01 | 8.03E−02 |
| 2-ethyl furan | 4.84E−02 | 7.73E−03 | 9.51E−03 | 8.22E−03 | 1.45E−02 | 9.52E−03 | 3.59E−02 | 4.48E−03 |
| 2-heptanone | 1.67E−01 | 1.29E−01 | 1.03E+00 | 1.39E−01 | 8.85E−02 | 1.59E−02 | 1.90E−01 | 8.12E−03 |
| 5-methylfurfural | 2.86E−02 | 2.24E−02 | 1.82E−01 | 2.80E−02 | 1.97E−02 | 4.37E−02 | 5.72E−02 | 2.34E−02 |
| benzaldehyde | 5.02E−01 | 3.97E−01 | 1.38E+00 | 5.35E−01 | 1.88E+00 | 1.09E+00 | 2.76E+00 | 7.94E−01 |
| coffee furanone | 2.59E−01 | 2.08E−01 | 1.18E+00 | 4.06E−01 | 2.54E−01 | 1.55E−01 | 4.50E−01 | 9.08E−02 |
| cyclopentanone | 1.17E−02 | 1.86E−03 | 8.08E−02 | 9.37E−03 | 1.78E−02 | 1.63E−02 | 1.41E−02 | 8.16E−03 |
| dimethyl trisulfide (DMTS) | 6.30E−03 | 1.25E−03 | 0.00E+00 | 2.37E−03 | 1.66E−02 | 1.32E−02 | 0.00E+00 | 1.65E−02 |
| furfural | 1.90E+00 | 2.18E+00 | 1.68E+01 | 2.83E+00 | 1.42E+00 | 2.74E+00 | 1.53E+00 | 1.20E+00 |
| gamma-decalactone | 0.00E+00 | 0.00E+00 | 0.00E+00 | 0.00E+00 | 0.00E+00 | 0.00E+00 | 0.00E+00 | 0.00E+00 |
| limonene | 2.23E+00 | 4.50E+00 | 1.29E+01 | 9.62E+00 | 1.64E+00 | 1.89E+00 | 3.55E+00 | 3.28E+00 |
| pyridine | 2.01E−02 | 2.16E−02 | 1.26E−01 | 2.86E−02 | 2.40E−02 | 2.70E−02 | 3.96E−02 | 2.11E−02 |

TABLE 9
Exemplary Nut butter replica formulations

| | Percent by weight |
|---|---|
| | (% w/w) |
| Flavor components including VOCs | 0.005-2.0 |
| Susbtrate (e.g. grape seed, sunflower seed, plant oils, seed meals/flour, plant | 20-99 |
| kernel) | |
| Stabilizer Fat (e.g. hydrogenated oil, palm oil, kernel oil) | 0.0-10 |
| Sweetener (e.g. sucrose, grain syrup) | 0.0-60 |
| Salt | 0.0-2.0 |
| Cocoa (e.g. cocoa powder, cocoa butter, chocolate) | 0.0-50 |
| Emulsifier (e.g. lecithin) | 0.0-2.0 |
| Other Nonvolatiles and Flavors (e.g. amino acids) | 0.0-0.5 |
| Liquid (e.g., water, milk, plant-based milk, or a combination thereof) | 0.0-20 |

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A nut butter replica comprising:
one or more isolated volatile organic compounds (VOCs); and
one or more isolated non-volatile compounds;
wherein:
a) the one or more isolated VOCs comprise at least one VOC that is not present in a corresponding reference nut butter,
b) the one or more isolated VOCs do not comprise at least one VOC that is present in a corresponding reference nut butter,
c) the one or more isolated VOCs are present in the nut butter replica in a total amount of at least 100 ppm,
d) the one or more isolated non-volatile compounds comprise at least one non-volatile compound that is not present in a corresponding reference nut butter, or
e) the one or more isolated non-volatile compounds do not comprise at least one non-volatile compound that is present in a corresponding reference nut butter.

2.-6. (canceled)

7. The nut butter replica of claim 1, wherein the one or more isolated VOCs do not comprise at least one compound selected from the group consisting of (+/−) 2-methyl-1-butanol, 1-methyl-1h-pyrrole-2-carboxaldehyde, 1-octen−3-ol, 1-penten−3-one, 2,3,5,6-tetramethylpyrazine, 2,3,5-trimethylpyrazine, 2,3-diethyl-5-methylpyrazine, 2,3-dimethylpyrazine, 2,3-pentanedione, 2,5-dimethylpyrazine, 2-ethyl-6-methylpyrazine, 2-methyl-5-vinylpyrazine (re-gras), 2-methylbutyraldehyde, 2-methylbutyric acid, 2-methylpyrazine, 2-methyltetrahydrofuran−3-one, 2-nonanone, 2-octanone, 2-pentylfuran, 3,5-diethyl-2-methylpyrazine, 3-octen−2-one, 4-hexene-3-one, 4-hydroxy-2-butenoic acid gamma-lactone, 4-methyl-3-penten−2-one, 5-methylfurfural, acetoin, amyl alcohol, benzaldehyde, benzene, 1,3,5-trimethyl-, decanal, furfural, furfuryl alcohol, heptanal, heptyl alcohol, hexanal, hexanoic acid, hexyl alcohol, isoamyl alcohol, isobutyl isobutyrate, methyl 2-pyrrolyl ketone, methylcyclopentenolone, nonanal, nonyl alcohol, phenylacetaldehyde, pyrazine, pyridine, pyrrole, valeraldehyde, 2,3-butanediol, 2-phenyl-2-butenal, 3-ethyl-2,6-dimethylpyrazine, 5,6,7,8-tetrahydroquinoxaline, limonene, d-limonene, heptyl formate, trans-2-heptenal, 1-octanol, 2-acetyl-1-pyrroline, 2-undecenal, benzyl benzoate, cinnamaldehyde, (e)-, piperonal, vanillin, (e,e)-3,5-octadien−2-one, 2-ethyl-5-methylpyrazine, 2-ethylfuran, 2-heptanone, 2-pyrrolidone, caffeine, gamma-nonalactone, maltol, phenethyl acetate, 2-ethylpyrazine, 2-methoxy-4-vinylphenol, 3-octanone, 3-phenylpropionaldehyde, 4-hydroxybutanoic acid lactone, alpha-pinene, delta-3-carene, dihydrocoumarin, ethyl 2-methylbutyrate, ethyl benzoate, gamma-hexalactone, hexyl acetate, isobutyric acid, isovaleric acid, naphthalene, phenethyl alcohol, propylene glycol, styrene, 4-methylthiazole, alpha-phellandrene, methylsulfinylmethane, palmitic acid, pyruvaldehyde, pyruvic acid, 2,5-dimethylfuran, 2-butanone, 2-butylfuran, 2-decanone, 3-hepten−2-one, 4-carvomenthenol, 4-heptanone, 4-methyl-5-thiazoleethanol, 5-ethyl-2,3-dimethylpyrazine, butyric acid, delta-octalactone, gamma-heptalactone, heptanoic acid, methyl heptanoate, methyl hexanoate, methyl octanoate, methyl valerate, octanal, octanoic acid, o-methylanisole, p-mentha-1,4-diene, terpinolene, thiazole, trans-2-hexenal, valeric acid, 1-octen−3-one, 1-penten−3-ol, 3-hexanol, 3-penten−2-one, beta-angelicalactone, nonanoic acid, o-cymene, p-tolyl acetate, tetrahydrofurfuryl alcohol, 1-methylnaphthalene, 3-furaldehyde, 3-methyl-2-cyclohexen−1-one, 1-rhamnose, (e)-2-octen−1-ol, 1-ethyl-2-pyrrolecarboxaldehyde, 1-methylpyrrole, 2-acetyl-2-thiazoline, 2-methylpentanal, 3-n-butylphthalide, 4,5-dihydro-3(2h)thiophenone, 4-hydroxy-2,5-dimethyl-3(2h)-furanone, 4-hydroxy-5-methyl-3(2h)-furanone, 5h-5-methyl-6,7-dihydrocyclopenta(b)pyrazine, 5-isopropyl-2-methylpyrazine, 5-methylfurfuryl alcohol, acetophenone, benzoic acid, cyclopentanone, dimethyl disulfide, dimethyl trisulfide, indole, isopropenylpyrazine, n-furfurylpyrrole, oleic acid, phenethyl butyrate, propionic acid, trimethyloxazole, 2-heptanol, 2-pentanone, 1-tyrosine, methyl nicotinate, 1-nonene, 1-octene, cinnamaldehyde, hydroxyacetone, hexyl formate, phenethyl benzoate, 1-hexadecanol, 1-tetradecanol, 2-ethylhexyl benzoate, benzophenone, butyl isobutyrate, epsilon-decalactone, ethyl decanoate, ethyl laurate, ethyl myristate, ethyl octanoate, ethyl palmitate, guaiacol, lauric acid, methyl acetate, myristic acid, n-capric acid isobutyl ester, pentadecanoic acid, 3-methylbutyl ester, phenethyl decanoate, phenethyl octanoate, propyl p-hydroxybenzoate, stearic acid, 2,6-dimethylpyrazine, 2-acetyl-3-methylpyrazine, benzyl alcohol, menthol racemic, s-methyl thioacetate, 2-methoxy-3(5 and 6)-isopropylpyrazine, glycerol, 2-ethyl-1-hexanol, (tri-)acetin, 5-methyl-2-phenyl-2-hexenal, butyl acetate, undecyl alcohol, isobutyl acetate, propyl acetate, tetrahydrofurfuryl acetate, 2-isobutyl-4,5-dimethyloxazole, 2,6-dimethyl-4-heptanone, 4-methyl-5-vinylthiazole, beta-pinene, 2,3-hexanedione, 3-(methylthio)propionaldehyde, beta-caryophyllene, delta-hexadecalactone, difurfuryl ether, trans,trans-2,4-octadienal, 2-methylheptanoic acid, ethyl nonanoate, 2-heptylfuran, camphene, cyclohexanone, ethyl heptanoate, ethyl hexanoate, ethyl lactate, gamma-valerolactone, heptyl acetate, isopropenyl acetate, methyl butyrate, methyl levulinate, butylamine, methyl nonanoate, 3-methyl-2-butanol, 6-methyl-5-hepten−2-one, isoamyl acetate, 2-acetyl-3-ethylpyrazine, 2-acetylpyridine, butyl butyrate, lauryl alcohol, p-cymene, 3,4-dimethylthiophene, 4-hydroxybenzoic acid, 9-octadecenoic acid, ethyl ester, ethyl pyruvate, isopropylamine, 3-methyl-1-pentanol, 2-oxobutyric acid, 4-methyl-2-phenyl-2-pentenal, 2-acetyl-3,5(and 6)-dimethylpyrazine, trimethylamine, 2(3),5-dimethyl-6,7-dihydro-5h-cyclopentapyrazine, methyl cinnamate, amyl formate, 5-hydroxyundecanoic acid lactone, propiophenone, 2-isopropylpyrazine, 2-ethylbutyl acetate, 2-acetyl-5-methylfuran, acetaldehyde, gamma-decalactone, trans-2-decenol, 4,5-dimethylthiazole, isobutyl butyrate, tridecanoic acid, and 1-mercapto-2-propanone.

8. (canceled)

9. The nut butter replica of claim 1, wherein the one or more VOCs comprise at least one compound selected from the group consisting of 2,3,5-trimethylpyrazine, 2,3-diethylpyrazine, 2,3-diethyl-5-methylpyrazine, 2,5-dimethylpyrazine, 2,6-dimethylpyrazine, 2,3-dimethylpyrazine, 2-ethyl-3-methylpyrazine, 2-ethylpyrazine, 2-methylpyrazine, isopropenyl pyrazine, tetramethylpyrazine, (E,E)-2,4-decadienal, 1-octen−3-ol, 2-ethyl furan, 2-heptanone, 5-methylfurfural, benzaldehyde, coffee furanone, cyclopentanone, dimethyl trisulfide, furfural, gamma-decalactone, limonene, pyridine, isovaleric acid, syringol, valeraldehyde, esters, 4-ethylguaiacol, furfuryl mercaptan, 3-(methylthio)propionaldehyde, 2-methyltetrahydrofuran−3-one, acetic acid, 2-furyl methyl ketone, s-methyl 3-methylbutanethioate, acetoin, methyl sulfide, butyric acid, 4-methyl-5-thiazoleethanol, indole, hexanal, acetophenone, furfuryl alcohol, 2-methoxy-3(5 and 6)-isopropylpyrazine, 4-methyl-5-thiazoleethanol acetate, 2-ethoxy-3-methylpyrazine, pentanal, p-cresol, isobutyraldehyde, delta-octalactone, 5-methyl-2-hepten−4-one, linalool, beta damascenone, eugenol, vanillin, 2,3-pentanedione, 4-hydroxy-2,5-dimethyl-3(2h)-furanone, maltol, 1-lactic acid, 2-ethyl-6-methylpyrazine, 2-acetylpyridine, methional, 3-methylbutyraldehyde, phenylacetaldehyde, phenethyl alcohol, 3,4-Hexanedione, 1-(2-Furanyl)-ethanone, 5-methyl-2-furancarboxaldehyde, 3-methyl-2-butenal, 3-ethyl-3,6-dimethyl-2h-pyrazine, 3-furaldehyde, dihydrocoumarin, 5-hydroxy-2,4-decadienoic acid delta-lactone, 2,2,4-trimethyl-1,3-oxacyclopentane, delta-hexalactone, octanal propyleneglycol acetal, (+/−)-trans- and cis-2-hexenal propylene glycol acetal, 2-isobutyl-4-methyl-1,3-dioxolane, cis- and trans-ethyl 2,4-dimethyl-1,3-dioxolane-2-acetate, and valeraldehyde propyleneglycol acetal.

10. The nut butter replica of claim 1, wherein at least one of the following, in any combination, is true:
(a) 2,3,5-trimethylpyrazine is present in an amount of no greater than about 4 ppm;
(b) 2,3-diethyl-5-methylpyrazine is present in an amount of no greater than about 0.5 ppm;
(c) 2,3-diethylpyrazine is present in an amount of no greater than about 10 ppm;
(d) 2,5-dimethylpyrazine is present in an amount of no greater than about 10 ppm;
(e) 2,6-dimethylpyrazine is present in an amount of no greater than about 10 ppm;
(f) 2,3-dimethylpyrazine is present in an amount of no greater than about 10 ppm, or at least 2.0 ppm;
(g) 2-ethyl-3-methylpyrazine is present in an amount of no greater than about 5.47 ppm;
(h) 2-ethylpyrazine is present in an amount of no greater than about 10 ppm, or at least 6.0 ppm;
(i) 2-methylpyrazine is present in an amount of no greater than about 10 ppm, or at least 6.0 ppm;
(j) 2-methylpyrazine is present in an amount of no greater than about 10 ppm, or at least 6.0 ppm;
(k) 2-methylpyrazine is present in an amount of no greater than about 10 ppm, or at least 6.0 ppm;
(l) isopropenyl pyrazine is present in an amount of no greater than about 10 ppm, or at least 0.05 ppm;
(m) tetramethylpyrazine is present in an amount of no greater than about 10 ppm;
(n) (E,E)-2,4-decadienal is present in an amount of no greater than about 8.92 ppm;
(o) 1-octen−3-ol is present in an amount of no greater than about 6 ppm;
(p) 2-ethyl furan is present in an amount of no greater than about 22.5 ppm;
(q) 2-heptanone is present in an amount of no greater than about 30 ppm, or at least 10 ppm;
(r) 5-methylfurfural is present in an amount of no greater than about 2.25 ppm;
(s) benzaldehyde is present in an amount of no greater than about 171.76 ppm, or at least about 10 ppm;
(t) coffee furanone is present in an amount of no greater than about 10 ppm, or at least about 4.0 ppm;
(u) cyclopentanone is present in an amount of no greater than about 2 ppm;
(v) dimethyl trisulfide is present in an amount of no greater than about 1 ppm;
(w) furfural is present in an amount of no greater than about 52.56 ppm;
(x) gamma-decalactone is present in an amount of no greater than about 20.65 ppm, or at least about 5.0 ppm;
(y) limonene is present in an amount of no greater than about 511 ppm, or at least about 14 ppm;
(z) pyridine is present in an amount of no greater than about 1.68 ppm;
(aa) isovaleric acid is present in an amount of no greater than about 7.76 ppm, or at least 0.7 ppm;
(ab) syringol is present in an amount of no greater than about 5 ppm;
(ac) valeraldehyde is present in an amount of no greater than about 6.15 ppm, or at least about 0.6 ppm;
(ad) 4-ethylguaiacol is present in an amount of no greater than about 12 ppm;
(ae) furfuryl mercaptan is present in an amount of no greater than about 3.55 ppm;
(af) 3-(methylthio)propionaldehyde is present in an amount of no greater than about 4.6 ppm;
(ag) 2-methyltetrahydrofuran−3-one is present in an amount of no greater than about 10 ppm;
(ah) acetic acid is present in an amount of no greater than about 5900 ppm;
(ai) 2-furyl methyl ketone is present in an amount of no greater than about 20 ppm;
(aj) s-methyl 3-methylbutanethioate is present in an amount of no greater than about 0.1 ppm;
(ak) acetoin is present in an amount of no greater than about 50 ppm;
(al) methyl sulfide is present in an amount of no greater than about 1.77 ppm;
(am) butyric acid is present in an amount of no greater than about 200 ppm;
(an) 4-methyl-5-thiazoleethanol is present in an amount of no greater than about 55 ppm;
(ao) indole is present in an amount of no greater than about 1.34 ppm;
(ap) hexanal is present in an amount of no greater than about 9.51 ppm;
(aq) acetophenone is present in an amount of no greater than about 28.25 ppm;
(ar) furfuryl alcohol is present in an amount of no greater than about 19.48 ppm;
(as) 2-methoxy-3(5 and 6)-isopropylpyrazine is present in an amount of no greater than about 0.2 ppm;
(at) 4-methyl-5-thiazoleethanol acetate is present in an amount of no greater than about 55 ppm;
(au) 2-ethoxy-3-methylpyrazine is present in an amount of no greater than about 5 ppm;
(av) pentanal is present in an amount of no greater than about 6.15 ppm;
(aw) p-cresol is present in an amount of no greater than about 7.7 ppm;
(ax) isobutyraldehyde is present in an amount of no greater than about 5.8 ppm;
(ay) delta-octalactone is present in an amount of no greater than about 15.53 ppm;
(az) 5-methyl-2-hepten−4-one is present in an amount of no greater than about 20 ppm;
(ba) linalool is present in an amount of no greater than about 40 ppm;
(bb) beta-damascenone is present in an amount of no greater than about 0.2 ppm;
(bc) eugenol is present in an amount of no greater than about 100 ppm;
(bd) vanillin is present in an amount of no greater than about 407.99 ppm;
(be) 2,3-pentanedione is present in an amount of no greater than about 10.98 ppm;
(bf) 4-hydroxy-2,5-dimethyl-3(2h)-furanone is present in an amount of no greater than about 60 ppm;
(bg) maltol is present in an amount of no greater than about 267.2 ppm;
(bh)1-lactic acid is present in an amount of no greater than about 5000 ppm;
(bi) 2-ethyl-6-methylpyrazine is present in an amount of no greater than about 5 ppm;
(bj) 2-acetylpyridine is present in an amount of no greater than about 3 ppm;
(bk) methional is present in an amount of no greater than about 4.6 ppm;
(bl) 3-methylbutyraldehyde is present in an amount of no greater than about 16.81 ppm;
(bm) phenylacetaldehyde is present in an amount of no greater than about 4.41 ppm;
(bn) phenethyl alcohol is present in an amount of no greater than about 30.01 ppm;
(bo) 3,4-hexanedione is present in an amount of no greater than about 10 ppm;
(bp) 1-(2-furanyl)-ethanone is present in an amount of no greater than about 20 ppm;
(bq) 5-methyl-2-furancarboxaldehyde is present in an amount of no greater than about 2.25 ppm;
(br) 3-methyl-2-butenal is present in an amount of no greater than about 7.25 ppm;
(bs) 3-ethyl-3,6-dimethyl-2h-pyrazine is present in an amount of no greater than about 10 ppm;
(bt) 3-furaldehyde is present in an amount of no greater than about 500 ppm;
(bu) dihydrocoumarin is present in an amount of no greater than about 130.7 ppm; or
(by) 5-hydroxy-2,4-decadienoic acid delta-lactone is present in an amount of no greater than about 0.5 ppm.

11. The nut butter replica of claim 1, wherein the VOCs comprise one or more of: an acid, an alcohol, an alkane, an aldehyde, an amine, a benzene, an ester, a furan, a ketone, a lactone, a phenol, a pyrazine, a pyridine, a pyrrole, a sugar or sugar alcohol, a sulfur compound, a terpene, or a thiophene.

12. (canceled)

13. The nut butter replica of claim 1, wherein the VOCs comprise one or more acids.

14. The nut butter replica of claim 13, wherein the one or more acids comprise at least one acid selected from the group consisting of isovaleric acid, acetic acid, L-lactic acid, butyric acid, 2-methylbutyric acid, 4-hydroxy-2-butenoic acid gamma-lactone, hexanoic acid, 4-hydroxybutanoic acid lactone, isobutyric acid, palmitic acid, pyruvic acid, heptanoic acid, octanoic acid, valeric acid, nonanoic acid, benzoic acid, oleic acid, propionic acid, lauric acid, myristic acid, n-capric acid isobutyl ester, pentadecanoic acid, 3-methylbutyl ester, stearic acid, 2-methylheptanoic acid, 4-hydroxybenzoic acid, 9-octadecenoic acid, ethyl ester, 2-oxobutyric acid, 5-hydroxyundecanoic acid lactone, and tridecanoic acid, or any combination thereof.

15. (canceled)

16. The nut butter replica of claim 1, wherein the VOCs comprise one or more alcohols.

17. The nut butter replica of claim 16, wherein the one or more alcohols comprise at least one alcohol selected from the group consisting of 1-octen−3-ol, furfuryl alcohol, p-cresol, eugenol, phenethyl alcohol, 4-methyl-5-thiazoleethanol, (+/−) 2-methyl-1-butanol, amyl alcohol, heptyl alcohol, hexyl alcohol, isoamyl alcohol, nonyl alcohol, 2,3-butanediol, 1-octanol, 2-methoxy-4-vinylphenol, propylene glycol, 4-carvomenthenol, 1-penten−3-ol, 3-hexanol, tetrahydrofurfuryl alcohol, (e)-2-octen−1-ol, 5-methylfurfuryl alcohol, 2-heptanol, 1-hexadecanol, 1-tetradecanol, guaiacol, benzyl alcohol, glycerol, 2-ethyl-1-hexanol, undecyl alcohol, 3-methyl-2-butanol, lauryl alcohol, 3-methyl-1-pentanol, and trans-2-decenol, or any combination thereof.

18. (canceled)

19. The nut butter replica of claim 1, wherein the VOCs comprise one or more aldehydes.

20. The nut butter replica of claim 19, wherein the one or more aldehydes comprise at least one aldehyde selected from the group consisting of (E,E)-2,4-decadienal, 5-methylfurfural, benzaldehyde, furfural, valeraldehyde, 3-(methylthio)propionaldehyde, hexanal, isobutyraldehyde, vanillin, methional, phenylacetaldehyde, 3-furaldehyde, pentanal, 3-methylbutyraldehyde, 3-methyl-2-butenal, 4-methyl-5-thiazoleethanol acetate, 5-methyl-2-furancarboxaldehyde, 1-methyl-1h-pyrrole-2-carboxaldehyde, 2-methylbutyraldehyde, decanal, heptanal, nonanal, 2-phenyl-2-butenal, trans-2-heptenal, 2-undecenal, piperonal, 3-phenylpropionaldehyde, pyruvaldehyde, octanal, trans-2-hexenal, 1-ethyl-2-pyrrolecarboxaldehyde, 2-methylpentanal, cinnamaldehyde, 5-methyl-2-phenyl-2-hexenal, trans,trans-2,4-octadienal, 4-methyl-2-phenyl-2-pentenal, acetaldehyde, octanal propyleneglycol acetal, (+/−)-trans- and cis-2-hexenal propylene glycol acetal, and valeraldehyde propyleneglycol acetal, or any combination thereof.

21. (canceled)

22. The nut butter replica of claim 1, wherein the VOCs comprise one or more amines.

23. The nut butter replica of claim 22, wherein the one or more amines comprise at least one amine selected from the group consisting of 2-amino-1-naphthalenol, 2-methoxy-benzenamine, 5-amino-1-naphthol, N,N-dimethyl-ethanamine, and N,N-dimethyl-methylamine, or any combination thereof.

24. The nut butter replica of claim 1, wherein the VOCs comprise one or more benzenes.

25. The nut butter replica of claim 24, wherein the one or more benzenes comprise at least one benzene selected from the group consisting of dihydrocoumarin, styrene and toluene, or a combination thereof.

26. The nut butter replica of claim 1, wherein the VOCs comprise one or more esters.

27. The nut butter replica of claim 26, wherein the one or more esters comprise at least one ester selected from the group consisting of isobutyl isobutyrate, heptyl formate, benzyl benzoate, phenethyl acetate, ethyl 2-methylbutyrate, ethyl benzoate, hexyl acetate, methyl heptanoate, methyl hexanoate, methyl octanoate, methyl valerate, p-tolyl acetate, phenethyl butyrate, methyl nicotinate, hexyl formate, phenethyl benzoate, 2-ethylhexyl benzoate, butyl isobutyrate, ethyl decanoate, ethyl laurate, ethyl myristate, ethyl octanoate, ethyl palmitate, methyl acetate, phenethyl decanoate, phenethyl octanoate, propyl p-hydroxybenzoate, s-methyl thioacetate, butyl acetate, isobutyl acetate, propyl acetate, tetrahydrofurfuryl acetate, ethyl nonanoate, ethyl heptanoate, ethyl hexanoate, ethyl lactate, heptyl acetate, isopropenyl acetate, methyl butyrate, methyl levulinate, methyl nonanoate, isoamyl acetate, butyl butyrate, ethyl pyruvate, methyl cinnamate, amyl formate, 2-ethylbutyl acetate, and isobutyl butyrate, or any combination thereof.

28. The nut butter replica of claim 26, wherein the nut butter replica comprises at least about 0.005 ppm of esters.

29. The nut butter replica of claim 1, wherein the VOCs comprise one or more furans.

30. The nut butter replica of claim 29, wherein the one or more furans comprise at least one furan selected from the group consisting of 2-ethyl furan, 1-(2-furanyl)-ethanone, 2-pentylfuran, 2,5-dimethylfuran, 2-butylfuran, 2-heptylfuran, and 2-acetyl-5-methylfuran, or any combination thereof.

31. (canceled)

32. The nut butter replica of claim 1, wherein the VOCs comprise one or more ketones.

33. The nut butter replica of claim 32, wherein the one or more ketones comprise at least one ketone selected from the group consisting of 2-heptanone, coffee furanone, cyclopentanone, gamma-decalactone, 2-methyltetrahydrofuran−3-one, 2-furyl methyl ketone, acetoin, acetophenone, delta-octalactone, 5-methyl-2-hepten−4-one, beta damascenone, 2,3-pentanedione, 4-hydroxy-2,5-dimethyl-3(2h)-furanone, maltol, 3,4-hexanedione, 1-penten−3-one, 2-nonanone, 2-octanone, 3-octen−2-one, 4-hexene-3-one, 4-methyl-3-penten−2-one, methyl 2-pyrrolyl ketone, methylcyclopentenolone, (e,e)-3,5-octadien−2-one, 2-pyrrolidone, gamma-nonalactone, 3-octanone, gamma-hexalactone, 2-butanone, 2-decanone, 3-hepten−2-one, 4-heptanone, gamma-heptalactone, 1-octen−3-one, 3-penten−2-one, beta-angelicalactone, 3-methyl-2-cyclohexen−1-one, 4,5-dihydro-3(2h)thiophenone, 4-hydroxy-5-methyl-3(2h)-furanone, 2-pentanone, hydroxyacetone, benzophenone, epsilon-decalactone, 2,6-dimethyl-4-heptanone, 2,3-hexanedione, delta-hexadecalactone, cyclohexanone, gamma-valerolactone, 6-methyl-5-hepten−2-one, propiophenone, 1-mercapto-2-propanone, and delta-hexalactone, or any combination thereof.

34. (canceled)

35. The nut butter replica of claim 32, wherein the nut butter replica comprises at least about 0.0001 ppm of ketones.

36. The nut butter replica of claim 1, wherein the VOCs comprise one or more lactones.

37. The nut butter replica of claim 36, wherein the one or more lactones comprise at least one lactone selected from the group consisting of 5-hydroxy-2,4-decadienoic acid delta-lactone, 4,5-dimethyl-3-hydroxy-2,5-dihydro-furan−2-one, gamma decalactone, massoia lactone, and sotolone, or any combination thereof.

38. (canceled)

39. The nut butter replica of claim 1, wherein the VOCs comprise one or more phenols.

40. The nut butter replica of claim 39, wherein the one or more phenols comprise at least one phenol selected from the group consisting of syringol, 4-ethylguaiacol, 1-(2-hydroxy-5-methylphenyl)-ethanone, 2,5-dimethylphenol, 2-methoxy-4-methylphenol, 2-methoxy-4-vinylphenol, 2-methoxy-phenol, 2-methyl-phenol, 4-ethyl guaiacol, 4-ethyl phenol, 4-ethyl-2-methoxy-phenol, 4-vinylphenol, eugenol, guaiacol, isoeugenol, p-cresol, phenol, syringol (2,6-dimethoxyphenol), vanillin erythro or threo-butan−2,3-diol acetal, and vanillyl ethyl ether, or any combination thereof.

41. (canceled)

42. The nut butter replica of claim 39, wherein the nut butter replica comprises at least about 0.05 ppm of phenols.

43. The nut butter replica of claim 1, wherein the VOCs comprise one or more pyrazines.

44. The nut butter replica of claim 43, wherein the one or more pyrazines comprise at least one pyrazine selected from the group consisting of 2,3,5-trimethylpyrazine, 2,3-diethylpyrazine, 2,3-diethyl-5-methylpyrazine, 2,5-dimethylpyrazine, 2,6-dimethylpyrazine, 2,3-dimethylpyrazine, 2-ethyl-3-methylpyrazine, 2-ethylpyrazine, 2-methylpyrazine, isopropenyl pyrazine, tetramethylpyrazine, 2-methoxy-3(5 and 6)-isopropylpyrazine, 2-ethoxy-3-methylpyrazine, 2-ethyl-6-methylpyrazine, 3-ethyl-3,6-dimethyl-2h-pyrazine, 2,3,5,6-tetramethylpyrazine, 2-methyl-5-vinylpyrazine (re-gras), 3,5-diethyl-2-methylpyrazine, pyrazine, 3-ethyl-2,6-dimethylpyrazine, 2-ethyl-5-methylpyrazine, 5-ethyl-2,3-dimethylpyrazine, 5h-5-methyl-6,7-dihydrocyclopenta(b)pyrazine, 5-isopropyl-2-methylpyrazine, isopropenylpyrazine, 2-acetyl-3-methylpyrazine, 2-acetyl-3-ethylpyrazine, 2-acetyl-3,5(and 6)-dimethylpyrazine, and 2(3),5-dimethyl-6,7-dihydro-5h-cyclopentapyrazine, and 2-isopropylpyrazine, or any combination thereof.

45. (canceled)

46. The nut butter replica of claim 1, wherein the VOCs comprise one or more pyridines.

47. The nut butter replica of claim 46, wherein the one or more pyridines comprise at least one pyridine selected from the group consisting of 2-acetylpyridine, pyridine, 1-methyl-1,2,3,6-tetrahydropyridine, 1-methyl-piperidine, 2-methyl-pyridine, 3-ethylpyridine, 3-ethyl-pyridine, 3-methyl-pyridine, 3-propyl-pyridine, 3-pyridinol, and methyl nicotinate, or any combination thereof.

48. (canceled)

49. The nut butter replica of claim 46, wherein the nut butter replica comprises no greater than about 1.68 ppm of pyridines.

50. The nut butter replica of claim 1, wherein the VOCs comprise one or more pyrroles.

51. The nut butter replica of claim 50, wherein the one or more pyrroles comprise at least one pyrrole selected from the group consisting of indole, 1-(1H-pyrrol-2-yl)-ethanone, 1-(2-furanylmethyl)-1H-pyrrole, 1-ethyl-1H-pyrrole, 1-methyl-1H-pyrrole, 1-methyl-1H-pyrrole-2-carboxaldehyde, 2-acetyl-1-methylpyrrole, 2-acetylpyrrole, and pyrrole, or any combination thereof.

52. (canceled)

53. The nut butter replica of claim 1, wherein the VOCs comprise one or more sugars or sugar alcohols.

54. The nut butter replica of claim 53, wherein the one or more sugars or sugar alcohols comprise at least one sugars or sugar alcohol selected from the group consisting of ethyl maltol and maltol, or a combination thereof.

55. The nut butter replica of claim 1, wherein the VOCs comprise one or more sulfur compounds.

56. The nut butter replica of claim 55, wherein the one or more sulfur compounds comprise at least one sulfur compound selected from the group consisting of dimethyl trisulfide, methyl sulfide, s-methyl 3-methylbutanethioate, furfuryl mercaptan, diethyl disulfide, dimethyl disulfide, dimethyl sulfide, dimethyl sulfoxide, methanethiol, and methional, or any combination thereof.

57. (canceled)

58. The nut butter replica of claim 1, wherein the VOCs comprise one or more terpenes.

59. The nut butter replica of claim 58, wherein the one or more terpenes comprise at least one terpene selected from the group consisting of limonene, linalool, pyrrole, d-alpha-pinene, delta-3-carene, naphthalene, styrene, 4-methylthiazole, alpha-phellandrene, o-methylanisole, p-mentha-1,4-diene, terpinolene, thiazole, o-cymene, 1-methylnaphthalene, 1-methylpyrrole, indole, n-furfurylpyrrole, trimethyloxazole, 1-nonene, 1-octene, 2-isobutyl-4,5-dimethyloxazole, 4-methyl-5-vinylthiazole, beta-pinene, beta-caryophyllene, camphene, p-cymene, 3,4-dimethylthiophene, and 4,5-dimethylthiazole, or any combination thereof.

60. (canceled)

61. The nut butter replica of claim 1, wherein the VOCs comprise one or more thiophenes.

62. The nut butter replica of claim 1, wherein the VOCs comprise 2,7-dimethyl-oxepine.

63. The nut butter replica of claim 1, wherein the VOCs comprise at least 20, at least 30, at least 40, or at least 50 compounds selected from the group consisting of (+/−) 2-methyl-1-butanol, 1-methyl-1h-pyrrole-2-carboxaldehyde, 1-octen−3-ol, 1-penten−3-one, 2,3,5,6-tetramethylpyrazine, 2,3,5-trimethylpyrazine, 2,3-diethyl-5-methylpyrazine, 2,3-dimethylpyrazine, 2,3-pentanedione, 2,5-dimethylpyrazine, 2-ethyl-6-methylpyrazine, 2-methyl-5-vinylpyrazine (re-gras), 2-methylbutyraldehyde, 2-methylbutyric acid, 2-methylpyrazine, 2-methyltetrahydrofuran−3-one, 2-nonanone, 2-octanone, 2-pentylfuran, 3,5-diethyl-2-methylpyrazine, 3-octen−2-one, 4-hexene-3-one, 4-hydroxy-2-butenoic acid gamma-lactone, 4-methyl-3-penten−2-one, 5-methylfurfural, acetoin, amyl alcohol, benzaldehyde, benzene, 1,3,5-trimethyl-, decanal, furfural, furfuryl alcohol, heptanal, heptyl alcohol, hexanal, hexanoic acid, hexyl alcohol, isoamyl alcohol, isobutyl isobutyrate, methyl 2-pyrrolyl ketone, methylcyclopentenolone, nonanal, nonyl alcohol, phenylacetaldehyde, pyrazine, pyridine, pyrrole, valeraldehyde, 2,3-butanediol, 2-phenyl-2-butenal, 3-ethyl-2,6-dimethylpyrazine, 5,6,7,8-tetrahydroquinoxaline, d-limonene, heptyl formate, trans-2-heptenal, 1-octanol, 2-acetyl-1-pyrroline, 2-undecenal, benzyl benzoate, cinnamaldehyde, (e)-, piperonal, vanillin, (e,e)-3,5-octadien−2-one, 2-ethyl-5-methylpyrazine, 2-ethylfuran, 2-heptanone, 2-pyrrolidone, caffeine, gamma-nonalactone, maltol, phenethyl acetate, 2-ethylpyrazine, 2-methoxy-4-vinylphenol, 3-octanone, 3-phenylpropionaldehyde, 4-hydroxybutanoic acid lactone, alpha-pinene, delta-3-carene, dihydrocoumarin, ethyl 2-methylbutyrate, ethyl benzoate, gamma-hexalactone, hexyl acetate, isobutyric acid, isovaleric acid, naphthalene, phenethyl alcohol, propylene glycol, styrene, 4-methylthiazole, alpha-phellandrene, methylsulfinylmethane, palmitic acid, pyruvaldehyde, pyruvic acid, 2,5-dimethylfuran, 2-butanone, 2-butylfuran, 2-decanone, 3-hepten−2-one, 4-carvomenthenol, 4-heptanone, 4-methyl-5-thiazoleethanol, 5-ethyl-2,3-dimethylpyrazine, butyric acid, delta-octalactone, gamma-heptalactone, heptanoic acid, methyl heptanoate, methyl hexanoate, methyl octanoate, methyl valerate, octanal, octanoic acid, o-methylanisole, p-mentha-1,4-diene, terpinolene, thiazole, trans-2-hexenal, valeric acid, 1-octen−3-one, 1-penten−3-ol, 3-hexanol, 3-penten−2-one, beta-angelicalactone, nonanoic acid, o-cymene, p-tolyl acetate, tetrahydrofurfuryl alcohol, 1-methylnaphthalene, 3-furaldehyde, 3-methyl-2-cyclohexen−1-one, 1-rhamnose, (e)-2-octen−1-ol, 1-ethyl-2-pyrrolecarboxaldehyde, 1-methylpyrrole, 2-acetyl-2-thiazoline, 2-methylpentanal, 3-n-butylphthalide, 4,5-dihydro-3(2h)thiophenone, 4-hydroxy-2,5-dimethyl-3(2h)-furanone, 4-hydroxy-5-methyl-3(2h)-furanone, 5h-5-methyl-6,7-dihydrocyclopenta(b)pyrazine, 5-isopropyl-2-methylpyrazine, 5-methylfurfuryl alcohol, acetophenone, benzoic acid, cyclopentanone, dimethyl disulfide, dimethyl trisulfide, indole, isopropenylpyrazine, n-furfurylpyrrole, oleic acid, phenethyl butyrate, propionic acid, trimethyloxazole, 2-heptanol, 2-pentanone, 1-tyrosine, methyl nicotinate, 1-nonene, 1-octene, cinnamaldehyde, hydroxyacetone, hexyl formate, phenethyl benzoate, 1-hexadecanol, 1-tetradecanol, 2-ethylhexyl benzoate, benzophenone, butyl isobutyrate, epsilon-decalactone, ethyl decanoate, ethyl laurate, ethyl myristate, ethyl octanoate, ethyl palmitate, guaiacol, lauric acid, methyl acetate, myristic acid, n-capric acid isobutyl ester, pentadecanoic acid, 3-methylbutyl ester, phenethyl decanoate, phenethyl octanoate, propyl p-hydroxybenzoate, stearic acid, 2,6-dimethylpyrazine, 2-acetyl-3-methylpyrazine, benzyl alcohol, menthol racemic, s-methyl thioacetate, 2-methoxy-3(5 and 6)-isopropylpyrazine, glycerol, 2-ethyl-1-hexanol, (tri-)acetin, 5-methyl-2-phenyl-2-hexenal, butyl acetate, undecyl alcohol, isobutyl acetate, propyl acetate, tetrahydrofurfuryl acetate, 2-isobutyl-4,5-dimethyloxazole, 2,6-dimethyl-4-heptanone, 4-methyl-5-vinylthiazole, beta-pinene, 2,3-hexanedione, 3-(methylthio)propionaldehyde, beta-caryophyllene, delta-hexadecalactone, difurfuryl ether, trans,trans-2,4-octadienal, 2-methylheptanoic acid, ethyl nonanoate, 2-heptylfuran, camphene, cyclohexanone, ethyl heptanoate, ethyl hexanoate, ethyl lactate, gamma-valerolactone, heptyl acetate, isopropenyl acetate, methyl butyrate, methyl levulinate, butylamine, methyl nonanoate, 3-methyl-2-butanol, 6-methyl-5-hepten−2-one, isoamyl acetate, 2-acetyl-3-ethylpyrazine, 2-acetylpyridine, butyl butyrate, lauryl alcohol, p-cymene, 3,4-dimethylthiophene, 4-hydroxybenzoic acid, 9-octadecenoic acid, ethyl ester, ethyl pyruvate, isopropylamine, 3-methyl-1-pentanol, 2-oxobutyric acid, 4-methyl-2-phenyl-2-pentenal, 2-acetyl-3,5(and 6)-dimethylpyrazine, trimethylamine, 2(3),5-dimethyl-6,7-dihydro-5h-cyclopentapyrazine, methyl cinnamate, amyl formate, 5-hydroxyundecanoic acid lactone, propiophenone, 2-isopropylpyrazine, 2-ethylbutyl acetate, 2-acetyl-5-methylfuran, acetaldehyde, gamma-decalactone, trans-2-decenol, 4,5-dimethylthiazole, isobutyl butyrate, tridecanoic acid, and 1-mercapto-2-propanone.

64. The nut butter replica of claim 1, wherein the VOCs comprise at least 10, at least 20, at least 30, at least 40, or at least 50 compounds selected from the group consisting of 2,3,5-trimethylpyrazine, 2,3-diethyl-5-methylpyrazine, 2,3-diethylpyrazine, 2,5-dimethylpyrazine, 2,6-dimethylpyrazine, 2,3-dimethylpyrazine, 2-ethyl-3-methylpyrazine, 2-ethylpyrazine, 2-methylpyrazine, isopropenyl pyrazine, tetramethylpyrazine, (E,E)-2,4-decadienal, 1-octen−3-ol, 2-ethyl furan, 2-heptanone, 5-methylfurfural, benzaldehyde, coffee furanone, cyclopentanone, DMTS, furfural, gamma-decalactone, limonene, pyridine, 4-ethylguiacol, furfuryl mercaptan, 2-pentanol, methional, acetic acid, 2-furyl methylketone, methyl thio isovalerate, acetoin, 3-methylbutanoic acid, dimethyl sulfide, butyric acid, propyl 2-mercaptopropionate, 2,4,6-trimethylphenol (mesitol), gamma-valerolactone, delta octalactone, delta decalactone, whiskey lactone, p-cresol, 3-(methylthio)propionaldehyde, isobutyraldehyde, delta-octalactone, 5-methyl-2-hepten−4-one, linalool, valeraldehyde, beta-damascenone, eugenol, vanillin, 2,3-pentanedione, 4-hydroxy-2,5-dimethyl-3(2H)-furanone, maltol, L-lactic acid, and 2-acetylpyridine.

65. The nut butter replica of claim 1, wherein the VOCs have less than about 95% or less than about 85% identity to the VOCs in a single reference nut butter.

66. The nut butter replica of claim 1, wherein the nut butter replica comprises at least 71 VOCs and wherein no more than 70 of the VOCs are found in a single reference nut butter.

67. The nut butter replica of claim 1, wherein the nut butter replica comprises at least 51 VOCs and wherein no more than 50 of the VOCs are found in a single reference nut butter.

68. The nut butter replica of claim 1, wherein the one or more isolated non-volatile compounds do not comprise at least one compound selected from the group consisting of homoserine, nicotinic acid, valine, proline, arginine, B-alanine-2, asparagine, glutamic acid, phenylalanine, leucine, lysine, glycine, serine, arabitol, fructose, mannitol, catechin, epicatechin, sorbitol, sucrose, trehalose, sotolon, vanillin, 2-ethyl-2-hydroxybutyricacid, and ricinoleic acid.

69. The nut butter replica of claim 1, wherein the one or more isolated non-volatile compounds comprise at least one compound selected from the group consisting of 8-hydroxyquinoline, quinoline, chlorogenic acid, fraxetin, strawberry furanone acetate, luteolin−7-O-glucoside, inosine, trigonelline, trans-4-hydroxyproline, carnosine, cystine, kynurenic acid, ornithine, cysteine, pyridoxine, adenine, glucosamine, D-glucuronic acid, quinic acid, tartaric acid, fumaric acid, succinic acid, 3,4-dihydroxybenzoic acid, 2-furoic acid, camphoric acid, ribose, adipic acid, rutin, xylose, galactose, vanillic acid, syringic acid, polydatin, cytosine, 4-guanidinobutyric acid, uracil, tyramine, tryptamine, maple furanone, acetanilide, benzaldehyde, sorbic acid, B-ionone, muramic acid, trans,trans-muconic acid, gentisic acid, 6,7-dihydroxycoumarin, tropic acid, 6-hydroxy-2-naphthoic acid, propyl gallate, hesperetin, and caffeic acid.

70. The nut butter replica of claim 1, wherein at least one of the following, in any combination, is true:
(a) chlorogenic acid is present in an amount of at least about 32 ppm;
(b) propyl gallate is present in an amount of at least about 5.0 ppm;
(c) hesperetin is present in an amount of at least about 0.08 ppm; or
(d) caffeic acid is present in an amount of at least about 0.15 ppm.

71. The nut butter replica of claim 1, wherein the one or more isolated non-volatile compounds comprise one or more of: an acid, an aldehyde, an alkaloid, an amine, an amino acid, a furan, a ketone, a lactone, a nucleotide, a nucleotide monophosphate, or nucleobase, a protein or peptide, a pyrazine, a pyridine, a sugar or sugar alcohol, a tannin, phenol, a fat, a salt, an emulsifier, polyphenol, or anthocyanin, or a xanthine.

72. (canceled)

73. The nut butter replica of claim 1, wherein the one or more isolated non-volatile compounds comprise one or more acids.

74. The nut butter replica of claim 73, wherein the one or more acids comprise at least one acid selected from the group consisting of adipic acid, trans-ferulic acid, sinapinic acid, salicylic acid, pantothenic acid, caffeic acid, vanillic acid, syringic acid, coumaric acid, sorbic acid, kynurenic acid, D-glucuronic acid, quinic acid, malic acid, pyruvic acid, tartaric acid, lactic acid, citric acid, fumaric acid, succinic acid, gallic acid, 2-furoic acid, 3,4-dihydroxybenzoic acid, 2-isopropylmalic acid, D-Gluconic acid, 4-methoxycinnamic acid, 2-ethyl-2-hydroxybutyric acid, ricinoleic acid, DL-hydroxystearic acid, nicotinic acid, chlorogenic acid, cholic acid, and hydroxybutyricacid, or any combination thereof.

75. The nut butter replica of claim 1, wherein the one or more isolated non-volatile compounds comprise one or more aldehydes.

76. The nut butter replica of claim 75, wherein the one or more aldehydes comprise vanillin.

77. The nut butter replica of claim 75, wherein the aldehydes are present in an amount of at least about 0.001 ppm.

78. The nut butter replica of claim 1, wherein the one or more isolated non-volatile compounds comprise one or more alkaloids.

79. The nut butter replica of claim 78, wherein the one or more alkaloids comprise piperine.

80. The nut butter replica of claim 1, wherein the one or more isolated non-volatile compounds comprise one or more amines.

81. The nut butter replica of claim 80, wherein the one or more amines comprise tryptamine.

82. The nut butter replica of claim 1, wherein the one or more isolated non-volatile compounds comprise one or more amino acids.

83. The nut butter replica of claim 82, wherein the one or more amino acids comprise at least one amino acid selected from the group consisting of phenylalanine, leucine, glucosamine, methionine, GABA, Tyrosine, lysine, histidine, glycine, serine, aspartic acid, isoleucine, tryptophan, valine, proline, carnitine, arginine, B-alanine-2, Threonine, glutamine, asparagine, glutamic acid, betaine, pipecolinic acid, citrulline, carnosine, and homoserine, or any combination thereof.

84. The nut butter replica of claim 1, wherein the one or more isolated non-volatile compounds comprise one or more furans.

85. The nut butter replica of claim 84, wherein the one or more furans comprise hydroxymethylfurfural.

86. The nut butter replica of claim 1, wherein the one or more isolated non-volatile compounds comprise one or more ketones.

87. The nut butter replica of claim 86, wherein the one or more ketones comprise at least one ketone selected from the group consisting of 2(5H)-furanone, 5-ethyl-4-hydroxy-2-methyl-3(2H)-furanone, acetovanillone, and methyl-2-pyrrolyl ketone, or any combination thereof.

88. The nut butter replica of claim 1, wherein the one or more isolated non-volatile compounds comprise one or more lactones.

89. The nut butter replica of claim 88, wherein the one or more lactones comprise sotolon.

90. The nut butter replica of claim 1, wherein the one or more isolated non-volatile compounds comprise one or more nucleotides, nucleotide monophosphates, or nucleobases.

91. The nut butter replica of claim 90, wherein the one or more nucleotides, nucleotide monophosphates, or nucleobases comprise at least one nucleotides, nucleotide monophosphates, or nucleobase selected from the group consisting of adenine, AMP, CMP, cytidine, cytosine, guanine, and uracil, or any combination thereof.

92. The nut butter replica of claim 1, wherein the one or more isolated non-volatile compounds comprise one or more proteins or peptides.

93. The nut butter replica of claim 92, wherein the one or more proteins or peptides comprise carnosine.

94. The nut butter replica of claim 1, wherein the one or more isolated non-volatile compounds comprise one or more pyrazines.

95. The nut butter replica of claim 94, wherein the one or more pyrazines comprise at least one pyrazine selected from the group consisting of 2,3,5,6-tetramethylpyrazine, 2,3,5-trimethylpyrazine, and 2,3-dimethylpyrazine, or any combination thereof.

96. The nut butter replica of claim 1, wherein the one or more isolated non-volatile compounds comprise one or more pyridines.

97. The nut butter replica of claim 96, wherein the one or more pyridines comprise at least one pyridine selected from the group consisting of pyridine and pyroxidine, or a combination thereof.

98. The nut butter replica of claim 1, wherein the one or more isolated non-volatile compounds comprise one or more sugars or sugar alcohols.

99. The nut butter replica of claim 98, wherein the one or more sugars or sugar alcohols comprise at least one sugar or sugar alcohol selected from the group consisting of arabitol, fructose, rhamnose, mannitol, glucose, lactose, xylose, sorbitol, fucose, galactose, mannose, sucrose, myo-inositol, trehalose, allulose, monkfruit, stevia, maltitol, isomalt, tagatose, and stachyose, or any combination thereof.

100. The nut butter replica of claim 1, wherein the one or more isolated non-volatile compounds comprise one or more tannins, phenols, polyphenols, or anthocyanins.

101. The nut butter replica of claim 100, wherein the one or more tannins, phenols, polyphenols, or anthocyanins comprise at least one tannin, phenol, polyphenol, or anthocyanin selected from the group consisting of catechin, ellagic acid, epicatechin, epicatechin gallate, gallic acid, hesperetin, methyl gallate, polydatin, propyl gallate, quercetin, resveratrol, rutin, salicylic acid, sinapinic acid, syringaldehyde, syringic acid, trans-ferulic acid, tyramine, and vanillic acid, or any combination thereof.

102. The nut butter replica of claim 1, wherein the one or more isolated non-volatile compounds comprise one or more xanthines.

103. The nut butter replica of claim 102, wherein the one or more xanthines comprise theobromine.

104. The nut butter replica of claim 1, wherein the one or more isolated non-volatile compounds comprise stabilizer fats.

105. The nut butter replica of claim 104, wherein the one or more stabilizer fats comprise hydrogenated oil, palm oil, kernel oil, shea oil, cottonseed oil, another fat, or another plant oil.

106. The nut butter replica of claim 1, wherein the one or more isolated non-volatile compounds comprise cocoa products.

107. The nut butter replica of claim 106, wherein the one or more cocoa products comprise cocoa powder, cocoa butter, or chocolate.

108. The nut butter replica of claim 1, wherein the one or more isolated non-volatile compounds comprise an emulsifier.

109. The nut butter replica of claim 108, wherein the one or more emulsifiers comprise lecithin.

110. The nut butter replica of claim 1, wherein the one or more isolated non-volatile compounds comprise a substrate.

111. The nut butter replica of claim 110, wherein the substrate comprises grape seeds, sunflower seeds, sunflower kernels, sunflower meal or flour, sunflower oil, other processed or unprocessed grains or grain products, legumes or legume seeds, oil plants or seeds, fruits or fruit products, roots, tubers, or root or tuber products, sugar processing by-products, or another plant by-products.

112. The nut butter replica of claim 1, wherein the one or more isolated non-volatile compounds comprise a liquid medium.

113. The nut butter replica of claim 112, wherein the liquid medium comprises water, milk, plant-based milk, or another alternative dairy products.

114. The nut butter replica of claim 1, wherein the one or more nonvolatile compounds comprise at least 10 compounds selected from the group consisting of 2(5H)-furanone, 2,3,5,6-tetramethylpyrazine, 2,3,5-trimethylpyrazine, 2,3-dimethylpyrazine, 2-ethyl-2-hydroxybutyric acid, 2-furoic acid, 2-isopropylmalic acid, 3,4-dihydroxybenzoic acid, 4-guanidinobutyric acid, 4-methoxycinnamic acid, 5-ethyl-4-hydroxy-2-methyl-3(2H)-furanone, acetovanillone, adenine, adipic acid, AMP, arabitol, arginine, asparagine, aspartic acid, beta-alanine, betaine, caffeic acid, caffeine, carnitine, carnosine, catechin, choline, cinnamic acid, citric acid, citrulline, CMP, coumaric acid, cysteine, cystine, cytidine, cytosine, D-gluconic acid, D-glucuronic acid, DL-hydroxystearic acid, ellagic acid, epicatechin, epicatechin gallate, fructose, fumaric acid, GABA, galactose, gallic acid, glucosamine, glucose, glutamic acid, glutamine, glycine, guanine, hesperetin, histidine, homoserine, hydroxymethylfurfural, isoleucine, kynurenic acid, lactic acid, leucine, lysine, malic acid, mannitol, mannose, methionine, methyl gallate, methyl-2-pyrrolyl ketone, inositol, ornithine, pantothenic acid, phenylalanine, pipecolinic acid, piperine, polydatin, proline, propyl gallate, pyridine, pyridoxine, pyruvic acid, quercetin, quinic acid, resveratrol, rhamnose, ribose, rutin, salicylic acid, serine, sinapinic acid, sorbic acid, sorbitol, sotolon, succinic acid, syringaldehyde, syringic acid, tartaric acid, threonine, trans-4-hydroxyproline, trans-ferulic acid, tryptamine, tryptophan, tyramine, tyrosine, uracil, valine, vanillic acid, vanillin, and xylose.

115. The nut butter replica of claim 1, wherein the one or more isolated non-volatile compounds comprise at least 5 or at least 10 compounds selected from the group consisting of 2,3,5-trimethylpyrazine, 2,3-dimethylpyrazine, aspartic acid, caffeine, choline, citric acid, lactic acid, sotolon, succinic acid, trans-ferulic acid, vanillic acid, and vanillin.

116. The nut butter replica of claim 1, wherein the one or more isolated non-volatile compounds have less than about 95% or less than about 85% identity to the isolated non-volatile compounds in a single reference nut butter.

117. The nut butter replica of claim 1, wherein the nut butter replica comprises at least 11 isolated non-volatile compounds and wherein no more than 10 of the isolated non-volatile compounds are found in a single reference nut butter.

118. The nut butter replica of claim 1, wherein the nut butter replica does not comprise one or more of E. coli, Salmonella sp., Brettanomyces sp., Lactobacillales, Saccharomyces sp., Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, Verticillium psalliotae, mold, mildew, rot, insects, insect eggs, insect filth, rodent filth, mammalian excreta, hydrogen sulfide, hydrogen disulfide, 2,4,6-trichloranisole, 2,4,6-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, dichloromethane, tree nut protein allergens, peanut protein allergens, and heavy metals.

119. The nut butter replica of claim 1, wherein the nut butter replica is a solution, suspension, or emulsion.

120. The nut butter replica of claim 119, wherein the solution, suspension, or emulsion is a nut butter spread or a nut butter coating.

121. The nut butter replica of claim 1, wherein the nut butter replica is soluble in water.

122. A method of preparing a nut butter replica, the method comprising:
forming a mixture comprising:
water,
one or more isolated VOCs that are water-soluble, and
one or more isolated non-volatile compounds that are water-soluble;
forming a substrate emulsion comprising:
an oil,
one or more isolated VOCs that are fat-soluble, and
one or more isolated non-volatile compounds that are fat-soluble; and
mixing the aqueous solution and the emulsion to form a nut butter replica.

123. The method of claim 122, wherein forming an emulsion comprises homogenizing.

124. The method of claim 122, wherein the oil comprises corn oil, sunflower oil, palm oil, soybean oil, cocoa butter, shea oil, kernel oil, or coconut oil.

125. The method of claim 122, wherein the method further comprises agglomerating the flavor mixture.

126. The method of claim 125, wherein agglomerating the flavor mixture comprises pneumatic mixing, steam-jet, fluid-bed, pan, or spray drying, drum, mixer, roller, or extrusion agglomeration.

127. The method of claim 122, wherein the nut butter replica comprises a solid substrate.

128. The method of claim 127, wherein the method further comprises applying the flavor mixture to the solid substrate.

129. The method the method of claim 128, wherein applying the flavor mixture comprises spray applying the flavor mixture.

130. The method of claim 127, wherein the solid substrate comprises processed or unprocessed grains or grain products, legumes or legume seeds, oil plants or seeds, fruits or fruit products, roots, tubers, or root or tuber products, sugar processing by-products, or other plant by-products.

131. The method of claim 127, wherein the solid substrate comprises grape seeds or seeds from raspberry, cranberry, blackberry, or strawberry).

132. The method of claim 122, wherein:
a) the one or more isolated VOCs comprise at least one VOC that is not present in a corresponding reference nut butter,
b) the one or more isolated VOCs do not comprise at least one VOC that is present in a corresponding reference nut butter,
c) the one or more isolated VOCs are present in the nut butter replica in a total amount of at least 100 ppm,
d) the one or more isolated non-volatile compounds comprise at least one non-volatile compound that is not present in a corresponding reference nut butter, or
e) the one or more isolated non-volatile compounds do not comprise at least one non-volatile compound that is present in a corresponding reference nut butter.
